(19) United States
(12) Patent Application Publication
(10) Pub. No.: US 2003/0203323 A1
(43) Pub. Date: Oct. 30, 2003

(54) Silver salt photothermographic dry imaging material and image recording method as well as image forming method using the same

(76) Inventors: Hideki Takiguchi, Tokyo (JP); Soc Man Ho Kimura, Tokyo (JP)

Correspondence Address: MUSERLIAN AND LUCAS AND MERCANTI, LLP, 600 THIRD AVENUE, NEW YORK, NY, 10016, US

(21) Appl. No.: 10/379,779

(22) Filed: Mar. 5, 2003

(30) Foreign Application Priority Data
Mar. 14, 2002 (JP) JP2002-069995

(51) Int. Cl. G03C 1/498

(52) U.S. Cl. 430/350; 430/619; 430/620

(57) ABSTRACT

A photothermographic imaging material comprising a support having thereon a photosensitive layer comprising photosensitive silver halide grains, light-insensitive organic silver salt grains, a binder, and a reducing agent for silver ions, wherein the silver halide grains are capable of: (a) forming surface latent images when exposed prior to heating development; and (b) forming internal latent images when exposed after heating development.

### FIELD OF THE INVENTION

The present invention relates to a silver salt photothermographic dry imaging material, and an image recording method as well as an image forming method using the same.

### BACKGROUND OF THE INVENTION

In recent years, in the medical and graphic arts fields, effluent resulting from wet processing for image forming materials has caused problems regarding workability. From the viewpoint of environmental protection as well as space saving, a decrease in the aforesaid processing effluent has been increasingly demanded.

As a result, techniques have been sought which relate to photothermographic materials which can be effectively exposed, employing laser imagers and laser image setters, and can form clear black-and-white images exhibiting high resolution.

Such techniques are described in, for example, U.S. Pat. Nos. 3,152,904 and 3,487,075, both by D. Morgan and B. Shely, or D. H. Klosterboer et al., “Dry Silver Photographic Materials”, (Handbook of Imaging Materials, Marcel Dekker, Inc. page 48, 1991). Also known are silver salt photothermographic dry imaging materials (hereinafter occasionally referred to as photosensitive materials) which comprise a support having thereon organic silver salts, photosensitive silver halide and reducing agents. Since any solution-based processing chemicals are not employed for the aforesaid silver salt photothermographic dry imaging materials, they exhibit advantages in that it is possible to provide a simpler environmentally friendly system to customers.

These silver salt photothermographic dry imaging materials are characterized in that photosensitive silver halide grains, which are incorporated in a photosensitive layer, are utilized as a photo-sensor and images are formed in such a manner that silver halide grains are thermally developed, commonly at 80 to 140° C., utilizing the incorporated reducing agents while using organic silver salts as a supply source of silver ions, and fixing need not be carried out.

However, the aforesaid silver salt photothermographic dry imaging materials tend to result in fogging during storage prior to thermal development, due to incorporation of organic silver salts, photosensitive silver halide grains and reducing agents. Further, after exposure, thermal development is commonly carried out at 80 to 250° C. followed by no fixing. Therefore, since all or some of the silver halide, organic silver salts, and reducing agents remain after thermal development, problems occur in which, during extended storage, image quality such as silver image tone tends to vary due to formation of metallic silver by heat as well as light.

Techniques which overcome these problems are disclosed in Japanese Patent Publication Open to Public Inspection Nos. 6-208192 and 8-267934, U.S. Pat. No. 5,714,311, European Patent No. 1096310, and references cited therein. These techniques disclosed therein exhibit some effects, but are not sufficient to meet the market's requirements.

In addition, for the purpose of enhancing covering power, when the number of photosensitive silver halide grains is increased while decreasing the diameter of the aforesaid grains, it has been found that problems occur in which variation and degradation of image quality such as tone of silver images are further accelerated due to effects of light incident to the aforesaid photosensitive slier halide grains during storage of the aforesaid photosensitive silver halide grains after development as well as while viewing them.

On the other hand, demanded as so-called “eternal objectives” is further improvement of image quality. Specifically, in the medical image field, demanded is development of techniques to achieve higher quality images to enable more accurate diagnosis.

### SUMMARY OF THE INVENTION

From the viewpoint of the foregoing, the present invention was achieved. An object of the present invention is to provide a silver salt photothermographic dry imaging material which exhibits excellent storage stability, irrespective of high speed as well as low fogging, and further exhibits excellent stability of silver images after thermal development, and an image recording method, as well as an image forming method of the same.

The inventors of the present invention performed diligent investigations. As a result, it was discovered that the object of the present invention was achieved by employing any of the embodiments described below.

(1) A photothermographic imaging material comprising a support having thereon a photosensitive layer comprising photosensitive silver halide grains, light-insensitive organic silver salt grains, a binder, and a reducing agent for silver ions, wherein the silver halide grains are capable of:

(a) forming surface latent images when exposed prior to heating development; and

(b) forming internal latent images when exposed after heating development.

(2) A photothermographic imaging material comprising a support having thereon a photosensitive layer comprising photosensitive silver halide grains, light-insensitive organic silver salt grains, a binder, and a reducing agent for silver ions, wherein the imaging material has a first photographic speed and a second photographic speed and the second photographic speed is not more than ⅕ of the first photographic speed,

the first photographic speed being derived from a first characteristic curve obtained from the imaging material subjected to a first measuring method comprising the following steps in the order named:

(1a) exposing the imaging material to white light or infrared light using an optical wedge; and

(1b) applying heat to the exposed imaging material under a predetermined condition so as to develop the exposed imaging material,

and the second photographic speed being derived from a second characteristic curve obtained from the imaging material subjected to a second measuring method comprising the following steps in the order named:

(2a) applying heat to the imaging material under the same condition as (1b);

(2d) exposing the heated imaging material to white light or infrared light using the optical wedge.

(3) The photothermographic imaging material of item 1 or item 2, wherein the silver halide grains comprise a dopant capable of trapping an electron inside of the grains.

(4) The photothermographic imaging material of anyone of items 1 to 3, wherein the silver halide grains are covered with a spectral sensitizing dye on surfaces of the grains so as to exhibit a spectral sensitivity and the spectral sensitivity substantially disappears after thermal development of the imaging material. The aforementioned “substantially disappears” indicates that the spectral sensitivity cannot be found under a practical condition.

(5) The photothermographic imaging material of anyone of items 1 to 4, wherein the silver halide grains are chemically sensitized on surfaces of the grains so as to exhibit a chemical sensitivity and the chemical sensitivity substantially disappears after thermal development of the imaging material.

(6) The photothermographic imaging material of anyone of items 1 to 5, wherein the silver halide grains are covered with a spectral sensitizing dye on surfaces of the grains so as to exhibit a spectral sensitivity and the silver halide grains are chemically sensitized on the surfaces of the grains so as to exhibit a chemical sensitivity, and the spectral sensitivity and the chemical sensitivity disappears after thermal development of the imaging material.

(7) The photothermographic imaging material of anyone of items 1 to 6, wherein the reducing agent is represented by the following Formula (S):

Formula (S)

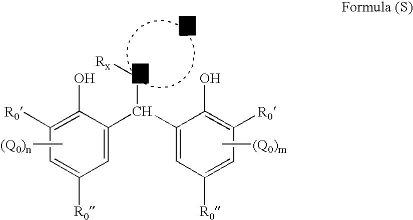

wherein Z is a group of atoms necessary to form a non aromatic ring of 3 to 10 members; Rx is a hydrogen or an alkyl group; each Ro′ and Ro″ is independently a hydrogen, an alkyl group, an aryl group, or a heterocyclic group; Qo is a substituent; and each n and m is independently an integer of 0 to 2; and plural Qos may be the same or different.

(8) The photothermographic imaging material of anyone of items 1 to 7, wherein the photosensitive layer has a silver coverage of from 0.5 to 1.5 g/m² and the silver halide grains comprise a dopant capable of trapping an electron inside of the grains.

(9) The photothermographic imaging material of anyone of items 1 to 8, wherein the light-insensitive organic silver salt grains comprise a silver salt of an aliphatic carboxylic acid having a melting point of 60 to 90° C. in an amount of 65 weight % based on the total organic silver salt grains.

(10) The photothermographic imaging material of item 9, wherein the aliphatic carboxylic acid has a melting point of 70 to 90° C.

(11) An image recording method, comprising the steps of:

(a) providing the photothermographic imaging material of anyone of items 1 to 10 in a laser scanning exposure apparatus; and

(b) exposing the photothermographic imaging material with a laser beam, wherein the laser beam is applied to the photothermographic imaging material using a longitudinal multiple scanning method; and

(c) applying heat to the exposed imaging material under a predetermined condition so as to develop the exposed imaging material.

(12) An image forming method, comprising the steps of:

(a) providing the photothermographic imaging material of anyone of items 1 to 10 in a laser scanning exposure apparatus;

(b) exposing the photothermographic imaging material with a laser beam; and,

(c) applying heat to the exposed imaging material under a predetermined condition so as to develop the exposed imaging material, wherein after the step (c) being carried out, the imaging material exhibits a hue angle h_{ab} which satisfies the following relationship:

180°<h_{ab}<270°

### DESCRIPTION OH THE PREFERRED EMBODIMENTS

The present invention will now be detailed.

Photosensitive silver halide grains (hereinafter simply referred to as silver halide grains) will be described which are employed in the silver salt photothermographic dry imaging material of the present invention (hereinafter simply referred to as the photosensitive material of the present invention) Incidentally, the photosensitive silver halide grains, as described in the present invention, refer to silver halide crystalline grains which can originally absorb light as an inherent quality of silver halide crystals, can absorb visible light or infrared radiation through artificial physicochemical methods and are treatment-produced so that physicochemical changes occur in the interior of the silver halide crystal and/or on the crystal surface, when the crystals absorb any radiation from ultraviolet to infrared.

Silver halide grains employed in the present invention can be prepared in the form of silver halide grain emulsions, employing methods described in P. Glafkides, “Chimie et Physique Photographique” (published by Paul Montel Co., 1967), G. F. Duffin, “Photographic Emulsion Chemistry” (published by The Focal Press, 1955), and V. L. Zelikman et al., “Making and Coating Photographic Emulsion”, published by The Focal Press, 1964). Namely, any of an acidic method, a neutral method, or an ammonia method may be employed. Further, employed as methods to allow water-soluble silver salts to react with water-soluble halides may be any of a single-jet precipitation method, a double-jet precipitation method, or combinations thereof. However, of these methods, the so-called controlled double-jet precipitation method is preferably employed in which silver halide grains are prepared while controlling formation conditions. Halogen compositions are not particularly limited. Any of silver chloride, silver chlorobromide, silver chloroiodobromide, silver bromide, silver iodobromide, or silver iodide may be employed. Of these, silver bromide or silver iodobromide is particularly preferred.

The content ratio of iodine in silver iodobromide is preferably in the range of 0.02 to 6.00 mol percent. Iodine may be incorporated so that it is distributed into the entire silver halide grain. Alternatively, a core/shell structure may be formed in which, for example, the concentration of iodine in the central portion of the grain is increased, while the concentration near the grain surface is simply decreased or substantially decreased to zero.

Grain formation is commonly divided into two stages, that is, the formation of silver halide seed grains (being nuclei) and the growth of the grains. Either method may be employed in which two stages are continually carried out, or in which the formation of nuclei (seed grains) and the growth of grains are carried out separately. A controlled double-jet precipitation method, in which grains are formed while controlling the pAg and pH which are grain forming conditions, is preferred, since thereby it is possible to control grain shape as well as grain size. For example, when the method, in which nucleus formation and grain growth are separately carried out, is employed, initially, nuclei (being seed grains) are formed by uniformly and quickly mixing water-soluble silver salts with water-soluble halides in an aqueous gelatin solution. Subsequently, under the controlled pAg and pH, silver halide grains are prepared through a grain growing process which grows the grains while supplying water-soluble silver salts as well as water-soluble halides.

In order to minimize milkiness (or white turbidity) as well as coloration (yellowing) after image formation and to obtain excellent image quality, the average grain diameter of the silver halide grains, employed in the present invention, is preferably rather small. The average grain diameter, when grains having a grain diameter of less than 0.02 μm is beyond practical measurement, is preferably 0.035 to 0.055 μm.

Incidentally, grain diameter, as described herein, refers to the edge length of silver halide grains which are so-called regular crystals such as a cube or an octahedron. Further, when silver halide gains are planar, the grain diameter refers to the diameter of the circle which has the same area as the projection area of the main surface.

In the present invention, silver halide grains are preferably monodispersed. Monodispersion, as described herein, means that the variation coefficient, obtained by the formula described below, is less than or equal to 30 percent. The aforesaid variation coefficient is preferably less than or equal to 20 percent, and is more preferably less than or equal to 15 percent.

Variation coefficient (in percent) of grain diameter=standard deviation of grain diameter/average of grain diameter×100

Cited as shapes of silver halide grains may be cubic, octahedral and tetradecahedral grains, planar grains, spherical grains, rod-shaped grains, and roughly elliptical-shaped grains. Of these, cubic, octahedral, tetradecahedral, and planar silver halide grains are particularly preferred.

When the aforesaid planar silver halide grains are employed, their average aspect ratio is preferably 1.5 to 100, and is more preferably 2 to 50. These are described in U.S. Pat. Nos. 5,264,337, 5,314,798, and 5,320,958, and incidentally it is possible to easily prepare the aforesaid target planar grains. Further, it is possible to preferably employ silver halide grains having rounded corners.

The crystal habit of the external surface of silver halide grains is not particularly limited. However, when spectral sensitizing dyes, which exhibit crystal habit (surface) selectiveness are employed, it is preferable that silver halide grains are employed which have the crystal habit matching their selectiveness in a relatively high ratio. For example, when sensitizing dyes, which are selectively adsorbed onto a crystal plane having a Miller index of (100), it is preferable that the ratio of the (100) surface on the external surface of silver halide grains is high. The ratio is preferably at least 50 percent, is more preferably at least 70 percent, and is most preferably at least 80 percent. Incidentally, it is possible to obtain a ratio of the surface having a Miller index of (100), based on T. Tani, J. Imaging Sci., 29, 165 (1985), utilizing adsorption dependence of sensitizing dye in a (111) plane as well as a (100) surface.

The silver halide grains, employed in the present invention, are preferably prepared employing low molecular weight gelatin, having an average molecular weight of less than or equal to 50,000 during the formation of the grains, which are preferably employed during formation of nuclei. The low molecular weight gelatin refers to gelatin having an average molecular weight of less than or equal to 50,000. The molecular weight is preferably from 2,000 to 40,000, and is more preferably from 5,000 to 25,000. It is possible to measure the molecular weight of gelatin employing gel filtration chromatography.

The concentration of dispersion media during the formation of nuclei is preferably less than or equal to 5 percent by weight. It is more effective to carry out the formation at a low concentration of 0.05 to 3.00 percent by weight.

During formation of the silver halide grains employed in the present invention, it is possible to use polyethylene oxides represented by the general formula described below.

YO(CH₂CH₂O)ₘ(CH(CH₃)CH₂O)ₚ(CH₂CH₂O)ₙY General Formula

wherein Y represents a hydrogen atom, —SO₃M, or —CO—B—COOM; M represents a hydrogen atom, an alkali metal atom, an ammonium group, or an ammonium group substituted with an alkyl group having less than or equal to 5 carbon atoms; B represents a chained or cyclic group which forms an organic dibasic acid; m and n each represents 0 through 50; and p represents 1 through 100.

When silver halide photosensitive photographic materials are produced, polyethylene oxides, represented by the above general formula, have been preferably employed as anti-foaming agents to counter marked foaming which occurs while stirring and transporting emulsion raw materials in a process in which an aqueous gelatin solution is prepared, in the process in which water-soluble halides as well as water-soluble silver salts are added to the gelatin solution, and in a process in which the resultant emulsion is applied onto a support. Techniques to employ polyethylene oxides as an anti-foaming agent are disclosed in, for example, Japanese Patent Publication Open to Public Inspection No. 44-9497. The polyethylene oxides represented by the above general formula function as an anti-foaming agent during nuclei formation.

The content ratio of polyethylene oxides, represented by the above general formula, is preferably less than or equal to 1 percent by weight with respect to silver, and is more preferably from 0.01 to 0.10 percent by weight.

It is desired that polyethylene oxides, represented by the above general formula, are present during nuclei formation. It is preferable that they are previously added to the dispersion media prior to nuclei formation. However, they may also be added during nuclei formation, or they may be employed by adding them to an aqueous silver salt solution or an aqueous halide solution which is employed during nuclei formation. However, they are preferably employed by adding them to an aqueous halide solution, or to both aqueous solutions in an amount of 0.01 to 2.00 percent by weight. Further, it is preferable that they are present during at least 50 percent of the time of the nuclei formation process, and it is more preferable that they are present during at least 70 percent of the time of the same. The polyethylene oxides, represented by the above general formula, may be added in the form of powder or they may be dissolved in a solvent such as methanol and then added.

Incidentally, temperature during nuclei formation is commonly from 5 to 60° C., and is preferably from 15 to 50° C. It is preferable that the temperature is controlled within the range, even when a constant temperature, a temperature increasing pattern (for example, a case in which temperature at the initiation of nuclei formation is 25° C., subsequently, temperature is gradually increased during nuclei formation and the temperature at the completion of nuclei formation is 40° C.), or a reverse sequence may be employed.

The concentration of an aqueous silver salt solution and an aqueous halide solution, employed for nuclei formation, is preferably less than or equal to 3.5 M, and is more preferably in the lower range of 0.01 to 2.50 M. The silver ion addition rate during nuclei formation is preferably from 1.5×10⁻³ to 3.0×10⁻¹ mol/minute, and is more preferably from 3.0×10⁻³ to 8.0×10⁻² mol/minute.

The pH during nuclei formation can be set in the range of 1.7 to 10.0. However, since the pH on the alkali side broadens the particle size distribution of the formed nuclei, the preferred pH is from 2 to 6. Further, the pBr during nuclei formation is usually from about 0.05 to about 3.00, is preferably from 1.0 to 2.5, and is more preferably from 1.5 to 2.0.

When the photosensitive silver halide grains according to the present invention are exposed to light prior to thermal development, latent images capable of functioning as a catalyst of development reaction are formed on the surface of the aforesaid silver halide grains. On the other hand, when exposed to light after the thermal development process, latent images are more formed in the interior of the silver halide grains than the surface thereof. As a result, the silver halide grains-result in retardation of latent image formation on the surface.

Generally, when photosensitive silver halide grains are exposed to light, silver halide grains themselves or spectral sensitizing dyes, which are adsorbed on the surface of photosensitive silver halide grains, are subjected to photo-excitation to generate free electrons. Generated electrons are competitively trapped by electron traps (sensitivity centers) on the surface or interior of silver halide grains. Accordingly, when chemical sensitization centers (chemical sensitization specks) and dopants, which are useful as an electron trap, are much more located on the surface of the silver halide grains than the interior thereof and the number is appropriate, latent images are dominantly formed on the surface, whereby the resulting silver halide grains become developable. Contrary to this, when chemical sensitization centers (chemical sensitization specks) and dopants, which are useful as an electron trap, are much more located in the interior of the silver halide grains than the surface thereof and the number is appropriate, latent images are dominantly formed in the interior, whereby it becomes difficult to develop the resulting silver halide grains. In other words, in the former, the surface speed is higher than interior speed, while in the latter, the surface speed is lower than the interior speed. The former type of latent image is called “a surface latent image”, and the latter is called “an internal latent image”.

In the present invention, one of features is that electron trapping dopants are incorporated in the interior of silver halide grains to achieve desired speed as well as desired image lasting properties.

Electron trapping dopants, as described herein, refer to silver, elements except for halogen or compounds constituting silver halide, and the aforesaid dopants themselves which exhibit properties capable of trapping free electron, or the aforesaid dopants are incorporated in the interior of silver halide grains to generate electron trapping portions such as lattice defects. For example, listed are metal ions other than silver ions or salts or complexes thereof, chalcogen (such as elements of oxygen family) sulfur, selenium, or tellurium, inorganic or organic compounds comprising nitrogen atoms, and rare earth element ions or complexes thereof.

Listed as metal ions, or salts or complexes thereof may be lead ions, bismuth ions, and gold ions, or lead bromide, lead carbonate, lead sulfate, bismuth nitrate, bismuth chloride, bismuth trichloride, bismuth carbonate, sodium bismuthate, chloroauric acid, lead acetate, lead stearate, and bismuth acetate.

Employed as compounds comprising chalcogen such as sulfur, selenium, and tellurium may be various chalcogen releasing compounds which are generally known as chalcogen sensitizers in the photographic industry. Further, preferred as organic compounds comprising chalcogen or nitrogen are heterocyclic compounds which include, for example, imidazole, pyrazole, pyridine, pyrimidine, pyrazine, pyridazine, triazole, triazine, idole, indazole, purine, thiazole, oxadiazole, quinoline, phthalazine, naphthylizine, quinoxaline, quinazoline, cinnoline, pteridine, acrydine, phenanthroline, phenazine, tetrazole, thiazole, oxazole, benzimidazole, benzoxazole, benzthiazole, indolenine, and tetraazaindene. Of these, preferred are imidazole, pyrazine, pyrimidine, pyrazine, pyridazine, triazole, triazine, thiadiazole, oxadiazole, quinoline, phthalazine, naphthylizine, quinoxaline, quinazoline, cinnoline, tetrazole, thiazole, oxazole, benzimidazole, benzoxazole, benzthiazole, and tetraazaindene.

Incidentally, the aforesaid heterocyclic compounds may have substituent(s). Preferable substituents include an alkyl group, an alkenyl group, an aryl group, an alkoxy group, an aryloxy group, an acyloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, a sulfonyl group, a ureido group, a phosphoric acid amide group, a halogen atom, a cyano group, a sulfo group, a carboxyl group, a nitro group, a heterocyclic group. Of these, more preferred are an alkyl group, an aryl group, an alkoxy group, an aryloxy group, an acyl group, an acylamino group, an alkoxycarbonylamino group, an aryloxycarbonylamino group, a sulfonylamino group, a sulfamoyl group, a carbamoyl group, a ureido group, a phosphoric acid amido group, a halogen atom, a cyano group, a nitro group, and a heterocyclic group. More preferred are an alkyl group, an aryl group, an alkoxy group, an aryloxy group, an acyl group, an acylamino group, a sulfonylamino group, a sulfamoyl group, a carbamoyl group, a halogen atom, a cyano group, a nitro group, and a heterocyclic group.

Incidentally, ions of transition metals which belong to Groups 6 through 11 in the Periodic Table may be chemically modified to form a complex employing ligands of the oxidation state of the ions and incorporated in silver halide grains employed in the present invention so as to function as an electron trapping dopant, as described above, or as a hole trapping dopant. Preferred as aforesaid transition metals are W, Fe, Co, Ni, Cu, Ru, Rh, Pd, Re, Os, Ir, and Pt.

In the present invention, aforesaid various types of dopants may be employed individually or in combination of at least two of the same or different types.

The content ratio of dopants is preferably in the range of 1×10⁻⁹ to 1×10 mol with respect mol of silver, and is more preferably 1×10⁻⁶ to 1×10⁻² mol.

However, the optimal amount varies depending the types of dopants, the diameter and shape of silver halide grains, and ambient conditions. Accordingly, it is preferable that addition conditions are optimized taking into account these conditions.

In the present invention, preferred as transition metal complexes or complex ions are those represented by the general formula described below.

General Formula [ML₆]^{m}

wherein M represents a transition metal selected from the elements of Groups 6 through 11 in the Periodic Table; L represents a ligand; and m represents 0, -, 2-, 3-, or 4-. Listed as specific examples of ligands represented by L are a halogen ion (a fluoride ion, a chloride ion, a bromide ion, or an iodide ion), a cyanide, a cyanato, a thiocyanato, a selenocyanato, a tellurocyanato, an azido, and an aqua ligand, and nitrosyl and thionitrosyl. Of these, aqua, nitrosyl, and thionitrosyl are preferred. When the aqua ligand is present, one or two ligands are preferably occupied by the aqua ligand. L may be the same or different.

It is preferable that compounds, which provide ions of these metals or complex ions, are added during formation of silver halide grains so as to be incorporated in the silver halide grains. The compounds may be added at any stage of, prior to or after, silver halide grain preparation, namely nuclei formation, grain growth, physical ripening or chemical ripening. However, they are preferably added at the stage of nuclei formation, grain growth, physical ripening, are more preferably added at the stage of nuclei formation and growth, and are most preferably added at the stage of nuclei formation. They may be added over several times upon dividing them into several portions. Further, they may be uniformly incorporated in the interior of silver halide grains. Still further, as described in Japanese Patent Publication Open to Public Inspection Nos. 63-29603, 2-306236, 3-167545, 4-76534, 6-110146, and 5-273683, they may be incorporated so as to result in a desired distribution in the interior of the grains.

These metal compounds may be dissolved in water or suitable organic solvents (for example, alcohols, ethers, glycols, ketones, esters, and amides) and then added. Further, addition methods include, for example, a method in which either an aqueous solution of metal compound powder or an aqueous solution prepared by dissolving metal compounds together with NaCl and KCl is added to a water-soluble halide solution, a method in which silver halide grains are formed by a silver salt solution, and a halide solution together with a the compound solution as a third aqueous solution employing a triple-jet precipitation method, a method in which, during grain formation, an aqueous metal compound solution in a necessary amount is charged into a reaction vessel, or a method in which, during preparation of silver halide, other silver halide grains which have been doped with metal ions or complex ions are added and dissolved. Specifically, a method is preferred in which either an aqueous solution of metal compound powder or an aqueous solution prepared by dissolving metal compounds together with NaCl and KCl is added to a water-soluble halide solution. When added onto the grain surface, an aqueous metal compound solution in a necessary amount may be added to a reaction vessel immediately after grain formation, during or after physical ripening, or during chemical ripening.

Incidentally, it is possible to introduce non-metallic dopants into the interior of silver halide employing the same method as the metallic dopants.

In the imaging materials in accordance with the present invention, it is possible to evaluate whether the aforesaid dopants exhibit electron trapping properties or not, while employing a method which has commonly employed in the photographic industry. Namely a silver halide emulsion comprised of silver halide grains, which have been doped with the aforesaid dopant or decomposition product thereof so as to be introduced into the interior of grains, is subjected to photoconduction measurement, employing a microwave photoconduction measurement method. Subsequently, it is possible to evaluate the aforesaid electron trapping properties by comparing the resulting decrease in photoconduction to that of the silver halide emulsion comprising no dopant as a standard. It is also possible to evaluate the same by performing experiments in which the internal speed of the aforesaid silver halide grains is compared to the surface speed.

Further, a method follows which is applied to a finished photothermographic dry imaging material to evaluate the electron trapping dopant effect in accordance with the present invention. For example, prior to exposure, the aforesaid imaging material is heated under the same conditions as the commonly employed thermal development conditions. Subsequently, the resulting material is exposed to white light or infrared radiation through an optical wedge for a definite time (for example, 30 seconds), and thermally developed under the same thermal development conations as above, whereby a characteristic curve (or a densitometry curve) is obtained. Then, it is possible to evaluate the aforesaid electron trapping dopant effect by comparing the speed obtained based on the characteristic curve to that of the imaging material which is comprised of the silver halide emulsion which does not comprise the aforesaid electron trapping dopant. Namely, it is necessary to confirm that the speed of the former sample comprised of the silver halide grain emulsion comprising the dopant in accordance with the present invention is lower than the latter sample which does not comprise the aforesaid dopant.

Speed of the aforesaid material is obtained based on the characteristic curve which is obtained by exposing the aforesaid material to white light or infrared radiation through an optical wedge for a definite time (for example 30 seconds) followed by developing the resulting material under common thermal development conditions. Further, speed of the aforesaid material is obtained based on the characteristic curve which is obtained by heating the aforesaid material under common thermal development conditions prior to exposure and giving the same definite exposure as above to the resulting material for the same definite time as above followed by thermally developing the resulting material under common thermal development conditions. The ratio of the latter speed to the former speed is preferably at most 1/5, and is more preferably at most 1/20. Incidentally, the smaller the aforesaid relative speed, the better. When the latter speed is limited under these values, the deterioration of image stability does not practically occur.

The silver halide grains of the present invention may be incorporated in a photosensitive layer employing an optional method. In such a case, it is preferable that the aforesaid silver halide grains are arranged so as to be adjacent to reducible silver sources (being aliphatic carboxylic silver salts).

The silver halide of the present invention is previously prepared and the resulting silver halide is added to a solution which is employed to prepare aliphatic carboxylic acid silver salt particles. By so doing, since a silver halide preparation process and an aliphatic carboxylic acid silver salt particle preparation process are performed independently, production is preferably controlled. Further, as described in British Patent No. 1,447,454, when aliphatic carboxylic acid silver salt particles are formed, it is possible to almost simultaneously form aliphatic carboxylic acid silver salt particles by charging silver ions to a mixture consisting of halide components such as halide ions and aliphatic carboxylic acid silver salt particle forming components. Still further, it is possible to prepare silver halide grains utilizing conversion of aliphatic carboxylic acid silver salts by allowing halogen-containing components to act on aliphatic carboxylic acid silver salts. Namely, it is possible to convert some of aliphatic carboxylic acid silver salts to photosensitive silver halide by allowing silver halide forming components to act on the previously prepared aliphatic carboxylic acid silver salt solution or dispersion, or sheet materials comprising aliphatic carboxylic acid silver salts.

Silver halide grain forming components include inorganic halogen compounds, onium halides, halogenated hydrocarbons, N-halogen compounds, and other halogen containing compounds. Specific examples include metal halides; inorganic halides such as ammonium halides; onium halides such as trimethylphenylammonium bromide, cetylethyldimethylammonium bromide, and trimethylbenzylammonium bromide; halogenated hydrocarbons such as iodoform, bromoform, carbon tetrachloride, and 2-brom-2-methylpropane; N-halogenated compounds such as N-bromosuccinic acid imide, N-bromophthalimide, and N-bromoacetamide; and others such as triphenylmethyl chloride, triphenylmethyl bromide, 2-bromacetic acid, 2-bromethanol, and dichlorobenzophenone. As mentioned above, it is possible to prepare silver halide by converting some part or all of silver in organic acid silver salts employing a reaction between organic acid silver and halogen ions. Further, silver halide grains may be employed in combination which are produced by converting some part of separately prepared aliphatic carboxylic acid silver salts.

The aforesaid silver halide grains, which include separately prepared silver halide grains and silver halide grains prepared by partial conversion of aliphatic carboxylic acid silver salts, are employed commonly in an amount of 0.001 to 0.7 mol per mol of aliphatic carboxylic acid silver salts and preferably in an amount of 0.03 to 0.5 mol.

The separately prepared photosensitive silver halide particles are subjected to desalting employing desalting methods known in the photographic art, such as a noodle method, a flocculation method, an ultrafiltration method, and an electrophoresis method, while they may be employed without desalting.

The light-insensitive aliphatic carboxylic acid silver salts according to the present invention are reducible silver sources which are preferably silver salts of long chain aliphatic carboxylic acids, having from 10 to 30 carbon atoms and preferably from 15 to 25 carbon atoms. Listed as examples of appropriate silver salts are those described below.

For example, listed are silver salts of gallic acid, oxalic acid, behenic acid, stearic acid, arachidic acid, palmitic acid, and lauric acid. Of these, listed as preferable silver salts are silver behenate, silver arachidate, and silver stearate.

Further, in the present invention, it is preferable that at least two types of aliphatic carboxylic acid silver salts are mixed since the resulting developability is enhanced and high contrast silver images are formed. Preparation is preferably carried out, for example, by mixing a mixture consisting of at least two types of aliphatic carboxylic acid with a silver ion solution.

On the other hand, from the viewpoint of enhancing retaining properties of images, the melting point of aliphatic carboxylic acids, which are employed as a raw material of aliphatic carboxylic acid silver, is commonly at least 50° C., and is preferably at least 60° C. The content ratio of aliphatic carboxylic acid silver salts is commonly at least 60 percent, is preferably at least 70 percent, and still more preferably at least 80 percent. From this viewpoint, specifically, it is preferable that the content ratio of silver behenate is higher.

Aliphatic carboxylic acid silver salts are prepared by mixing water-soluble silver compounds with compounds which form complexes with silver. When mixed, a normal precipitation method, a reverse precipitating method, a double-jet precipitation method, or a controlled double-jet precipitation method, described in Japanese Patent Publication Open to Public Inspection No. 9-127643, are preferably employed. For example, after preparing a metal salt soap (for example, sodium behenate and sodium arachidate) by adding alkali metal salts (for example, sodium hydroxide and potassium hydroxide) to organic acids, crystals of aliphatic carboxylic acid silver salts are prepared by mixing the soap with silver nitrate. In such a case, silver halide grains may be mixed together with them.

Aliphatic carboxylic acid silver salts according to the present invention may be crystalline grains which have the core/shell structure disclosed in European Patent No. 1168069A1 and Japanese Patent Application Open to Public Inspection No. 2002-023303. Incidentally, when the core/shell structure is formed, organic silver salts, except for aliphatic carboxylic acid silver, such as silver salts of phthalic acid and benzimidazole may be employed wholly or partly in the core portion or the shell portion as a constitution component of the aforesaid crystalline grains.

In the aliphatic carboxylic acid silver salts according to the present invention, it is preferable that the average circle equivalent diameter is from 0.05 to 0.80 μm, and the average thickness is from 0.005 to 0.070 μm. It is still more preferable that the average circle equivalent diameter is from 0.2 to 0.5 mm, and it is more preferable that the average circle equivalent diameter is from 0.2 to 0.5 μm and the average thickness is from 0.01 to 0.05 μm.

When the average circle equivalent diameter is less than or equal to 0.05 μm, excellent transparency is obtained, while image retention properties are degraded. On the other hand, when the average grain diameter is less than or equal to 0.8 μm, transparency is markedly degraded. When the average thickness is less than or equal to 0.005 μm, during development, silver ions are abruptly supplied due to the large surface area and are present in a large amount in the layer, since specifically in the low density section, the silver ions are not used to form silver images. As a result, the image retention properties are markedly degraded. On the other hand, when the average thickness is more than or equal to 0.07 μm, the surface area decreases, whereby image stability is enhanced. However, during development, the silver supply rate decreases and in the high density section, silver formed by development results in non-uniform shape, whereby the maximum density tends to decrease.

The average circle equivalent diameter can be determined as follows. Aliphatic carboxylic acid silver salts, which have been subjected to dispersion, are diluted, are dispersed onto a grid covered with a carbon supporting layer, and imaged at a direct magnification of 5,000, employing a transmission type electron microscope (Type 2000FX, manufactured by JEOL, Ltd.). The resultant negative image is converted to a digital image employing a scanner. Subsequently, by employing appropriate software, the grain diameter (being a circle equivalent diameter) of at least 300 grains is determined and an average grain diameter is calculated.

It is possible to determine the average thickness, employing a method utilizing a transmission electron microscope (hereinafter referred to as a TEM) as described below.

First, a photosensitive layer, which has been applied onto a support, is adhered onto a suitable holder, employing an adhesive, and subsequently, cut in the perpendicular direction with respect to the support plane, employing a diamond knife, whereby ultra-thin slices having a thickness of 0.1 to 0.2 μm are prepared. The ultra-thin slice is supported by a copper mesh and transferred onto a hydrophilic carbon layer, employing a glow discharge. Subsequently, while cooling the resultant slice at less than or equal to −130° C. employing liquid nitrogen, a bright field image is observed at a magnification of 5,000 to 40,000, employing TEM, and images are quickly recorded employing either film, imaging plates, or a CCD camera. During the operation, it is preferable that the portion of the slice in the visual field is suitably selected so that neither tears nor distortions are imaged.

The carbon layer, which is supported by an organic layer such as extremely thin collodion or Formvar, is preferably employed. The more preferred carbon layer is prepared as follows. The carbon layer is formed on a rock salt substrate which is removed through dissolution. Alternately, the organic layer is removed employing organic solvents and ion etching whereby the carbon layer itself is obtained. The acceleration voltage applied to the TEM is preferably from 80 to 400 kV, and is more preferably from 80 to 200 kV.

Other items such as electron microscopic observation techniques, as well as sample preparation techniques, may be obtained while referring to either “Igaku-Seibutsugaku Denshikenbikyo Kansatsu Gihoh (Medical-Biological Electron Microscopic Observation Techniques”, edited by Nippon Denshikembikyo Gakkai Kanto Shibu (Maruzen) or “Denshikembikyo Seibutsu Shiryo Sakuseihoh (Preparation Methods of Electron Microscopic Biological Samples”, edited by Nippon Denshikenbikyo Gakkai Kanto Shibu (Maruzen).

It is preferable that a TEM image, recorded in a suitable medium, is decomposed into preferably at least 1,024×1,024 pixels and subsequently subjected to image processing, utilizing a computer. In order to carry out the image processing, it is preferable that an analogue image, recorded on a film strip, is converted into a digital image, employing any appropriate means such as scanner, and if desired, the resulting digital image is subjected to shading correction as well as contrast-edge enhancement. Thereafter, a histogram is prepared, and portions, which correspond to aliphatic carboxylic acid silver salts, are extracted through a binarization processing.

At least 300 of the thickness of aliphatic carboxylic acid silver salt particles, extracted as above, are manually determined employing appropriate software, and an average value is then obtained.

Methods to prepare aliphatic carboxylic acid silver salt particles, having the shape as above, are not particularly limited. It is preferable to maintain a mixing state during formation of an organic acid alkali metal salt soap and/or a mixing state during addition of silver nitrate to the soap as desired, and to optimize the proportion of organic acid to the soap, and of silver nitrate which reacts with the soap.

It is preferable that, if desired, the planar aliphatic carboxylic acid silver salt particles (referring to aliphatic carboxylic acid silver salt particles, having an average circle equivalent diameter of 0.05 to 0.80 μm as well as an average thickness of 0.005 to 0.070 μm) are preliminarily dispersed together with binders as well as surface active agents, and thereafter, the resultant mixture is dispersed employing a media homogenizer or a high pressure homogenizer. The preliminary dispersion may be carried out employing a common anchor type or propeller type stirrer, a high speed rotation centrifugal radial type stirrer (being a dissolver), and a high speed rotation shearing type stirrer (being a homomixer).

Further, employed as the aforesaid media homogenizers may be rotation mills such as a ball mill, a planet ball mill, and a vibration ball mill, media stirring mills such as a bead mill and an attritor, and still others such as a basket mill. Employed as high pressure homogenizers may be various types such as a type in which collision against walls and plugs occurs, a type in which a liquid is divided into a plurality of portions which are collided with each other at high speed, and a type in which a liquid is passed through narrow orifices.

Preferably employed as ceramics, which are used in ceramic beads employed during media dispersion are, for example, Al₂O₃, BaTiO₃, SrTiO₃, MgO, ZrO, BeO, Cr₂O₃, Sio₂, SiO₂—Al₂O₃, Cr₂O₃—MgO, MgO—CaO, MgO—C, MgO—Al₂O₃ (spinel), SiC, TiO₂, K₂O, Na₂O, BaO, PbO, B₃O₃, SrTiO₃ (strontium titanate), BeAl₂O₄, Y₃Al₅O₁₂, ZrO₂—Y₂O₃ (cubic crystalline zirconia), 3BeO—Al₂O₃-6SiO₂ (synthetic emerald), C (synthetic diamond), Si₂O-nH₂O, silicon nitride, yttrium-stabilized zirconia, and zirconia-reinforced alumina. Due to the fact that impurity formation due to friction with beads as well as the homogenizer during dispersion is minimized, yttrium-stabilized zirconia and zirconia-reinforced alumina (hereinafter, ceramics comprising the zirconia are abbreviated as zirconia) are preferably employed.

In apparatuses which are employed to disperse the planar aliphatic carboxylic acid silver salt particles of the present invention, preferably employed as materials of the members which come into contact with the aliphatic carboxylic acid silver salt particles are ceramics such as zirconia, alumina, silicon nitride, and boron nitride, or diamond. Of these, zirconia is preferably employed. During the dispersion, the concentration of added binders is preferably from 0.1 to 10.0 percent by weight with respect to the weight of aliphatic carboxylic acid silver salts. Further, temperature of the dispersion during the preliminary and main dispersion is preferably maintained at less than or equal to 45° C. The examples of the preferable operation conditions for the main dispersion are as follows. When a high pressure homogenizer is employed as a dispersion means, preferable operation conditions are from 29 to 100 MPa, and at least double operation frequency. Further, when the media homogenizer is employed as a dispersion means, the peripheral rate of 6 to 13 m/second is cited as the preferable condition.

In the present invention, light-insensitive aliphatic carboxylic acid silver salt particles are preferably formed in the presence of compounds which function as a crystal growth retarding agent or a dispersing agent. Further, the compounds which function as a crystal growth retarding agent or a dispersing agent are preferably organic compounds having a hydroxyl group or a carboxyl group.

In the present invention, compounds, which are described herein as crystal growth retarding agents or dispersing agents for aliphatic carboxylic acid silver salt particles, refer to compounds which, in the production process of aliphatic carboxylic acid silver salts, exhibit more functions and greater effects to decrease the grain diameter, and to enhance monodispersibility when the aliphatic carboxylic acid silver salts are prepared in the presence of the compounds, compared to the case in which the compounds are not employed. Listed as examples are monohydric alcohols having 10 or fewer carbon atoms, such as preferably secondary alcohol and tertiary alcohol; glycols such as ethylene glycol and propylene glycol; polyethers such as polyethylene glycol; and glycerin. The preferable addition amount is from 10 to 200 percent by weight with respect to aliphatic carboxylic acid silver salts.

On the other hands, preferred are branched aliphatic carboxylic acids, each containing an isomer, such as isoheptanic acid, isodecanoic acid, isotridecanoic acid, isomyristic acid, isopalmitic acid, isostearic acid, isoarachidinic acid, isobehenic acid, or isohexaconic acid. Listed as preferable side chains are an alkyl group or an alkenyl group having 4 or fewer carbon atoms. Further, listed are aliphatic unsaturated carboxylic acids such as palmitoleic acid, oleic acid, linoleic acid, linolenic acid, moroctic acid, eicosenoic acid, arachidonic acid, eicosapentaenoic acid, erucic acid, docosapentaenoic acid, and selacholeic acid. The preferable addition amount is from 0.5 to 10.0 mol percent of aliphatic carboxylic acid silver salts.

Preferable compounds include glycosides such as glucoside, galactoside, and fructoside; trehalose type disaccharides such as trehalose and sucrose; polysaccharides such as glycogen, dextrin, dextran, and alginic acid; cellosolves such as methyl cellosolve and ethyl cellosolve; water-soluble organic solvents such as sorbitan, sorbitol, ethyl acetate, methyl acetate, and dimethylformamide; and water-soluble polymers such as polyvinyl alcohol, polyacrylic acid, acrylic acid copolymers, maleic acid copolymers, carboxymethyl cellulose, hydroxypropyl cellulose, hydroxypropyl methyl cellulose, polyvinylpyrrolidone, and gelatin. The preferable addition amount is from 0.1 to 20.0 percent by weight with respect to aliphatic carboxylic acid silver salts.

Alcohols having 10 or fewer carbon atoms, being preferably secondary alcohols and tertiary alcohols, increase the solubility of sodium aliphatic carboxylates in the emulsion preparation process, whereby the viscosity is lowered so as to enhance the stirring efficiency and to enhance monodispersibility as well as to decrease particle size. Branched aliphatic carboxylic acids, as well as aliphatic unsaturated carboxylic acids, result in higher steric hindrance than straight chain aliphatic carboxylic acid silver salts as a main component during crystallization of aliphatic carboxylic acid silver salts to increase the distortion of crystal lattices whereby the particle size decreases due to non-formation of over-sized crystals.

As mentioned above, being compared to conventional silver halide photosensitive photographic materials, the greatest different point in terms of the structure of silver salt photothermographic dry imaging materials is that in the latter materials, a large amount of photosensitive silver halide, organic silver salts and reducing agents is contained which are capable of becoming causes of generation of fogging and printout silver, irrespective of prior and after photographic processing. Due to that, in order to maintain storage stability before development and even after development, it is essential to apply highly effective fog minimizing and image stabilizing techniques to silver salt photothermographic dry imaging materials. Other than aromatic heterocyclic compounds which retard the growth and development of fog specks, heretofore, mercury compounds, such as mercury acetate, which exhibit functions to oxidize and eliminate fog specks, have been employed as a markedly effective storage stabilizing agents. However, the use of such mercury compounds has caused problems regarding safety as well as environmental protection.

Antifoggants as well as image stabilizing agents which are employed in the silver salt photothermographic dry imaging material of the present invention will now be described.

In the silver salt photothermographic dry imaging material of the present invention, one of the features is that bisphenols are mainly employed as a reducing agent, as described below. It is preferable that compounds are incorporated which are capable of deactivating reducing agents upon generating active species capable of extracting hydrogen atoms from the aforesaid reducing agents. Preferred compounds which are desired colorless photo-oxidizing materials are those which are capable of forming free radicals as a reaction active species during exposure.

Accordingly, compounds are not particularly limited as long as they exhibit such functions, but organic free radicals comprised of a plurality of atoms are preferred. Compounds having an optional structure may be employed which exhibit such functions and result in no adverse effects to silver salt photothermographic dry imaging materials.

Further, in order to result in sufficient stability of generated free radicals so that sufficient connect time is assured to react with and deactivate reducing agents, it is preferable that the aforesaid free radical generating compounds have a carbocyclic aromatic group.

Listed as representatives of these compounds may be biimidazolyl compounds and iodonium compounds described below.

Listed as biimidazolyl compounds are those represented by General Formula (1) below.

General Formula (1)

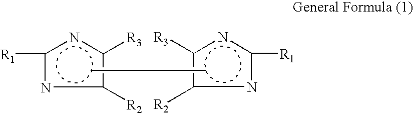

wherein R₁, R₂, and R₃ (which may be the same or differ) each represents an alkyl group (for example, methyl, ethyl, and hexyl), an alkenyl group (for example, vinyl and allyl), an alkoxy group (for example, methoxy, ethoxy, and octyloxy), an aryl group (for example, phenyl, naphthyl, and tolyl), a hydroxyl group, a halogen atom, an aryloxy group (for example, phenoxy), an alkylthio group (for example, methylthio and butylthio), an arylthio group (for example, phenylthio), an acyl group (for example, acetyl, propionyl, butyryl, and valeryl), a sulfonyl group (for example, methylsulfonyl and phenylsulfonyl), an acylamino group, a sulfonylamino group, an acyloxy group (for example, acetoxy and benzoxy), a carboxyl group, a cyano group, a sulfo group, and an amino group. Of these, suitable substituents are aryl group, an alkenyl group, and a cyano group.

It is possible to produce the aforesaid biimidazolyl compounds employing methods described in U.S. Pat. No. 3,734,733 and British Patent No. 1,271,177, or methods subject to the aforesaid methods.

Listed as specific examples of preferable compounds may be, for example, compounds described in Japanese Patent Application Open to Public Inspection No. 2000-321711.

Further, listed as similarly suitable compounds may be iodonium compounds represented by General Formula (2) described below.

General Formula (2)

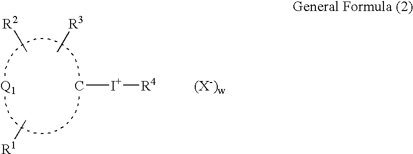

wherein Q₁ includes necessary atoms to complete a 5-, 6-, or 7-membered ring, which are selected from a carbon atom, a nitrogen atom, an oxygen atom, or a sulfur atom, R¹, R², and R³ (which may be the same or different) each represents a hydrogen atom, an alkyl group (for example, methyl, ethyl, or hexyl), an alkenyl group (for example, vinyl or allyl), an alkoxy group (for example, methoxy, ethoxy, or octyloxy), an aryl group (for example, phenyl, naphthyl, or tolyl), a hydroxyl group, a halogen atom, an aryloxy group (for example, phenoxy), an alkylthio group (for example, methylthio or butylthio), an arylthio group (for example, phenylthio), an acyl group (for example, acetyl, propionyl, butyryl, or valeryl), a sulfonyl group (for example, methylsulfonyl or phenylsulfonyl), an acylamino group, a sulfonylamino group, an acyloxy group, (for example, acetoxy or benzoxy), a carboxyl group, a cyano group, a sulfo group and an amino group. Of these, more preferable substituents include an aryl group, an alkenyl group, and a cyano group,

R⁴ represents a carboxylate group such as acetate, benzoate, and trifluoroacetate, and O—, and W represent or 1.

X⁻ represents an anionic counter ion which include as a appropriate example CH₃CO₂⁻, CH₃SO⁻ and PF₆₋. When R³ is either a sulfo group or a carboxyl group, W represents 0 and R⁴ represents O—. Incidentally, some of R¹, R², and R³ may be joined with each other to form a ring.

Of these, the compounds are particularly preferred which are represented by General Formula (3) described below.

General Formula (3)

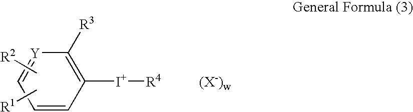

In General Formula (3), R¹, R², R³, and R⁴, X⁻, and W each is defined in aforesaid General formula (2), and Y represents either a carbon atom (in the form of —CH═of a benzene ring) or a nitrogen atom (in the form of —N═of a pyridine ring).

It is possible to synthesize the aforesaid iodonium compounds employing the production method, described in Org. Syn., 1961, and Fieser, “Advanced Organic Chemistry (Reinhold, N.Y., 1961) or the method subject to the aforesaid method.

Listed as preferable specific examples may be, for example, exemplified compounds described in Japanese Patent Publication Open to Public Inspection No. 2000-321711.

The added amount of compounds represented by aforesaid General Formulas (1) and (2) is commonly from 10⁻³ to 10⁻¹ mol/m², and is preferably from 5×10⁻³ to 5×10⁻² mol/m². Incidentally, the aforesaid compounds may be incorporated in an optional constitution layer. However, it is preferable that they are incorporated adjacent to reducing agents.

Further, as compounds which deactivate reducing agents so that they are incapable of reducing aliphatic carboxylic silver salts to silver, it is preferable that reactive species are not halogen atoms. However, compounds which release halogen atoms as an active species may be employed in combination with compounds which release active species except for halogen atoms. A number of compounds have been known which are capable of releasing halogen atoms as an active species. When they are employed in combination, the desired effects are obtained.

Listed as specific examples of compounds which generate an active halogen atom are the compounds represented by General Formula (4) described below.

General Formula (4)

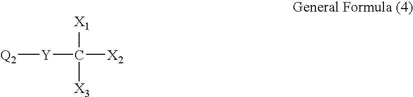

wherein Q₂ represents an aryl group or a heterocyclic group; X₁, X₂, and X₃ each represents a hydrogen atom, a halogen atom, an acyl group, an alkoxycarbonyl group, an aryloxycarbonyl group, and an aryl group, and one of them represents a halogen atom, and Y represents —C(═O)—, —SO—, or —SO₂—.

The aryl group represented by Q₂ may be a single ring or a condensed ring, is preferably a single ring having from 6 to 30 carbon atoms or a two-ring aryl group (for example, phenyl and naphthyl). Of these, a phenyl group and a naphthyl group are more preferred and a phenyl group is still more preferred.

The heterocyclic group represented by Q₂ includes 3- to 10-membered saturated or unsaturated heterocyclic group comprising at least one of N, O, or S, which may be a single ring or may further form a condensed ring with other rings.

The aforesaid heterocyclic group is preferably a 5- or 6-membered unsaturated heterocyclic group which may have a condensed ring, is more preferably a 5- or 6-membered aromatic heterocyclic group which may have a condensed ring, is still more preferably a 5- or 6-membered aromatic heterocyclic group which may have a condensed ring comprising nitrogen atom(s), and is most preferably a 5- or 6-membered aromatic heterocyclic group which may have a condensed ring comprising 1 to 4 nitrogen atoms. Heterocycles in such a heterocyclic group are preferably imidazole, pyrazole, pyridine, pyrimidine, pyrazine, pyridazine, triazole, triazine, indole, indazole, purine, thiadiazole, oxadiazole, quinoline, phthalazine, naphthylizine, quinoxaline, quinazoline, cinnoline, pteridine, acrydine, phenanthroline, phenazine, tetrazole, thiazole, oxazole, benzimidazole, benzoxazole, benzthiazole, indolenine, and tetraazaindene. Of these, preferred are imidazole, pyridine, pyrimidine, pyrazine, pyridazine, triazole, triazine, thiadiazole, oxadiazole, quinoline, phthalazine, naphthylizine, quinoxaline, quinazoline, cinnoline, tetrazole, thiazole, oxazble, benzimidazole, benzoxazole, benzthiazole, and tetraazaindene. Of these, more preferred are imidazole, pyridine, pyrimidine, pyrazine, pyridazine, triazole, triazine, thiadiazole, quinoline, phthalazine, naphthylizine, quinoxaline, quinazoline, cinnoline, tetrazole, thiazole, benzimidazole, and benzthiazole. Of these, most preferred are pyridine, thiazole, and quinoline, and benzthiazole.

The aryl group as well as the heterocyclic group represented by Q₂ may have a substituent besides —Y—C(X₁) (X₂) (X₃). Preferable substituents include an alkyl group, an alkenyl group, an aryl group, an alkoxy group, an aryloxy group, an acyloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, a sulfonyl group, a ureido group, an amidophosphate group, a halogen atom, a cyano group, a sulfo group, a carboxylic group, a nitro group, and a heterocyclic group. Of these, more preferred are an alkyl group, an aryl group, an alkoxy group, an aryloxy group, an acyl group, an acylamino group, an alkoxycarbonylamino group, an aryloxycarbonylamino group, a sulfonylamino group, a sulfamoyl group, a carbamoyl group, a ureido group, amidophosphate group, a halogen atom, a cyano group, a nitro group, and a heterocyclic group. Of these, further more preferred are an alkyl group, an aryl group, an alkoxy group, an aryloxy group, an acyl group, an acylamino group, a sulfonylamino group, a sulfamoyl group, a carbamoyl group, a halogen atom, a cyano group, a nitro group, and a heterocyclic group. Of these, most preferred are an alkyl group, an aryl group, and or halogen atom.

X₁, X₂, and X₃ each is preferably a halogen atom, a haloalkyl group, an acyl group, an alkoxycarbonyl group, an aryloxycarbonyl group, a carbamoyl group, a sulfamoyl group, a sulfonyl group or a heterocyclic group; is more preferably a halogen atom, a haloalkyl group, an acyl group, an alkoxycarbonyl group, an aryloxycarbonyl group, or a sulfonyl group; is further more preferably a halogen atom or a trihalomethyl group; and is most preferably a halogen atom. Of halogen atoms, a chlorine atom, a bromine atom, and an iodine atom are preferred; a chlorine atom or a bromine atom is more preferred; and a bromine atom is most preferred.

Y represents —C(═O)—, —SO—, or —SO₂—. Of these, —SO₂— is preferred.

The added amount of these compounds is preferably in the range which substantially causes no problems with an increase in printout silver due to the formation of silver halide. The added amount is preferably less than or equal to 150 percent, and more preferably less than or equal to 100 percent in terms of the ratio to the aforesaid compounds which do not create a halogen radical.

Incidentally, other than the aforesaid compounds, compounds, which are conventionally known as an antifoggant, may be incorporated in the silver salt photothermographic dry imaging material of the present invention. The compounds may be ones which are capable of creating reactive components in the same manner as the aforesaid compounds or others which result in different antifogging mechanism. Listed as examples of the compounds are those described in U.S. Pat. Nos. 3,589,903, 3,874,946, 4,546,075, 4,452,885, and 4,756,999, and Japanese Patent Publication Open to Public Inspection No. 59-572234, 9-288328, and 9-90550. Further listed as other antifoggants are compounds which are disclosed in U.S. Pat. No. 5,028,523, and European Patent Nos. 600,587, 605,981, and 631,176.

In the present invention, other than the aforesaid compounds, preferably employed as antifoggants as well as storage stabilizers may be compounds, which form a chelate ring with silver ions, which include compounds such as phthalic acids which have two carboxylic groups in the adjacent position and are capable of forming a chelate ring.

In the present invention, at least one of silver ion-reducing agents is a bisphenol derivative, and may be employed individually or in combination with other reducing agents which have different chemical structures. By employing such compounds, it is possible to surprisingly minimize quality degradation, due to fogging during storage, as well as to minimize tone variation during storage of silver images after thermal development of the silver salt photothermographic imaging material according to the present invention.

In the present invention, specified compounds in which at least one of silver ion-reducing agents is a bisphenol derivative is employed individually or together with other reducing agents having a different chemical structure. In the silver salt photothermographic imaging materials according to the present invention, surprisingly, it is possible to minimize performance degradation due to fogging during storage of the aforesaid photothermographic imaging materials as well as degradation of tone of silver images during storage after thermal development. Further, specifically, when employed in combination with silver saving agents, it is possible to exhibit surprising effects in which it is possible to produce excellent images having a higher maximum density even at a relatively low silver amount, desired image tone and processing variation resistance.

Preferred as reducing agents employed in the present invention are bisphenol derivatives represented by aforesaid General Formulas (S). Compounds having a ring structure, represented by General Formula (S), are more preferred. The aforesaid ring is preferably a 6-membered ring.

In General Formula (S), Z represents a group of atoms which are necessary to form 3- to 10-membered non-aromatic rings. Listed as the 3-membered rings are cyclopropyl, aziridyl, and oxiranyl; as the 4-membered rings are cylcobutyl, cyclobutenyl, oxetanyl, and azetidinyl; as the 5-membered rings are cyclopentyl, cyclopentenyl, cylopentadienyl, tetrahydrofuranyl, pyrrolidinyl, and tetrahydrothienyl; as the 6-membered rings are cyclohexyl, cyclohexenyl, cyclohexadienyl, tetrahydropyranyl, pyranyl, piperidinyl, dioxanyl, tetrahydrothiopyranyl, norcaranyl, norpinanyl, and norbornyl; as the 7-membered rings are cycloheptyl, cycloheptynyl, and cycloheptadienyl; as the 8-membered rings are cyclooctanyl, cyclooctenyl, cyclooctadienyl, and cyclooctatrienyl; as the 9-membered rings are cyclononanyl, cyclononenyl, cyclononadienyl, and cycononatrienyl; and as the 10-membered rings are cyclodecanyl, cyclodecenyl, cyclodecadienyl, and cyclodecatrienyl.

Rings are preferably from 3- to 6-membered rings, are more preferably 5- or 6-membered rings, and are most preferably 6-membered rings. Of these, hydrocarbon rings containing no heteroatoms are preferred. The ring may form a spiro bond with another ring through a spiro atom, or may form any condensed ring with another ring containing an aromatic ring. Further, the ring may have an optional substituent in its ring. Specifically listed as the substituents are a halogen atom (for example, a fluorine atom, a chlorine atom, or a bromine atom), an alkyl group (for example, a methyl group, an ethyl group, a propyl group, a butyl group, a pentyl group, an isopentyl group, a 2-ethyl-hexyl group, an octyl group, or a decyl group), a cycloalkyl group (for example, a cyclohexyl group or a cycloheptyl group), an alkenyl group (for example, an ethenyl-2-propenyl group, a 3-butenyl group, a 1-methyl-3-propenyl group, a 3-pentenyl group, or a 1-methyl-3-butenyl group), a cycloalkenyl group (for example, a 1-cycloalkenyl group or a 2-cycloalkenyl group), an alkynyl group (for example, an ethynyl group or a 1-propynyl group), an alkoxy group (for example, a methoxy group, an ethoxy group, or a propoxy group), an alkylcarbonyloxy group (for example, an acetyloxy group), an alkylthio group (for example, a methylthio group or trifluoromethylthio group), a carboxyl group, an alkylcarbonylamino group (for example, an acetylamino group), a ureido group (for example, a methylaminocarbonylamino group), an alkylsulfonylamino group (for example, a methanesulfonylamino group), an alkylsulfonyl group (for example, a methanesulfonyl group and a trifluoromethanesulfonyl group), a carbamoyl group (for example, a carbamoyl group or an N,N-dimethylcarbamoyl group, an N-morpholinocarbonyl group), a sulfamoyl group (for example, a sulfamoyl group, an N,N-dimethylsulfamoyl group, or a morpholinosulfamoyl group), a trifluoromethyl group, a hydroxyl group, a nitro group, a cyano group, an alkylsulfonamido group (for example, a methanesulfonamido group or a butanesulfonamido group), an alkylamino group (for example, an amino group, an N,N-dimethylamino group, or an N,N-diethylamino group), a sulfo group, a phosphono group, a sulfite group, a sulfino group, an alkylsulfonylaminocarbonyl group (for example, a methanesulfonylaminocarbonyl group or an ethanesulfonylaminocarbonyl group), an alkylcarbonylaminosulfonyl group (for example, an acetamidosulfonyl group or a methoxyacetamidosulfonyl group), an alkynylaminocarbonyl group (for example, an acetoamidocarbonyl group or a methoxyacetoamidocarbonyl group), and an alkylsulfinylaminocarbonyl group (for example, a methanesulfinylaminocarbonyl group or an ethanesulfinylaminocarbonyl group). Further, when two or more substituents are employed, they may be the same or different. Of these, an alkyl group is particularly preferred. R₀′ and R₀″ each represents a hydrogen atom, an alkyl group, an aryl group, or a heterocyclic group. Preferred as the alkyl groups are ones having from 1 to 10 carbon atoms. Listed as specific examples are a methyl group, an ethyl group, a propyl group, an isopropyl group, a butyl group, a t-butyl group, a pentyl group, an isopentyl group, a 2-ethyl-hexyl group, an octyl group, a decyl group, a cyclohexyl group, a cycloheptyl group, a 1-methylcyclohexyl group, an ethenyl-2-propenyl group, a 3-butenyl group, a 1-methyl-3-propenyl group, a 3-pentenyl group, a 1-methyl-3-butenyl group, a 1-cycloalkenyl group, a 2-cycloalkenyl group, an ethynyl group, and a 1-propynyl group. More preferably listed are a methyl group, an ethyl group, an isopropyl group, a t-butyl group, a cyclohexyl group, and a 1-methylcyclohexyl group. Further more preferably listed are a methyl group, a t-butyl group, and a 1-methylcyclohexyl group. Of these, a methyl group is most preferred. Listed as specific examples of the aryl groups are a phenyl group, a naphthyl group, and an anthranyl group. Listed as specific examples of the heterocyclic groups are aromatic heterocyclic groups such as a pyridine group, a quinoline group, an isoquinoline group, an imidazole group, a pyrazole group, a triazole group, an oxazole group, a thiazole group, an oxadiazole group, a thiadiazole group, and a tetrazole group, as well as non-aromatic heterocyclic groups such as a piperizino group, a morpholine group, a tetrahydrofuryl group, a tetrahydrothienyl group, and a tetrahydropyranyl group. The groups may have substituents. Listed as the substituents may be those in the rings as above described. A plurality of Ro and Ro may be the same or different. The most preferred case is that all R₀′ and R₀″ represent a methyl group.

R_{X} represents a hydrogen atom or an alkyl group, which preferably contains from 1 to 10 carbon atoms. Listed as specific examples are a methyl group, an ethyl group, a propyl group, an isopropyl group, a butyl group, a t-butyl group, a pentyl group, an isopentyl group, a 2-ethyl-hexyl group, an octyl group, a decyl group, a cyclohexyl group, a cycloheptyl group, a 1-methylcyclohexyl group, an ethenyl-2-propenyl group, a 3-butenyl group, a 1-methyl-3-propenyl group, a 3-pentenyl group, a 1-methyl-3-butenyl group, a 1-cycloalkenyl group, a 2-cycloalkenyl group, an ethynyl group, and a 1-propynyl group. More preferably listed are a methyl group, an ethyl group, and an isopropyl group. Rₓ is preferably a hydrogen atom.

Q₀ represents a group which can be substituted onto a benzene ring. Specifically listed are an alkyl group having from 1 to 25 carbon atoms (such as a methyl group, an ethyl group, a propyl group, an isopropyl group, a tert-butyl group, a pentyl group, a hexyl group, and a cyclohexyl group), a halogenated alkyl group (such as a trifluoromethyl group and a perfluoroctyl group), a cycloalkyl group (such as a cyclohexyl group and a cyclopentyl group), an alkynyl group (such as a propargyl group), a glycidyl group, an acrylate group, a methacrylate group, an aryl group (such as a phenyl group), a heterocyclic group (such as a pyridyl group, a thiazolyl group, an oxazolyl group, an imidazolyl group, a furyl group, a pyrrolyl group, a pirazinyl group, a pyrimidinyl group, a pyridazinyl group, a selenazolyl group, a sulforanyl group, a piperidinyl group, a pyrazolyl group, and a tetrazolyl group), a halogen atom (such as a chlorine atom, a bromine atom, an iodine atom, and a fluorine atom), an alkoxy group (such as a methoxy group, an ethoxy group, a propyloxy group, a pentyloxy group, a cyclopentyloxy group, a hexyloxy group, and a cyclohexyloxy group), an aryloxy group (such as a phenoxy group), an alkoxycarbonyl group (such as a methyloxycarbonyl group, an ethyloxycarbonyl group, and a butyloxycarbonyl group), an aryloxycarbonyl group (such as a phenyloxycarbonyl group), a sulfonamido group (such as a methanesulfonamido group, an ethanesulfonamido group, a butanesulfonamido group, a hexanesulfonamido group, a cyclohexanesulfonamido group, and a benzenesulfonamido group), a sulfamoyl group (such as an aminosulfonyl group, a methylsulfonyl group, a dimethylaminosulfonyl group, a butylaminosulfonyl group, a hexylaminosulfonyl group, a cyclohexylaminosulfonyl group, a phenylaminosulfonyl group, and a 2-pyridylaminosulfonyl group), a urethane group (such as a methylureido group, an ethylureido group, a pentylureido group, a cyclohexylureido group, a phenylureido group, and a 2-pyridylureido group), an acyl group (such as an acetyl group, a propionyl group, a butanoyl group, a hexanoyl group, a cyclohexanoyl group, a benzoyl group, and a pyridinoyl group), a carbamoyl group (such as an aminocarbonyl group, a methylaminocarbonyl group, a dimethylaminocarbonyl group, a propylaminocarbonyl group, a pentylaminocaerbonyl group, a cyclohexylaminocarbonyl group, a phenylaminocarbonyl group, and a 2-pyridinylaminocarbonyl group), an amido group (such as an acetamide group, a propionamido group, a butanamido group, a hexanamido group, and a benzamido group), a sulfonyl group (such as a methylsulfonyl group, an ethylsulfonyl group, a butylsulfonyl group, a cyclohexylsulfonyl group, a phenylsulfonyl group, and a 2-pyridylsulfonyl group), an amino group (such as an amino group, an ethylamino group, a dimethylamino group, a butylamino group, a cyclopentylamino group, an anilino group, and a 2-pyridylamino group), a cyano group, a nitro group, a sulfo group, a carboxyl group, a hydroxyl group, an oxamoyl group. Further, the group may be substituted with the groups. n and m each represents an integer of 0, 1, and 2. However, most preferably, n and m each represents 0.

Specific examples of silver ion reducing agents employed in the present invention will now be listed. However, the present invention is not limited theses examples.

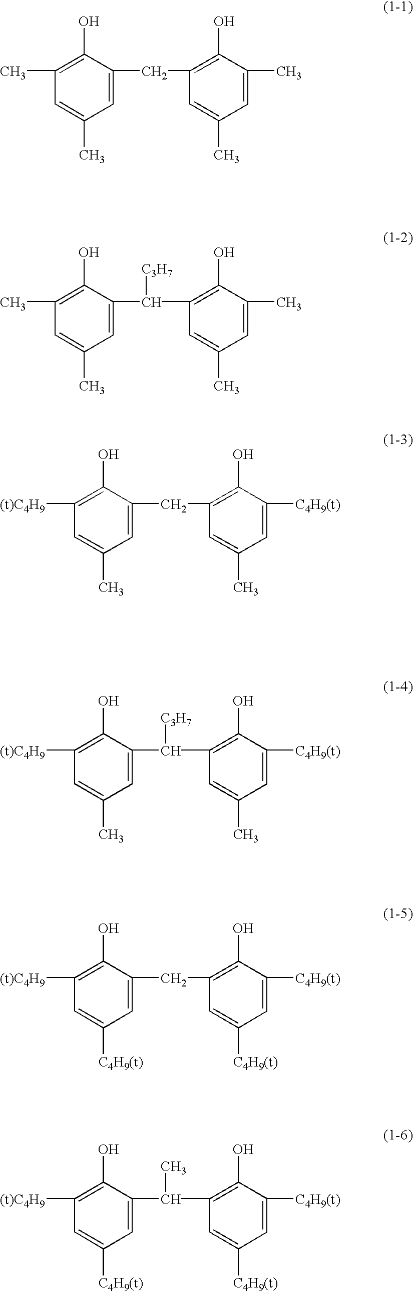

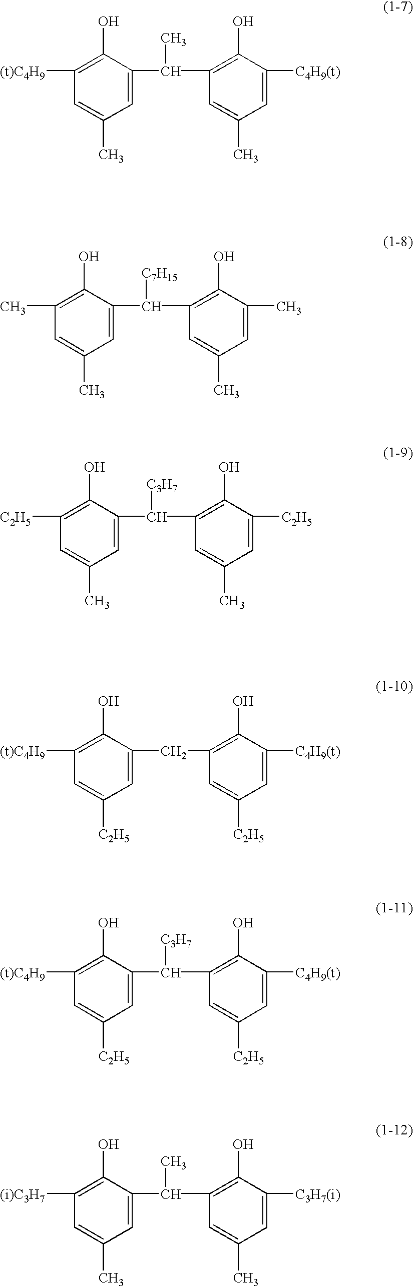

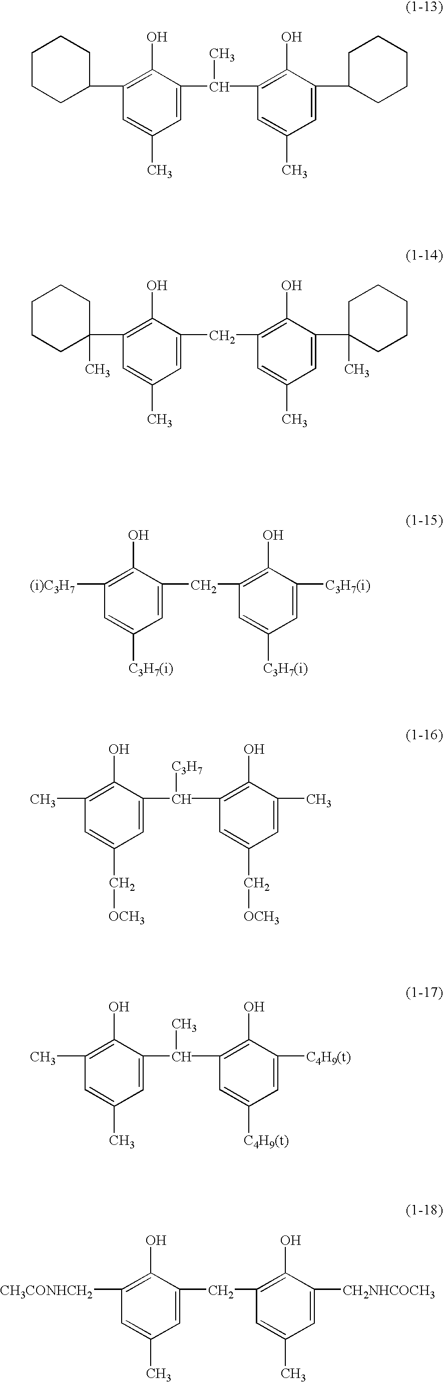

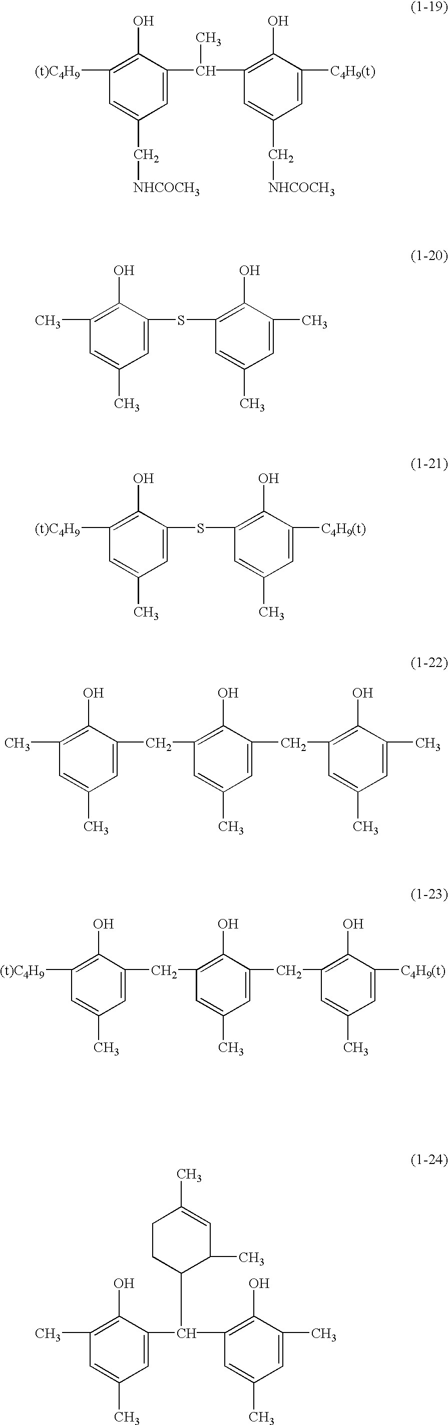

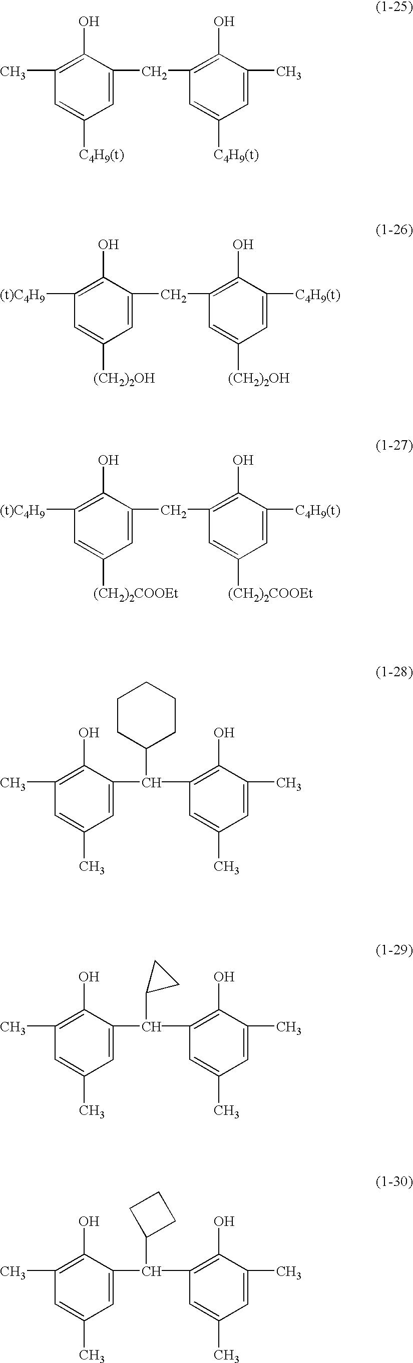

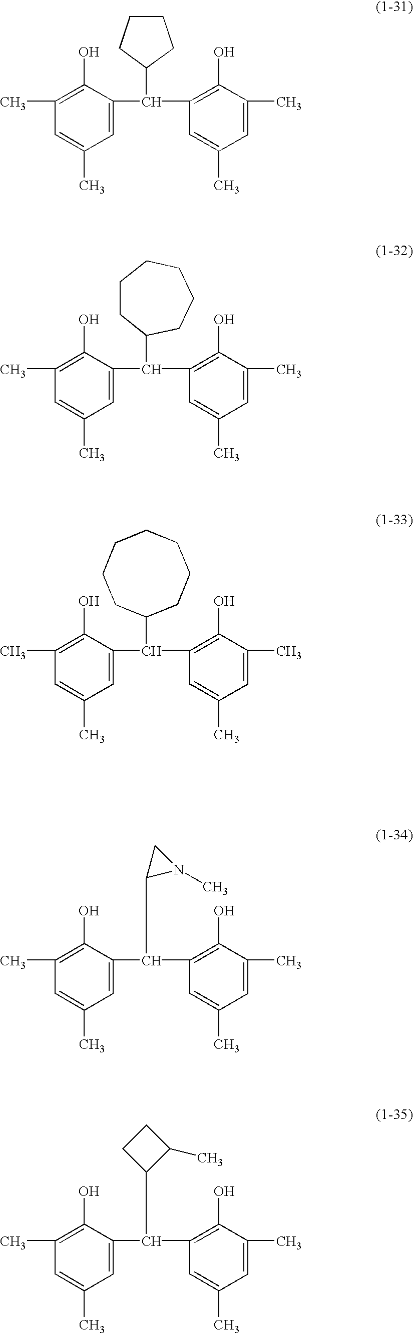

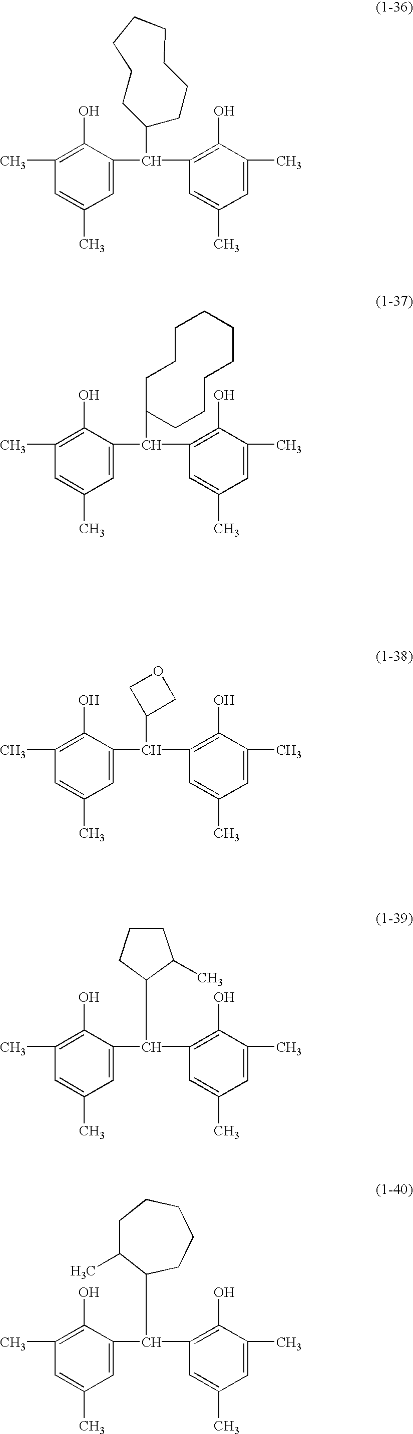

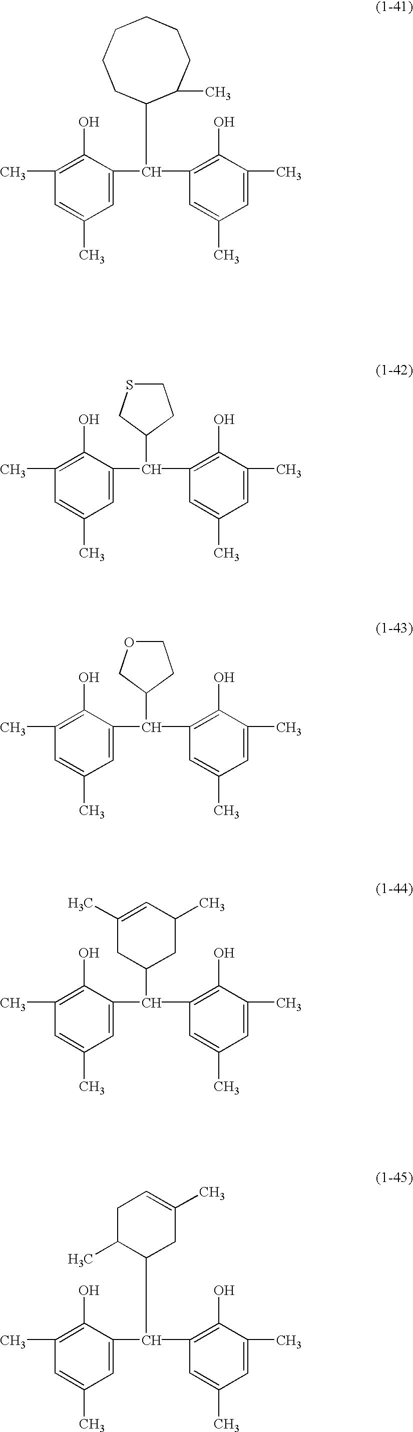

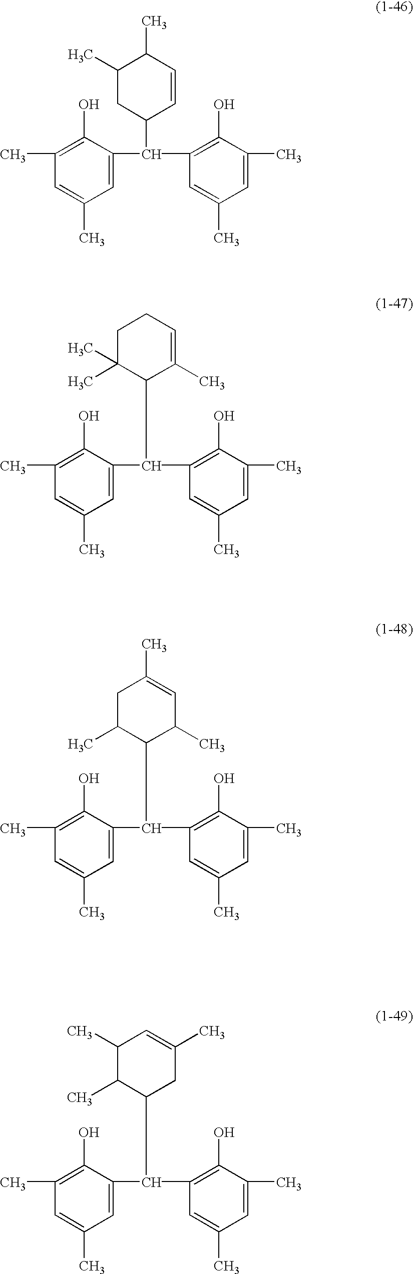

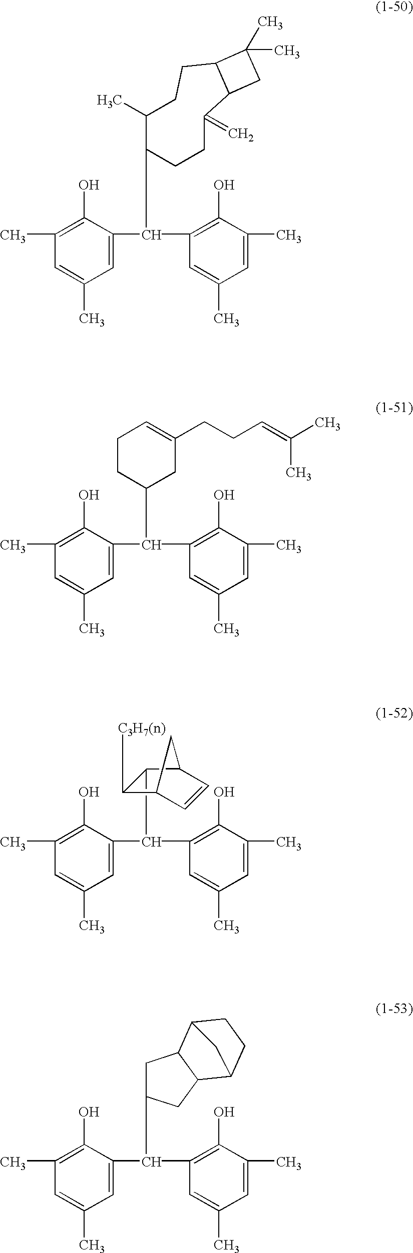

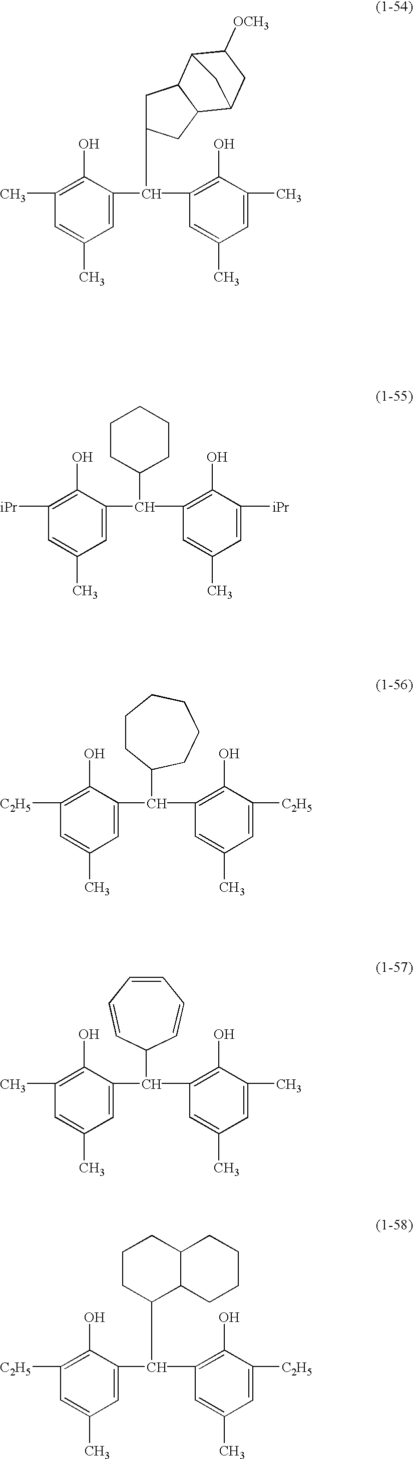

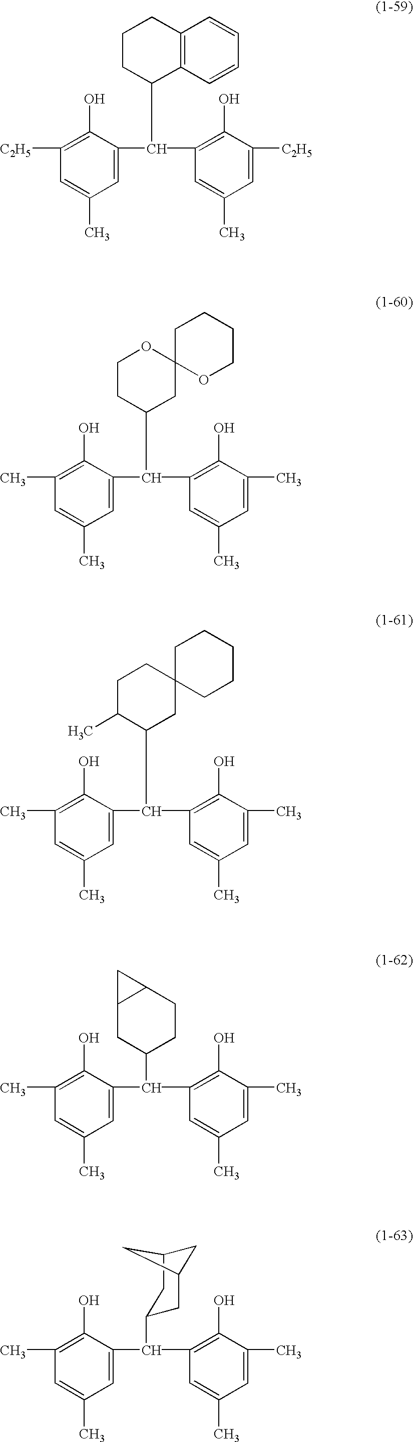

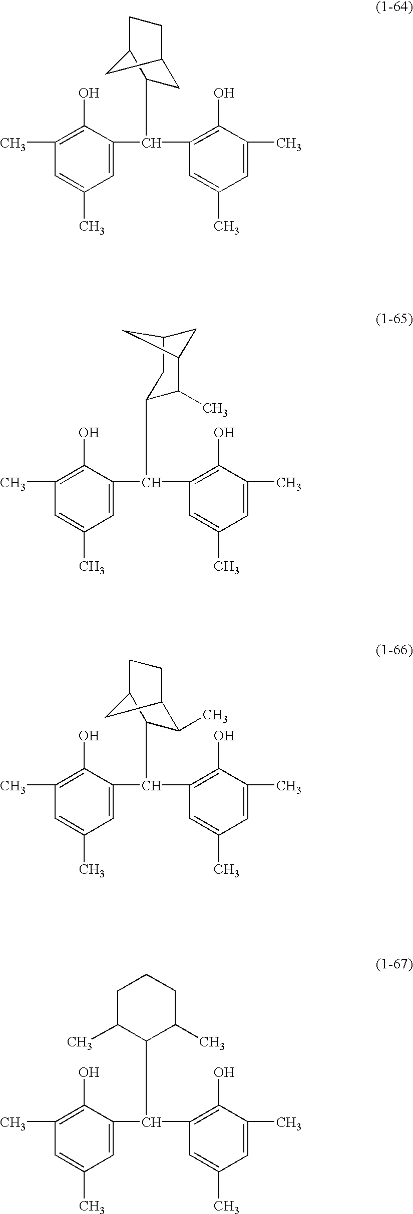

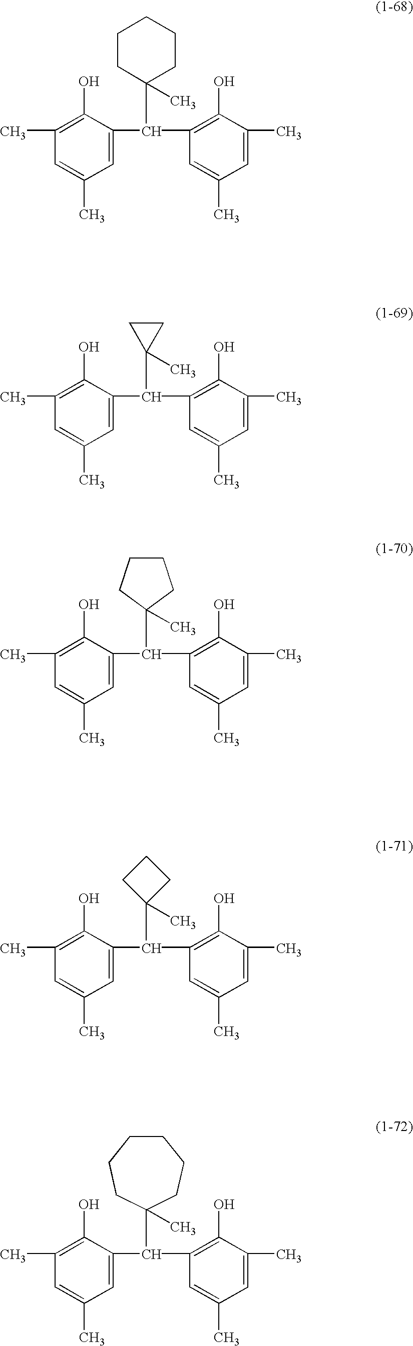

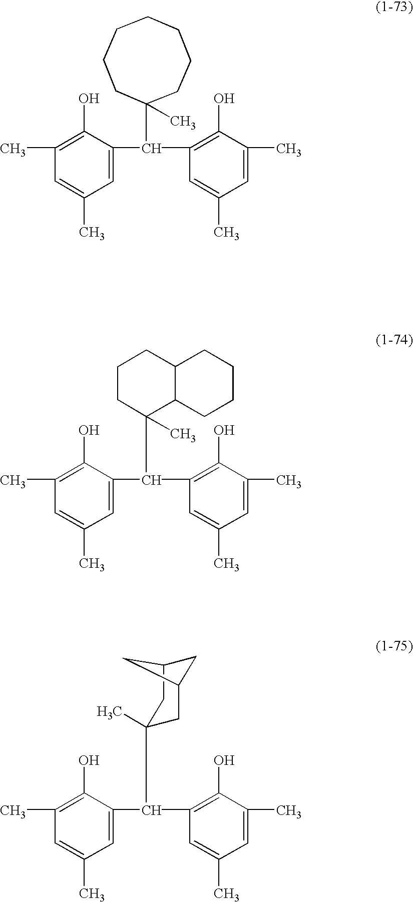

For example, the compounds represented by General Formulas (S) can easily be synthesized, employing conventional methods known in the art. For example, a preferable synthetic scheme of the compounds represented by General Formula (S) will be illustrated below.

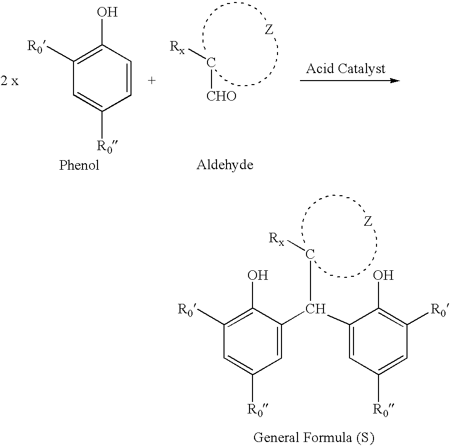

Namely, two equivalents of phenol and one equivalent of aldehyde are mixed in the absence of a solvent or are dissolved in suitable organic solvents and dispersed. Subsequently, acid in a catalytic amount is added, and the resulting mixture undergoes reaction preferably at −20 to 120° C. for 0.5 to 60.0 hours, whereby it is possible to prepare a target compound represented by General Formula (S) at the desired yield.

The aforesaid organic solvents are preferably hydrocarbon based organic solvents, and specifically include benzene, toluene, xylene, dichloromethane, and chloroform. Of these, toluene is preferred. However, from the viewpoint of achieving the desired yield, it is most preferable that the reaction is performed in the absence of solvents. Employed as acid catalysts may be all inorganic acids and organic acids. Of these, concentrated hydrochloric acid, p-toluenesulfonic acid and phosphoric acid are preferably employed. The catalyst is preferably employed in an amount of 0.001 to 1.500 equivalents with respect to the corresponding aldehyde. The reaction temperature is preferably near room temperature (15 to 25° C.) and the reaction time is preferably from 3 to 20 hours.

In the present invention, it is possible to employ compounds described below as a silver ion reducing agent; namely, polyphenol compounds such as 2,2′-dihyroxy-1,1′-binaphthyl and 6,6′-dibromo-2,2,2,2′-dihydroxy-1,1′-binaphthyl described in U.S. Pat. Nos. 3,589,903 and 4,021,249, British Patent No. 1,486,148, Japanese Patent Publication Open to Public Inspection Nos. 51-51933, 50-36110, 50-116023, and 52-84727, and Japanese Patent Publication No. 51-35727; bisnaphthols described in U.S. Pat. No. 3,672,904; and sulfonamidophenols or sulfonamidonaphthols such as 4-benzenesulfonamidophenol, 2-benzenesulfonamidophenol, 2,6-dichloro-4-benzenesulfonamidophenol, and 4-benxenesulfonamidonaphthol described in U.S. Pat. No. 3,801,321.

The employed amount of the reducing agents represented by aforesaid General Formula (S) is preferably from 1×10⁻² to 10 mol per mol of silver, and is more preferably from 1×10⁻² to 1.5 mol.

The amount of reducing agents, employed in the photothermographic dry imaging material of the present invention, varies depending on the types of organic silver salts as well as on the reducing agents and other additives. However, the amount is generally from 0.05 to 10.00 mol per mol of organic silver salts, and is preferably from 0.1 to 3.0 mol. In such a range, two or more types of the reducing agents may be employed in combination. In the present invention, it is occasionally preferable that just prior to coating, the aforesaid reducing agents are added to a photosensitive emulsion comprised of photosensitive silver halide, organic silver salt particles, and solvents so as to minimize the variation of photographic properties during the period of its standing.

The photosensitive silver halide of the present invention may undergo chemical sensitization. For instance, it is possible to create chemical sensitization centers (being chemical sensitization nuclei) utilizing compounds which release chalcogen such as sulfur, as well as noble metal compounds which release noble metals ions, such as gold ions, while employing methods described in, for example, Japanese Patent Application Nos. 2000-057004 and 2000-061942. It is preferable that the aforesaid silver halide is chemically sensitized employing organic sensitizers containing chalcogen atoms, as described below.

It is preferable that the aforesaid organic sensitizers, comprising chalcogen atoms, have a group capable of being adsorbed onto silver halide grains as well as unstable chalcogen atom positions.

Employed as the aforesaid organic sensitizers may be those having various structures, as disclosed in Japanese Patent Publication Open to Public Inspection Nos. 60-150046, 4-109240, and 11-218874. Of these, the aforesaid organic sensitizer is preferably at least one of compounds having a structure in which the chalcogen atom bonds to a carbon atom, or to a phosphorus atom, via a double bond.

The employed amount of chalcogen compounds as an organic sensitizer varies depending on the types of employed chalcogen compounds, silver halide grains, and reaction environments during performing chemical sensitization, but is preferably from 10⁻⁸ to 10⁻² mol per mol of silver halide, and is more preferably from 10⁻⁷ to 10⁻³ mol. The chemical sensitization environments are not particularly limited. However, it is preferable that in the presence of compounds which diminish chalcogenized silver or silver nuclei, or decrease their size, especially in the presence of oxidizing agents capable of oxidizing silver nuclei, chalcogen sensitization is performed employing organic sensitizers, containing chalcogen atoms. The sensitization conditions are that the pAg is preferably from 6 to 11, but is more preferably from 7 to 10, while the pH is preferably from 4 to 10, but is more preferably from 5 to 8. Further, the sensitization is preferably carried out at a temperature of lass than or equal to 30° C.

Accordingly, in the silver salt photothermographic dry imaging material of the present invention, it is preferable to employ a photosensitive emulsion prepared in such a manner that photosensitive silver halide undergoes chemical sensitization at a temperature of less than or equal to 30° C. in the presence of oxidizing agents capable of oxidizing silver nuclei on the grains; and that the resultant silver halide is mixed with aliphatic carboxylic acid silver salts; and further that the resultant mixture is dispersed, followed by dehydration and drying.

Further, it is preferable that chemical sensitization, employing the aforesaid organic sensitizers, is carried out in the presence of either spectral sensitizing dyes or compounds containing heteroatoms, which exhibit the adsorption onto silver halide grains. By carrying out chemical sensitization in the presence of compounds which exhibit adsorption onto silver halide grains, it is possible to minimize the dispersion of chemical sensitization center nuclei, whereby it is possible to achieve higher speed as well as lower fogging. Though spectral sensitizing dyes will be described below, the compounds comprising heteroatoms, which result in adsorption onto silver halide grains, as descried herein, refer to, as preferable examples, nitrogen containing heterocyclic compounds described in Japanese Patent Publication Open to Public Inspection No. 3-24537. Listed as heterocycles in nitrogen-containing heterocyclic compounds may be a pyrazole ring, a pyrimidine ring, a 1,2,4-triazine ring, a 1,2,3-triazole ring, a 1,3,4-thiazole ring, a 1,2,3-thiazole ring, a 1,2,4-thiadiazole ring, a 1,2,5-thiadiazole ring, 1,2,3,4-tetrazole ring, a pyridazine ring, and a 1,2,3-triazine ring, and a ring which is formed by combining 2 or 3 of the rings such as a triazolotriazole ring, a diazaindene ring, a triazaindene ring, and a pentaazaindenes ring. It is also possible to employ heterocyclic rings such as a phthalazine ring, a benzimidazole ring, an indazole ring and a benzthiazole ring, which are formed by condensing a single heterocyclic ring and an aromatic ring.

Of these, preferred is an azaindene ring. Further, preferred are azaindene compounds having a hydroxyl group, as a substituent, which include compounds such as hydroxytriazaindene, tetrahydroxyazaindene, and hydroxypentaazaindene.

The aforesaid heterocyclic ring may have substituents other than a hydroxyl group. As substituents, the aforesaid heterocyclic ring may have, for example, an alkyl group, a substituted alkyl group, an alkylthio group, an amino group, a hydroxyamino group, an alkylamino group, a dialkylamino group, an arylamino group, a carboxyl group, an alkoxycarbonyl group, a halogen atom, and a cyano group.

The added amount of these heterocyclic compounds varies widely depending on the size and composition of silver halide grains, and other conditions. However, the amount is in the range of about 10⁻⁶ to 1 mol per mol with respect to silver halide, and is preferably in the range of 10⁻⁴ to 10⁻¹ mol.

The photosensitive silver halide of the present invention may undergo noble metal sensitization utilizing compounds which release noble metal ions such as gold ions. For example, employed as gold sensitizers may be chloroaurates and organic gold compounds.

Further, other than the aforesaid sensitization methods, it is possible to employ a reduction sensitization method. Employed as specific compounds for the reduction sensitization may be ascorbic acid, thiourea dioxide, stannous chloride, hydrazine derivatives, boron compounds, silane compounds, and polyamine compounds. Further, it is possible to perform reduction sensitization by ripening an emulsion while maintaining a pH higher than or equal to 7 or a pAg less than or equal to 8.3.

Silver halide which undergoes the chemical sensitization, according to the present invention, includes one which has been formed in the presence of organic silver salts, another which has been formed in the absence of organic silver salts, or still another which has been formed by mixing those above.

In the present invention, it is preferable that the surface of photosensitive silver halide grains undergoes chemical sensitization and the resulting chemical sensitizing effects are substantially lost after the thermal development process. “Chemical sensitization effects are substantially lost after the thermal development process”, as described herein, means that the speed of the aforesaid imaging material which has been achieved by the aforesaid chemical sensitization techniques decreases to 1.1 times or less compared to the speed of aforesaid material which does not undergo chemical sensitization.

It is preferable that photosensitive silver halide in the present invention is adsorbed by spectral sensitizing dyes so as to result in spectral sensitization. Employed as spectral sensitizing dyes may be cyanine dyes, merocyanine dyes, complex cyanine dyes, complex merocyanine dyes, homopolar cyanine dyes, styryl dyes, hemicyanine dyes, oxonol dyes, and hemioxonol dyes. For example, employed may be sensitizing dyes described in Japanese Patent Publication Open to Public Inspection Nos. 63-159841, 60-140335, 63-231437, 63-259651, 63-304242, and 63-15245, and U.S. Pat. Nos. 4,639,414, 4,740,455, 4,741,966, 4,751,175, and 4,835,096.

Useful sensitizing dyes, employed in the present invention, are described in, for example, Research Disclosure, Item 17645, Section IV-A (page 23, December 1978) and Item 18431, Section X (page 437, August 1978) and publications further cited therein. It is specifically preferable that those sensitizing dyes are used which exhibit spectral sensitivity suitable for spectral characteristics of light sources of various types of laser imagers, as well as of scanners. For example, preferably employed are compounds described in Japanese Patent Publication Open to Public Inspection Nos. 9-34078, 9-54409, and 9-80679.

Useful cyanine dyes include, for example, cyanine dyes having basic nuclei such as a thiazoline nucleus, an oxazoline nucleus, a pyrroline nucleus, a pyridine nucleus, an oxazole nucleus, a thiazole nucleus, a selenazole nucleus, and an imidazole nucleus. Useful merocyanine dyes, which are preferred, comprise, in addition to the basic nuclei, acidic nuclei such as a thiohydantoin nucleus, a rhodanine nucleus, an oxazolizinedione nucleus, a thiazolinedione nucleus, a barbituric acid nucleus, a thiazolinone nucleus, a marononitryl nucleus, and a pyrazolone nucleus.

In the present invention, it is possible to employ sensitizing dyes which exhibit spectral sensitivity, specifically in the infrared region. Listed as preferably employed infrared spectral sensitizing dyes are infrared spectral sensitizing dyes disclosed in U.S. Pat. Nos. 4,536,473, 4,515,888, and 4,959,294.

Specifically preferred as the infrared spectral sensitizing dyes are long chain polymethine dyes which are characterized in that a sulfinyl group is substituted onto the benzene ring of a benzazole ring.

It is possible to easily synthesize the aforesaid infrared sensitizing dyes, employing the method described in F. M. Harmer, “The Chemistry of Heterocyclic Compounds, Volume 18, The Cyanine Dyes and Related Compounds (A. Weissberger ed., published by Interscience, New York, 1964).

These infrared sensitizing dyes may be added at any time after preparing the silver halide. For example, the dyes may be added to solvents, or the dyes, in a so-called solid dispersion state in which the dyes are dispersed into minute particles, may be added to a photosensitive emulsion comprising silver halide grains or silver halide grains/aliphatic carboxylic acid silver salts. Further, in the same manner as the aforesaid heteroatoms containing compounds which exhibit adsorption onto silver halide grains, the dyes are adsorbed onto silver halide grains prior to chemical sensitization, and subsequently, undergo chemical sensitization, whereby it is possible to minimize the dispersion of chemical sensitization center nuclei so at to enhance speed, as well as to decrease fogging.

In the present invention, the aforesaid spectral sensitizing dyes may be employed individually or in combination. Combinations of sensitizing dyes are frequently employed when specifically aiming for supersensitization.

An emulsion comprising photosensitive silver halide as well as aliphatic carboxylic acid silver salts, which are employed in the silver salt photothermographic dry imaging material of the present invention, may comprise sensitizing dyes together with compounds which are dyes having no spectral sensitization or have substantially no absorption of visible light and exhibit supersensitization, whereby the aforesaid silver halide grains may be supersenstized.

Useful combinations of sensitizing dyes and dyes exhibiting supersensitization, as well as materials exhibiting supersensitization, are described in Research Disclosure Item 17643 (published December 1978), page 23, Section J of IV; Japanese Patent Publication Nos. 9-25500 and 43-4933; and Japanese Patent Publication Open to Public Inspection Nos. 59-19032, 59-192242, and 5-431432. Preferred as supersensitizers are hetero-aromatic mercapto compounds or mercapto derivatives.

Ar—SM

wherein M represents a hydrogen atom or an alkali metal atom, and Ar represents an aromatic ring or a condensed aromatic ring, having at least one of a nitrogen, sulfur, oxygen, selenium, or tellurium atom. Hetero-aromatic rings are preferably benzimidazole, naphthoimidazole, benzimidazole, naphthothiazole, benzoxazole, naphthooxazole, benzoselenazole, benztellurazole, imidazole, oxazole, pyrazole, triazole, triazine, pyrimidine, pyridazine, pyrazine, pyridine, purine, quinoline, or quinazoline. On the other hand, other hetero-aromatic rings are also included.

Incidentally, mercapto derivatives, when incorporated in the dispersion of aliphatic carboxylic acid silver salts and/or a silver halide grain emulsion, are also included which substantially prepare the mercapto compounds. Specifically, listed as preferred examples are the mercapto derivatives described below.

Ar—S—S—Ar

wherein Ar is the same as the mercapto compounds defined above.

The aforesaid hetero-aromatic rings may have a substituent selected from the group consisting of, for example, a halogen atom (for example, Cl, Br, and I), a hydroxyl group, an amino group, a carboxyl group, an alkyl group (for example, an alkyl group having at least one carbon atom and preferably having from 1 to 4 carbon atoms), and an alkoxy group (for example, an alkoxy group having at least one carbon atom and preferably having from 1 to 4 carbon atoms).

Other than the aforesaid supersensitizers, employed as supersensitizers may be compounds represented by General Formula (5), shown below, which is disclosed in Japanese Patent Application No. 2000-070296 and large ring compounds.

General Formula (5)

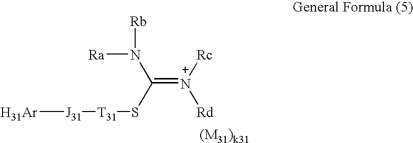

wherein H₃₁Ar represents either an aromatic hydrocarbon group or an aromatic heterocyclic group; T₃₁ represents a divalent linking group comprised of an aliphatic hydrocarbon group or a linking group; J₃₁ represents a divalent linking group containing at least one of an oxygen atom, a sulfur atom, or a nitrogen atom or a linking group; Ra, Rb, Rc, and Rd each represents a hydrogen atom, an acyl group, an aliphatic hydrocarbon group, an aryl group, or a heterocyclic group, or Ra and Rb, Rc and Rd, Ra and Rc, or Rb and Rc can be joined together to form a nitrogen-containing heterocyclic group; M₃₁ represents an ion necessary to offset the charge in the molecule; and k₃₁ represents the number of ions necessary to offset the charge in the molecule.

In General Formula (5), the divalent linking group represented by T₃₁, comprised of an aliphatic hydrocarbon group, includes a straight chain, branched or cyclic alkylene group (having preferably from 1 to 20 carbon atoms, more preferably from 1 to 16 carbon atoms, and further more preferably from 1 to 12 carbon atoms), an alkenyl group (having preferably from 2 to 20 carbon atoms, more preferably from 2 to 16 carbon atoms, and further more preferably from 2 to 12 carbon atoms), an alkynyl group (having preferably from 2 to 20 carbon atoms, more preferably from 2 to 16 carbon atoms, and further more preferably from 2 to 12 carbon atoms), which may have a substituent. The substituent includes, for example, as an aliphatic hydrocarbon group, a straight chain, branched or cyclic alkyl group (having preferably from 1 to 20 carbon atoms, more preferably from 1 to 16 carbon atoms, and further more preferably from 1 to 12 carbon atoms), an alkenyl group (having preferably from 2 to 20 carbon atoms, more preferably from 2 to 16 carbon atoms, and further more preferably from 2 to 12 carbon atoms), an alkynyl group (having preferably from 2 to 20 carbon atoms, more preferably from 2 to 16 carbon atoms, and further more preferably from 2 to 12 carbon atoms); as an aryl group, a single ring or a fused ring aryl group (for example, phenyl and naphthyl are listed, and of these, phenyl is preferred); and as a heterocyclic group, a 3- to 10-membered saturated and unsaturated heterocyclic group (for example, 2-thiszolyl, 1-piperadinyl, 2-pyridyl, 3-pyridyl, 2-furyl, 2-thienyl, 2-benzimidazolyl, and carbazolyl). The heterocyclic rings in these groups may be a single ring or may form a fused ring with other rings. These groups may have a substituent at an optional position. Listed as the substituents are, for example, an alkyl group (including a cycloalkyl group, and aralkyl group, and having preferably from 1 to 20 carbon atoms, more preferably from 1 to 12 carbon atoms, and further more preferably from 1 to 8 carbon atoms, and listed as, for example, a methyl group, an ethyl group, an n-propyl group, an isopropyl group, an n-butyl group, a tert-butyl group, an n-heptyl group, an n-octyl group, an n-decyl group, an n-undecyl group, an n-hexadecyl group, a cyclopropyl group, a cyclopentyl group, a cyclohexyl group, a benzyl group, and a phenethyl group), an alkenyl group (having preferably from 2 to 20 carbon atoms, more preferably from 2 to 12 carbon atoms, and further more preferably from 2 to 8 carbon atoms, and including, for example, a vinyl group, an allyl group, a 2-butenyl group, and a 3-pentenyl group); an alkynyl group (having preferably from 2 to 20 carbon atoms, more preferably from 2 to 12 carbon atoms, and further more preferably from 2 to 8 carbon atoms, and including, for example, a propagyl group and a 3-pentynyl group); an aryl group (having preferably from 6 to 30 carbon atoms, more preferably from 6 to 20 carbon atoms, and further more preferably from 6 to 12 carbon atoms, and including, for example, a phenyl group, a p-tolyl group, an o-aminophenol group, and a naphthyl group); an amino group (having preferably from 0 to 20 carbon atoms, further more preferably from 0 to 10 carbon atoms, and most preferably from 0 to 6 carbon atoms, and including, for example, an amino group, a methylamino group, an ethylamino group, a dimethylamino group, a diethylamino group, a diphenylamino group, and a dibenzylamino group); an imino group (having preferably from 1 to 20 carbon atoms, more preferably from 1 to 18 carbon atoms, and furthermore preferably from 1 to 12 carbon atoms, and including, for example, a methylamino group, an ethylimino group, a propylimino group, and a phenylimino group); an alkoxy group (having preferably from 1 to 20 carbon atoms, more preferably from 1 to 12 carbon atoms, and further more preferably from 1 to 8 carbon atoms, and including, for example, a methoxy group, an ethoxy group, and a butoxy group); an aryloxy group (having preferably from 6 to 20 carbon atoms, more preferably from 6 to 16 carbon atoms, and furthermore preferably from 6 to 12 carbon atoms, and including, for example, a phenyloxy group and a naphthyloxy group); an acyl group (having preferably from 1 to 20 carbon atoms, more preferably from 1 to 16 carbon atoms, and furthermore preferably from 1 to 12 carbon atoms, and including, for example, acetyl group, a benzoyl group, a formyl group, and a pivaloyl group); an alkoxycarbonyl group (having preferably from 2 to 20 carbon atoms, more preferably from 2 to 16 carbon atoms, and further more preferably from 2 to 12 carbon atoms, and including, for example, a methoxycarbonyl group and an ethoxycarbonyl group); an aryloxycarbonyl group (having preferably from 7 to 20 carbon atoms, more preferably from 7 to 16 carbon atoms, and furthermore preferably from 7 to 10 carbon atoms, and including, for example, phenyloxycarbonyl group); an acyloxy group (having preferably from 1 to 20 carbon atoms, more preferably from 1 to 16 carbon atoms, and furthermore preferably from 1 to 10 carbon atoms, and including, for example, an acetoxy group and a benzoyloxy group); an acylamino group (having preferably from 1 to 20 carbon atoms, more preferably from 1 to 16 carbon atoms, and further more preferably from 1 to 10 carbon atoms, and including, for example, an acetylamino group and a benzoylamino group); an alkoxycarbonyl group (having preferably from 2 to 20 carbon atoms, more preferably from 2 to 16 carbon atoms, and further more preferably from 2 to 12 carbon atoms, and including, for example, a methoxycarbonylamino group); an aryloxycarbonylamino group (having preferably from 7 to 20 carbon atoms, more preferably from 7 to 16 carbon atoms, and further more preferably from 7 to 12 carbon atoms, and including, for a phenyloxycarbonylamino group); a sulfonylamino group (having preferably from 1 to 20 carbon atoms, more preferably from 1 to 16 carbon atoms, and furthermore preferably from 1 to 12 carbon atoms, and including, for example, methanesulfonylamino group and a benzenesulfonylamino group); a sulfamoyl group (having preferably from 0 to 20 carbon atoms, more preferably from 0 to 16 carbon atoms, and further more preferably from 0 to 12 carbon atoms, and including, for example, a sulfamoyl group, a methylsulfamoyl group, a dimethylsulfamoyl group, and a phenylsulfamoyl group); a carbamoyl group (having preferably from 1 to 20 carbon atoms, more preferably from 1 to 16 carbon atoms, and further more preferably from 1 to 12 carbon atoms, and including, for example, a carbamoyl group, a methylcarbamoyl group, a diethylcarbamoyl group, and a phenylcarbamoyl group); an alkylthio group (having preferably from 1 to 20 carbon atoms, more preferably from 1 to 16 carbon atoms, and further more preferably from 1 to 12 carbon atoms, and including, for example, a methylthio group and an ethylthio group); an arylthio group (having preferably from 6 to 20 carbon atoms, more preferably from 6 to 16 carbon atoms, and further more preferably from 6 to 12 carbon atoms, and including, for example, a phenylthio group); a sulfonyl group (having preferably from 1 to 20 carbon atoms, more preferably from 1 to 16 carbon atoms, and further more preferably from 1 to 12 carbon atoms, and including, for example, a methanesulfonyl group and a tocyl group); a sulfinyl group (having preferably from 1 to 20 carbon atoms, more preferably from 1 to 16 carbon atoms, and further more preferably from 1 to 12 carbon atoms, and including, for example, a methanesulfonyl group, a benzenesulfonyl group); an ureido group (having preferably from 1 to 20 carbon atoms, more preferably from 1 to 16 carbon atoms, and most preferably from 1 to 12 carbon atoms, and including, for example, a ureido group, a methylureido, and a phenylureido group.); an phosphoric acid amido group (having preferably from 1 to 20 carbon atoms, more preferably from 1 to 16 carbon atoms, and further more preferably from 1 to 12 carbon atoms, and including, for example, a diethyl phosphate amido group and a phenyl phosphoric acid amido group; a hydroxyl group; a mercapto group; a halogen atom (for example, a fluorine atom, a chlorine atom, a bromine atom, and an iodine atom); a cyano group; a sulfo group; a sulfino group; a carboxyl group; a phosphono group; a nitro group; a hydroxamic acid group; a hydrazino group; a heterocyclic group (for example, an imidazolyl group, a benzimidazolyl group, a thiazolyl group, a benzthiazolyl group, a carbazolyl group, a pyridyl group, a furyl group, a piperidyl group, and a morpholine group).

Of the aforesaid groups, groups such as a hydroxyl group, a mercapto group, a sulfo group, a sulfino group, a carboxyl group, a phosphono group, and a phosphino group, which can form a salt, may be in the form of salts. The substituents may be substituted. Further, when there are at least two substituents, they may be the same or different. Preferred as substituents are an alkyl group, an aralkyl group, an alkoxy group, an aryl group, an alkylthio group, an acyl group, an acylamino group, an imino group, a sulfamoyl group, a sulfonyl group, a sulfamoylamino group, a ureido group, an amino group, a halogen atom, a nitro group, a heterocyclic group, an alkoxycarbonyl group, a hydroxyl group, a sulfo group, a carbamoyl group, or a carboxyl group. More preferred are an alkyl group, an alkoxy group, an aryl group, an alkylthio group, an acyl group, an acylamino group, an imino group, a sulfonylamino group, a ureido group, an amino group, a halogen atom, a nitro group, a heterocyclic group, an alkoxycarbonyl group, a hydroxyl group, a sulfo group, a carbamoyl group, or a carboxyl group. Further more preferred are an alkyl group, an alkoxy group, an aryl group, an alkylthio group, an acylamino group, an imino group, a ureido group, an amino group, a heterocyclic group, an alkoxycarbonyl group, a hydroxyl group, a carbamoyl group, or a carboxyl group. An amidino group includes those having a substituent. Listed as the substituents are, for example, an alkyl group (being either a methyl, ethyl, a pyridylmethyl, benzyl, phenethyl, carboxybenzyl, or aminophenylmethyl group), an aryl group (being either a phenyl, p-tolyl, naphthyl, o-aminophenyl, or o-methoxyphenyl group), and a heterocyclic group (being either a 2-thiazolyl, 2-pyridyl, 3-pyridyl, 2-furyl, 3-furyl, 2-thieno, 2-imidazolyl, benzothiazole, or a carbazolyl group).

Listed as divalent linking groups containing at least one of an oxygen atom, a sulfur atom, or a nitrogen atom, represented by J₃₁, are, for example, those described below. Further, those may be employed in combination.

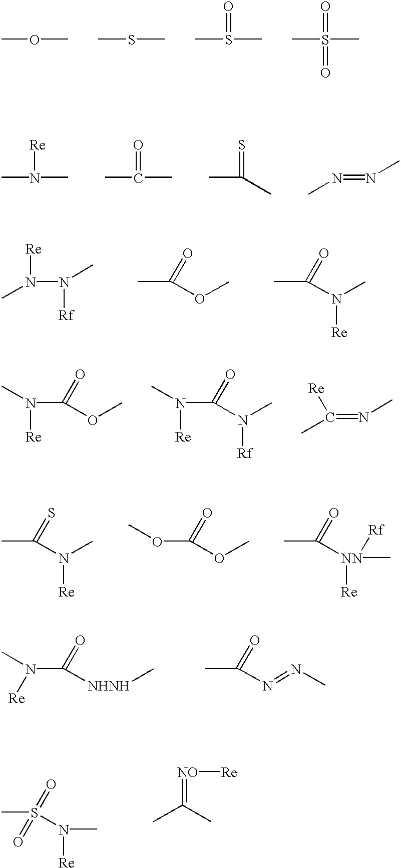

Herein, Re and Rf each represents the same as those defined for the aforesaid Ra through Rd.

The aromatic hydrocarbon group represented by H₃₁Ar is preferably a group having from 6 to 30 carbon atoms, and is more preferably a single ring or fused ring aryl group having from 6 to 20 carbon atoms. For example, a phenyl group and a naphthyl group are listed, and among them, the phenyl group is particularly preferred. The aromatic heterocyclic group represented by H₃₁Ar is a 5- to 10-membered unsaturated heterocyclic ring having at least one of N, O, or S. The heterocyclic ring in the group may be either a single ring or a fused ring. Preferred as heterocyclic rings in such heterocyclic groups are 5- or 6-membered aromatic heterocyclic rings and their benzo-fused rings. Of these, more preferred are 5- or 6-membered aromatic heterocyclic or 5 or 6-membered aromatic heterocyclic rings containing a nitrogen atom and benzo-fused rings thereof. Of these, still more preferred are 5- or 6-membered aromatic heterocyclic rings containing one or two nitrogen atoms and benzo-fused rings thereof.

Listed as specific examples of heterocyclic groups are those derived from, for example, thiophene, furan, pyrrole, imidazole, pyrazole, pyridine, pyrazine, pyridazine, triazole, triazine, indole, indazole, purine, thiadiazole, oxadiazole, quinoline, phthalazine, naphthyridine, quinoxaline, quinazoline, cinnoline, pteridine, acridine, phenanthroline, phenazine, tetrazole, thiazole, oxazole, benzimidazole, benzoxazole, benzothiazole, benzothiazoline, benzotriazole, tetraazaindene, and carbazole. Of these, preferred as heterocyclic groups are groups comprised of imidazole, pyrazole, pyridine, pyrazine, indole, indazole, thiadiazole, oxadiazole, quinoline, phenazine, tetrazole, thiazole, oxazole, benzimidazole, benzoxazole, benzothiazole, benzothiazoline, benzotriazole, tetraazaindene, and carbazole. Of these, further more preferred are groups derived from imidazole, pyridine, pyrazine, quinoline, phenazine, tetrazole, thiazole, benzoxazole, benzimidazole, benzothiazole, benzothiazoline, benzotriazole, and carbazole.

Aromatic hydrocarbon groups as well as aromatic heterocyclic groups, represented by H₃₁Ar, may have a substituent. Listed as the aforesaid substituents may be, for example, the same groups as listed as the substituents for T₃₁ and the preferred range is also the same. These substituents may be substituted. Further, when there are at least two substituents, they may be the same or different. The groups represented by H₃₁Ar are preferably aromatic heterocyclic groups.

Listed as aliphatic hydrocarbon groups, aryl groups, and heterocyclic groups, represented by Ra, Rb, Rc, and Rd, may be the same groups listed as examples of aromatic hydrocarbon groups, aryl groups, and heterocyclic groups in aforesaid T₃₁, and the preferred range is also the same as above. Listed as acyl groups represented by Ra, Rb, Rc, and Rd are aliphatic or aromatic groups having from 1 to 12 carbon atoms. Specifically listed are an acetyl group, a benzoyl group, a formyl group, and a pivaloyl group. Listed as nitrogen-containing heterocyclic groups which are formed by combining Ra and Rb, Rc and Rd, Ra and Rc, or Rb and Rd are 3- to 10-membered unsaturated heterocyclic rings (for example, cyclic groups such as a piperidine ring, a piperazine ring, an acridine ring, a pyrrole ring, and a morpholine ring).

Listed as specific examples of acid anions, represented by M₃₁, which are ions necessary to offset the charge in the molecule are, for example, halogen ions (for example, chloride ions, bromide ions, and iodide ions), p-toluenesulfonate ions, perchlorate ions, boron tetrafluoride ions, sulfate ions, methyl sulfate ions, ethyl sulfate ions, methanesulfonate ions, and trifluoromethanesulfonate ions.

The supersensitizers according to the present invention are preferably employed in a photosensitive layer comprising organic silver salts and silver halide grains in an amount of 0.001 to 1.000 mol per mol of silver, and more preferably in an amount of 0.01 to 0.50 mol.

In the present invention, it is preferable that spectral sensitization is achieved by adsorbing the spectral sensitizing dyes onto the surface of photosensitive silver halide grains and the resulting spectral sensitization effects are substantially lost after the thermal development process. “Spectral sensitization effects are substantially lost”, as described herein, means that the speed of the aforesaid imaging material which has been achieved by sensitizing dyes and supersensitizers decreases to 1.1 times or less compared to the speed of aforesaid material which is not spectrally sensitized.

In the present invention, either a photosensitive layer or a light-insensitive layer may comprise silver saving agents. The silver saving agents, used in the present invention, refer to compounds capable of reducing the silver amount to obtain a definite silver image density. Even though various mechanisms may be considered to explain functions regarding a decrease in the silver amount, compounds having functions to enhance covering power of developed silver are preferable. The covering power of developed silver, as described herein, refers to optical density per unit amount of silver. These silver saving agents may be incorporated in either a photosensitive layer or a light-insensitive layer or in both such layers.

Listed as preferred examples of silver saving agents are hydrazine derivatives represented by General Formula (H) described below, vinyl compounds represented by General Formula (G) described below, and quaternary onium compounds represented by General Formula (P) described below.

General Formula (H)

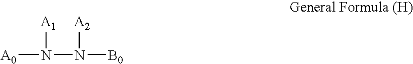

General Formula (G)

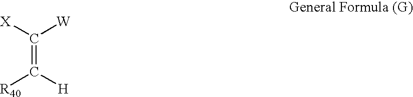

General Formula (P)

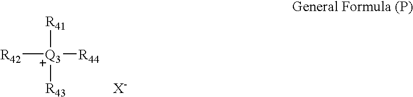

In General Formula (H), A₀ represents an aliphatic group, an aromatic group, a heterocyclic group, or a -G₀-D₀ group, each of which may have a substituent; Bo represents a blocking group; and A₁ and A₂ each represents a hydrogen atom, or one represents a hydrogen atom and the other represents an acyl group, a sulfonyl group, or a oxalyl group. Herein, G₀ represents a —CO— group, a —COCO— group, a —CS— group, a —C(═NG₁D₁)— group, a —SO— group, a —SO₂— group, or a —P(O) (G₁D₁)— group, wherein G₁ represents a simple bonding atom or a group such as an —O— group, a —S— group, or an —N(D₁)— group, wherein D₁ represents an aliphatic group, an aromatic group, a heterocyclic group, or a hydrogen atom; when there is a plurality of D₁ in the molecule, those may be the same or different; and Do represents a hydrogen atom, an aliphatic group, an aromatic group, a heterocyclic group, an amino group, an alkoxy group, an aryloxy group, an alkylthio group, or an arylthio group. Listed as preferred Do are a hydrogen atom, an alkyl group, an alkoxy group, and an amino group.

In General Formula (H), the aliphatic group represented by A₀ is preferably a straight chain, branched, or cyclic alkyl group having from 1 to 30 carbon atoms and more preferably from 1 to 20 carbon atoms. Listed as the alkyl groups are, for example, a methyl group, an ethyl group, a t-butyl group, an octyl group, a cyclohexyl group, and a benzyl group. The groups may be substituted with a suitable substituent (for example, an aryl group, an alkoxy group, an aryloxy group, an alkylthio group, an arylthio group, a sulfoxyl group, a sulfonamido group, a sulfamoyl group, an acylamino group, and a ureido group).

In General Formula (H), the aromatic group represented by A₀ is preferably a single ring or fused ring aryl group. Listed as examples are a benzene ring or a naphthalene ring. Preferably listed as heterocyclic groups represented by A₀ are those containing at least one heteroatom selected from nitrogen, sulfur and oxygen atoms. Listed as examples are a pyrrolidine ring, an imidazole ring, a tetrahydrofuran ring, a morpholine ring, a pyridine ring, a pyrimidine ring, a quinoline ring, a thiazole ring, a benzothiazole ring, a thiophene ring, and a furan ring. The aromatic ring, heterocyclic group, and -G₀-D₀ group may each have a substituent. Particularly preferred as A₀ are an aryl group and a -G₀-D₀- group.

Further, in General Formula (H), A₀ preferably contains at least one of non-diffusive groups or silver halide adsorbing groups. Preferred as the non-diffusive groups are ballast groups which are commonly employed for immobilized photographic additives such as couplers. Listed as ballast groups are an alkyl group, an alkenyl group, an alkynyl group, an alkoxy group, a phenyl group, a phenoxy group, and an alkylphenoxy group, which are photographically inactive. The total number of carbon atoms of the portion of the substituent is preferably at least 8.

In General Formula (H), listed as silver halide adsorption enhancing groups are thiourea, a thiourethane group, a mercapto group, a thioether group, a thione group, a heterocyclic group, a thioamido heterocyclic group, a mercapto heterocyclic group, or the adsorption group described in Japanese Patent Publication Open to Public Inspection No. 64-90439.

In General Formula (H), B₀ represents a blocking group, and preferably represents -G₀-D₀ group, wherein G₀ represents a —CO— group, a —COCO— group, a —CS— group, a —C(═NG₁D₁)— group, an —SO— group, an —SO₂— group, or a —P(O) (G₁D₁) group. Listed as preferred G₀ are a —CO— group and a —COCO— group. G₁ represents a simple bonding atom or group such as an —O— atom, an —S— atom or an —N(D₁)— group, wherein D₁ represents an aliphatic group, an aromatic group, a heterocyclic group, or a hydrogen atom, and when there is a plurality of D₁ in a molecule, they may be the same or different. Do represents a hydrogen atom, an aliphatic group, an aromatic group, a heterocyclic group, an amino group, an alkoxy group, an aryloxy group, an alkylthio group, and an arylthio group. Listed as preferred Do are a hydrogen atom, an alkyl group, an alkoxy group, or an amino group. A₁ and A₂ each represents a hydrogen atom, or when one represents a hydrogen atom, the other represents an acyl group (such as an acetyl group, a trifluoroacetyl group, and a benzoyl group), a sulfonyl group (such as a methanesulfonyl group and a toluenesulfonyl group), or an oxalyl group (such as an ethoxalyl group).

The compounds represented by General Formula (H) can be easily synthesized employing methods known in the art. They can be synthesized based on, for example, U.S. Pat. Nos. 5,464,738 and 5,496,695.

Other than those, preferably usable hydrazine derivatives include Compounds H-1 through H-29 described in columns 11 through 20 of U.S. Pat. No. 5,545,505, and Compounds 1 through 12 in columns 9 through 11 of U.S. Pat. No. 5,464,738. The hydrazine derivatives can be synthesized employing methods known in the art.

In General Formula (G), X as well as R₄₀ are illustrated utilizing a cis form, while X and R₄₀ include a trans form. This is applied to the structure illustration of specific compounds.

In General Formula (G), X represents an electron attractive group, while W represents a hydrogen atom, an alkyl group, an alkenyl group, an alkynyl group, an aryl group, a heterocyclic group, a halogen atom, an acyl group, a thioacyl group, an oxalyl group, an oxyoxalyl group, a thioxyalyl group, an oxamoyl group, an oxycarbonyl group, a thiocarbonyl group, a carbamoyl group, a thiocarbamoyl group, a sulfonyl group, a sulfinyl group, an oxysulfinyl group, a thiosulfinyl group, a sulfamoyl group, an oxysulfinyl group, a thiosulfinyl group, a sulfamoyl group, a phosphoryl group, a nitro group, an imino group, an N-carbonylimino group, an N-sulfonylimino group, a dicyanoethylene group, an ammonium group, a sulfonium group, a phosphonium group, a pyrylium group, and an immonium group.

R₄₀ represents a halogen atom, a hydroxyl group, an alkoxy group, an aryloxy group, a heterocyclic oxy group, an alkenyloxy group, an acyloxy group, an alkoxycarbonyloxy group, an aminocarbonyloxy group, a mercapto group, an alkylthio group, an arylthio group, a heterocyclic thio group, an alkenylthio group, an acylthio group, an alkoxycarbonylthio group, an aminocarbonylthio group, a hydroxyl group, an organic or inorganic salt (for example, a sodium salt, a potassium salt, and a silver salt) of a mercapto group, an amino group, an alkylamino group, a cyclic amino group (for example, a pyrrolidino group), an acylamino group, an oxycarbonylamino group, a heterocyclic group (a nitrogen-containing 5- or 6-membered heterocyclic ring such as a benztriazolyl group, an imidazolyl group, a triazolyl group, and a tetrazolyl group), a ureido group, and a sulfonamido group. X and W may be joined together to form a ring structure, while X and R₄₀ may also be joined together in the same manner. Listed as rings which are formed by X and W are, for example, pyrazolone, pyrazolidinone, cyclopentanedione, β-ketolactone, β-ketolactum.

General Formula (G) will be described further. The electron attractive group represented by X refers to the substituent of which substituent constant σp is able to take a positive value. Specifically, included are a substituted alkyl group (such as a halogen-substituted alkyl group), a substituted alkenyl group (such as a cyanovinyl group), a substituted or unsubstituted alkynyl group (such as a trifluoromethylacetylenyl group and a cyanoacetylenyl group), a substituted aryl group (such as a cyanophenyl group), a substituted or unsubstituted heterocyclic group (such as a pyridyl group, a triazinyl group, or a benzoxazolyl group), a halogen atom, a cyano group, an acyl group (such as an acetyl group, a trifluoroacetyl group, and a formyl group), a thioacetyl group (such as a thioacetyl group and a thioformyl group), an oxalyl group (such as a methyloxalyl group), an oxyoxalyl group (such as an ethoxyoxalyl group), a thiooxyalyl group (such as an ethylthiooxyalyl group), an oxamoyl group (such as a methyloxamoyl group), an oxycarbonyl group (such as an ethoxycarbonyl group), a carboxyl group, a thiocarbonyl group (such as an ethylthiocarbonyl group), a carbamoyl group, a thiocarbamoyl group, a sulfonyl group, a sulfinyl group, an oxysulfonyl group (such as an ethoxysulfonyl group), a thiosulfonyl group (such as an ethylthiosulfonyl group), a sulfamoyl group, an oxysulfinyl group (such as a methoxysulfinyl group), a thiosulfinyl group (such as a methylthiosulfinyl group), a sulfinamoyl group, a phosphoryl group, a nitro group, an imino group, an N-carbonylimino group (such as an N-acetylimino group), an N-sulfonylimino group (such as an N-methanesulfonylimino group), a dicyanoethylene group, an ammonium group, a sulfonium group, a phosphonium group, a pyrylium group, and an immonium group. However, also included are heterocyclic rings which are formed employing an ammonium group, a sulfonium group, a phosphonium group, or an immonium group. Substituents having a σp value of at least 0.30 are particularly preferred.

Alkyl groups represented by W include a methyl group, an ethyl group, and a trifluoromethyl group; alkenyl groups represented by W include a vinyl group, a halogen-substituted vinyl group, and a cyanovinyl group; aryl groups represented by W include a nitrophenol group, a cyanophenyl group, and a pentafluorophenyl group; heterocyclic groups represented by W include a pyridyl group, a triazinyl group, a succinimido group, a tetrazolyl group, an imidazolyl group, and a benzoxyazolyl group. Preferred as W are electron attractive groups having a positive σp value, and more preferred are those having a σp value of at least 0.30.

Of the aforesaid substituents of R₄₀, preferably listed are a hydroxyl group, a mercapto group, an alkoxy group, an alkylthio group, a halogen atom, an organic or inorganic salt of a hydroxyl group or a mercapto group, and a heterocyclic group, and of these, more preferably listed are a hydroxyl group, and an organic or inorganic salt of a hydroxyl group or a mercapto group.

Further, of the aforesaid substituents of X and W, preferred are those having an thioether bond in the substituent.

In General Formula (P), Q₂ represents a nitrogen atom or a phosphorus atom; R₄₁, R₄₂, R₄₃, and R₄₄ each represents a hydrogen atom or a substituents; and X⁻ represents an anion. Incidentally, R₄₁ through R₄₄ may be joined together to form a ring.

Listed as substituents represented by R₄₁ through R₄₄ are an alkyl group (such as a methyl group, an ethyl group, a propyl group, a butyl group, a hexyl group, and a cyclohexyl group), an alkenyl group (such as an allyl group and a butenyl group), an alkynyl group (such as a propargyl group and a butynyl group), an aryl group (such as a phenyl group and a naphthyl group), a heterocyclic group (such as a piperidinyl group, a piperazinyl group, a morpholinyl group, a pyridyl group, a furyl group, a thienyl group, a tetrahydrofuryl group, a tetrahydrothienyl group, and a sulforanyl group), and an amino group.

Listed as rings which are formed by joining R₄₁ through R₄₄ are a piperidine ring, a morpholine ring, a piperazine ring, quinuclidine ring, a pyridine ring, a pyrrole ring, an imidazole ring, a triazole ring, and a tetrazole ring.

Groups represented by R₄₁ through R₄₄ may have a substituent such as a hydroxyl group, an alkoxy group, an aryloxy group, a carboxyl group, a sulfo group, an alkyl group, and an aryl group. R₄₁, R₄₂, R₄₃, and R₄₄ each is preferably a hydrogen atom or an alkyl group.

Listed as anions represented by X⁻ are inorganic or organic anions such as a halogen ion, a sulfate ion, a nitrate ion, an acetate ion, and a p-toluenesulfonate ion.

The aforesaid quaternary onium compounds can easily be synthesized employing methods known in the art. For instance, the aforesaid tetrazolium compounds can be synthesized based on the method described in Chemical Reviews Vol. 55. pages 335 through 483. The added amount of the aforesaid silver saving agents is commonly from 10⁻⁵ to 1 mol with respect to mol of aliphatic carboxylic acid silver salts, and is preferably from 10⁻⁴ to 5×10⁻¹ mol.

In the present invention, it is preferable that at least one of silver saving agents is a silane compound.

The silane compounds employed as a silver saving agent in present invention are preferably alkoxysilane compounds having at least two primary or secondary amino groups or salts thereof, as described in Japanese Patent Application No. 2001-192698.

“Having at least two primary or secondary amino groups”, as described herein, refers to having at least two primary amine groups, at least two secondary amine group, or at least one primary amine group and one secondary amine group. The salts of alkoxysilane compounds, as described herein, refer to addition products of alkoxysilane compounds with inorganic acid or organic acid capable of forming an onium salt with an amino group.

Listed as such alkoxysilane compounds or salts thereof are the compounds described below. However, in the present invention, compounds are not limited to these examples as long as at least two primary or secondary amino groups are included in the molecule.

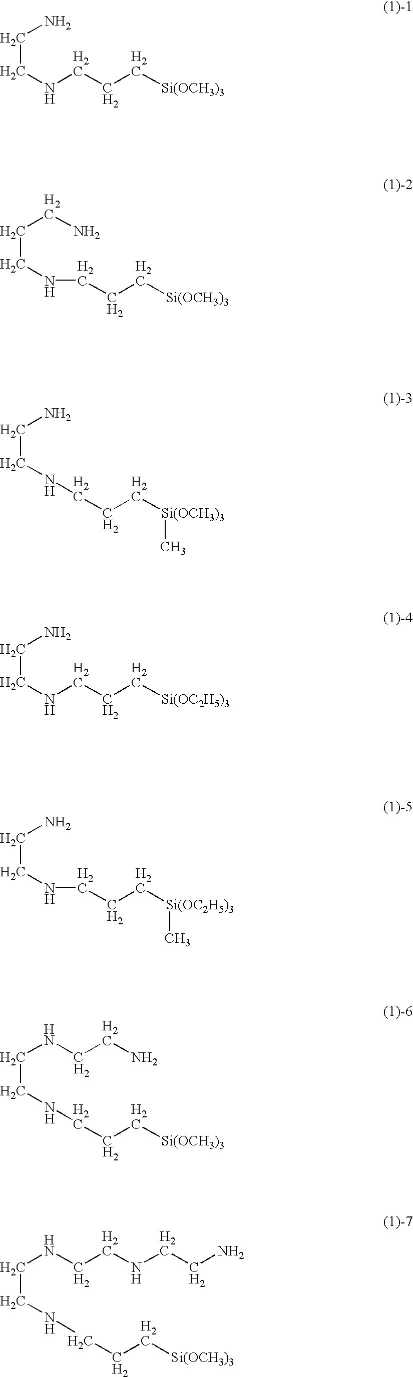

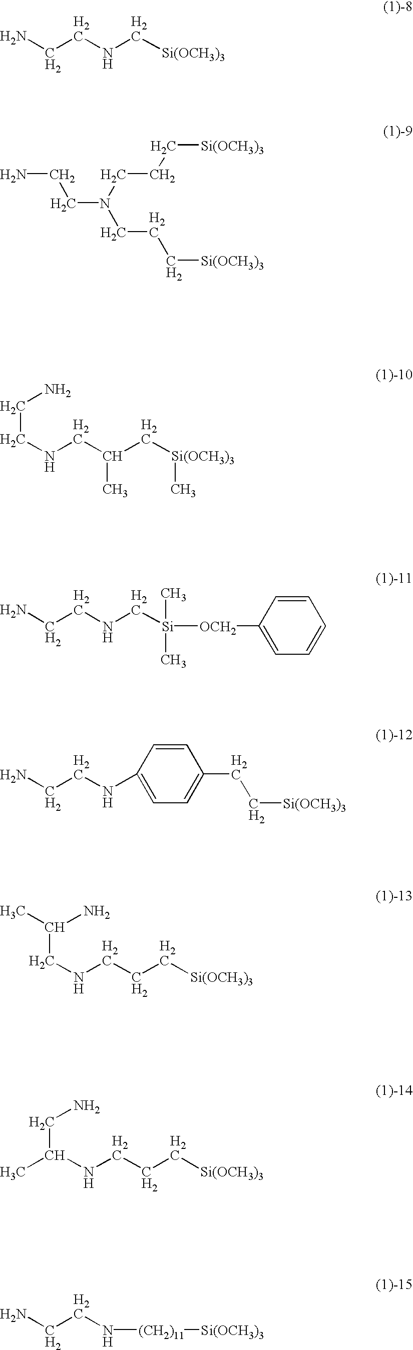

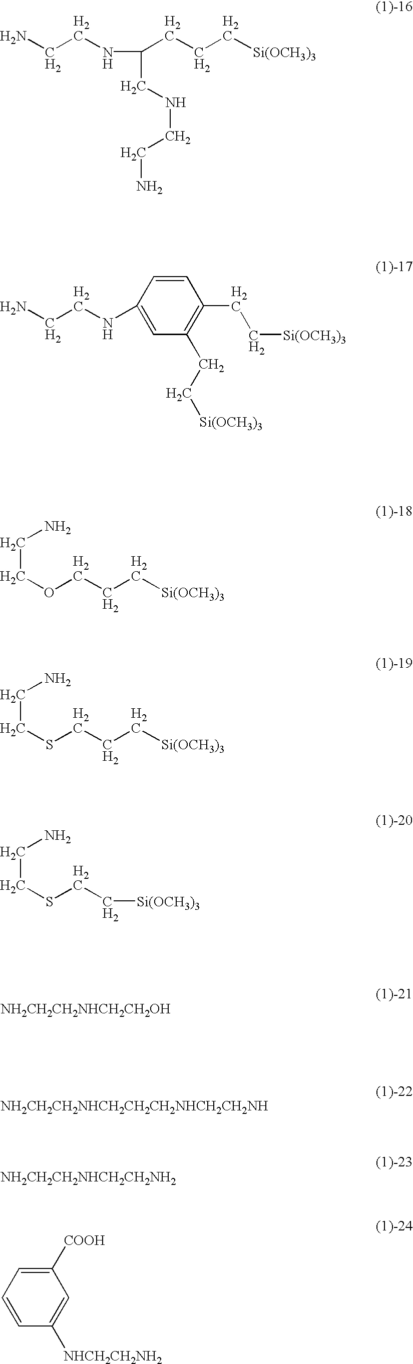

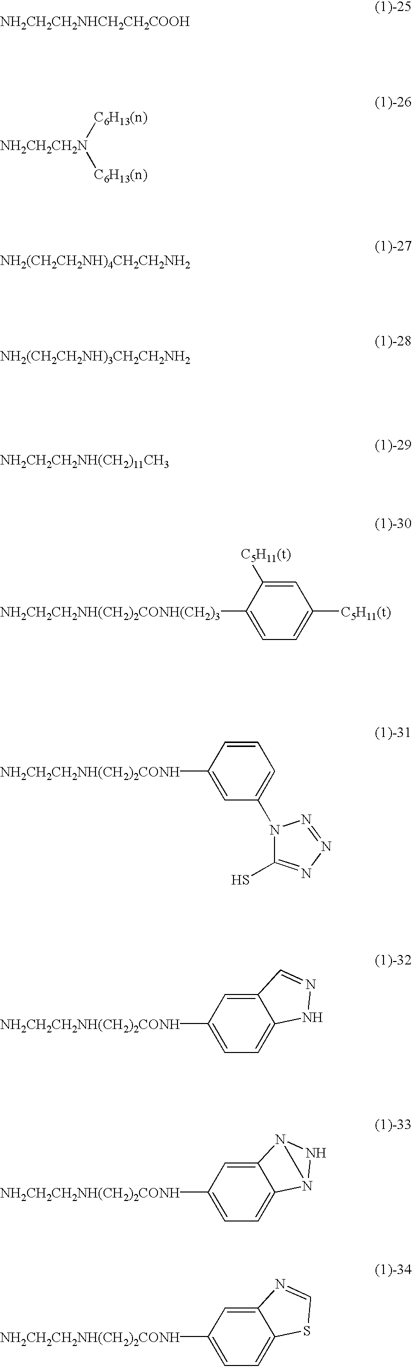

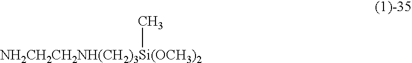

In these compounds, preferred as alkoxy groups which form alkoxysilyl are alkoxy groups comprised of saturated hydrocarbon. Further, since storage stability is more enhanced, a methoxy group, an ethoxy group, and an isopropoxy group is preferred. Still further, for the purpose of minimizing speed variation due to storage conditions prior to thermal development, compounds which have no unsaturated hydrocarbon group in the molecule are more preferred. Incidentally, these alkoxysilane compounds or salts thereof may be employed individually or in combination of at least two types.

Further, it is preferable that an image forming layer comprises at least one Schiff base which is formed employing dehydration condensation reaction of an alkoxysilane compound having at least one primary amine group with a ketone compound.

By employing such Schiff base, it is possible to save silver. In addition, images are obtained which result in low fogging as well as minimize speed variation, irrespective of storage condition prior to thermal development, and result in no excessive increase in gamma. Further, when ketone based solvents are employed during preparation of the image forming layer forming coating composition, described below, due to sealing the primary amine portion composition, it is possible to minimize speed variation due to storage after preparing the coating composition.

It is possible to use without any particular limitations ketone forming compounds which are employed to form the Schiff base with the aforesaid alkoxysilane compounds. Due to problems of unpleasant odor which is generated during image formation, employing the image forming method described below, the boiling point of the compounds is preferably at most 150° C. and is more preferably at most 100° C.

Listed as such Schiff bases may be the compounds described below. However, they are not limited to these examples, as long as they are Schiff bases which are formed employing dehydrations condensation reaction of alkoxysilane compound having at least one primary amine group with a ketone compound.

Incidentally, for the purpose of saving more silver, of the aforesaid compounds, Schiff bases having at least one of a secondary amine group are more preferred. Further, these Schiff bases may be employed individually or in combination of at least two types.

When alkoxysilane compounds or salts thereof or Schiff bases are incorporated in the image forming layer as a silver saving agent, the added amount of these compound is preferably in the range of 0.00001 to 0.05 mol per mol of silver. Further, both of alkoxysilane compounds or salt thereof and Schiff bases are added, the added amount is in the same range as above.

However, when the added amount of the aforesaid alkoxysilane compounds or Schiff bases exceeds the above range, the image density of the unexposed portion, which is formed employing the image forming method described below, occasionally becomes higher. In such a case, for the purpose of decreasing the dependency of the added amount of the Shchiff bases per mol of silver, it is preferable that isocyanate compounds, having at least two isocyanate groups in the molecule are added to the image forming layer. Employed as isocyanate compounds may be those employed as a cross-linking agent, described below.

Suitable binders for the silver salt photothermographic material of the present invention are to be transparent or translucent and commonly colorless, and include natural polymers, synthetic resin polymers and copolymers, as well as media to form film. The binders include, for example, gelatin, gum Arabic, casein, starch, poly(acrylic acid), poly(methacrylic acid), poly(vinyl chloride), poly(methacrylic acid), copoly(styrene-maleic anhydride), coply(styrene-acrylonitrile), coply(styrene-butadiene), poly(vinyl acetals) (for example, poly(vinyl formal) and poly(vinyl butyral), poly(esters), poly(urethanes), phenoxy resins, poly(vinylidene chloride), poly(epoxides), poly(carbonates), poly(vinyl acetate), cellulose esters, poly(amides). The binders may be hydrophilic or hydrophobic.

Preferable binders for the photosensitive layer of the silver salt photothermographic dry imaging material of the present invention are poly(vinyl acetals), and a particularly preferable binder is poly(vinyl butyral), which will be detailed hereunder. Polymers such as cellulose esters, especially polymers such as triacetyl cellulose, cellulose acetate butyrate, which exhibit higher softening temperature, are preferable for an overcoating layer as well as an undercoating layer, specifically for a light-insensitive layer such as a protective layer and a backing layer. Incidentally, if desired, the binders may be employed in combination of at least two types.

Such binders are employed in the range of a proportion in which the binders function effectively. Skilled persons in the art can easily determine the effective range. For example, preferred as the index for maintaining aliphatic carboxylic acid silver salts in a photosensitive layer is the proportion range of binders to aliphatic carboxylic acid silver salts of 15:1 to 1:2 and most preferably of 8:1 to 1:1. Namely, the binder amount in the photosensitive layer is preferably from 1.5 to 6 g/m², and is more preferably from 1.7 to 5 g/m². When the binder amount is less than 1.5 g/m², density of the unexposed portion markedly increases, whereby it occasionally becomes impossible to use the resultant material.

In the present invention, it is preferable that thermal transition point temperature, after development is at higher or equal to 100° C., is from 46 to 200° C. and is more preferably from 70 to 105° C. Thermal transition point temperature, as described in the present invention, refers to the VICAT softening point or the value shown by the ring and ball method, and also refers to the endothermic peak which is obtained by measuring the individually peeled photosensitive layer which has been thermally developed, employing a differential scanning calorimeter (DSC), such as EXSTAR 6000 (manufactured by Seiko Denshi Co.), DSC220C (manufactured by Seiko Denshi Kogyo Co.), and DSC-7 (manufactured by Perkin-Elmer Co.). Commonly, polymers exhibit a glass transition point, Tg. In silver salt photothermographic dry imaging materials, a large endothermic peak appears at a temperature lower than the Tg value of the binder resin employed in the photosensitive layer. The inventors of the present invention conducted diligent investigations while paying special attention to the thermal transition point temperature. As a result, it was discovered that by regulating the thermal transition point temperature to the range of 46 to 200° C., durability of the resultant coating layer increased and in addition, photographic characteristics such as speed, maximum density and image retention properties were markedly improved. Based on the discovery, the present invention was achieved.

The glass transition temperature (Tg) is determined employing the method, described in Brandlap, et al., “Polymer Handbook”, pages from III-139 through III-179, 1966 (published by Wiley and Son Co.). The Tg of the binder comprised of copolymer resins is obtained based on the following formula.

Tg of the copolymer (in ° C.)=v₁Tg₁+v₂Tg₂++vₙTgₙ

wherein v₁, v₂, . . . vₙ each represents the mass ratio of the monomer in the copolymer, and Tg₁, Tg₂, . . . Tgₙ each represents Tg (in ° C.) of the homopolymer which is prepared employing each monomer in the copolymer. The accuracy of Tg, calculated based on the formula calculation, is ±5° C.

In the silver salt photothermographic dry imaging material of the present invention, employed as binders, which are incorporated in the photosensitive layer, on the support, comprising aliphatic carboxylic acid silver salts, photosensitive silver halide grains and reducing agents, may be conventional polymers known in the art. The polymers have a Tg of 70 to 105° C., a number average molecular weight of 1,000 to 1,000,000, preferably from 10,000 to 500,000, and a degree of polymerization of about 50 to about 1,000. Examples of such polymers include polymers or copolymers comprised of constituent units of ethylenic unsaturated monomers such as vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, and vinyl acetal, as well as vinyl ether, and polyurethane resins and various types of rubber based resins.

Further listed are phenol resins, epoxy resins, polyurethane hardening type resins, urea resins, melamine resins, alkyd resins, formaldehyde resins, silicone resins, epoxy-polyamide resins, and polyester resins. Such resins are detailed in “Plastics Handbook”, published by Asakura Shoten. These polymers are not particularly limited, and may be either homopolymers or copolymers as long as the resultant glass transition temperature, Tg is in the range of 70 to 105° C.

Listed as homopolymers or copolymers which comprise the ethylenic unsaturated monomers as constitution units are alkyl acrylates, aryl acrylates, alkyl methacrylates, aryl methacrylates, alkyl cyano acrylate, and aryl cyano acrylates, in which the alkyl group or aryl group may not be substituted. Specific alkyl groups and aryl groups include a methyl group, an ethyl group, an n-propyl group, an isopropyl group, an n-butyl group, an isobutyl group, a sec-butyl group, a tert-butyl group, an amyl group, a hexyl group, a cyclohexyl group, a benzyl group, a chlorophenyl group, an octyl group, a stearyl group, a sulfopropyl group, an N-ethyl-phenylaminoethyl group, a 2-(3-phenylpropyloxy)ethyl group, a dimethylaminophenoxyethyl group, a furfuryl group, a tetrahydrofurfuryl group, a phenyl group, a cresyl group, a naphthyl group, a 2-hydroxyethyl group, a 4-hydroxybutyl group, a triethylene glycol group, a dipropylene glycol group, a 2-methoxyethyl group, a 3-methoxybutyl group, a 2-actoxyethyl group, a 2-acetacttoxyethyl group, a 2-methoxyethyl group, a 2-iso-proxyethyl group, a 2-butoxyethyl group, a 2-(2-methoxyethoxy)ethyl group, a 2-(2-ethoxyetjoxy)ethyl group, a 2-(2-bitoxyethoxy)ethyl group, a 2-diphenylphsophorylethyl group, an O-methoxypolyethylene glycol (the number of addition mol n=6), an ally group, and dimethylaminoethylmethyl chloride.

In addition, employed may be the monomers described below. vinyl esters: specific examples include vinyl acetate, vinyl propionate, vinyl butyrate, vinyl isobutyrate, vinyl corporate, vinyl chloroacetate, vinyl methoxyacetate, vinyl phenyl acetate, vinyl benzoate, and vinyl salicylate; N-substituted acrylamides, N-substituted methacrylamides and acrylamide and methacrylamide: N-substituents include a methyl group, an ethyl group, a propyl group, a butyl group, a tert-butyl group, a cyclohexyl group, a benzyl group, a hydroxymethyl group, a methoxyethyl group, a dimethylaminoethyl group, a phenyl group, a dimethyl group, a diethyl group, a β-cyanoethyl group, an N-(2-acetacetoxyethyl) group, a diacetone group; olefins: for example, dicyclopentadiene, ethylene, propylene, 1-butene, 1-pentane, vinyl chloride, vinylidene chloride, isoprene, chloroprene, butadiene, and 2,3-dimethylbutadiene; styrenes; for example, methylstyrene, dimethylstyrene, trimethylstyrene, ethylstyrene, isopropylstyrene, tert-butylstyrene, chloromethylstryene, methoxystyrene, acetoxystyrene, chlorostyrene, dichlorostyrene, bromostyrene, and vinyl methyl benzoate; vinyl ethers: for example, methyl vinyl ether, butyl vinyl ether, hexyl vinyl ether, methoxyethyl vinyl ether, and dimethylaminoethyl vinyl ether; N-substituted maleimides: N-substituents include a methyl group, an ethyl group, a propyl group, a butyl group, a tert-butyl group, a cyclohexyl group, a benzyl group, an n-dodecyl group, a phenyl group, a 2-methylphenyl group, a 2,6-diethylphenyl group, and a 2-chlorophenyl group; others include butyl crotonate, hexyl crotonate, dimethyl itaconate, dibutyl itaconate, diethyl maleate, dimethyl maleate, dibutyl maleate, diethyl fumarate, dimethyl fumarate, dibutyl fumarate, methyl vinyl ketone, phenyl vinyl ketone, methoxyethyl vinyl ketone, glycidyl acrylate, glycidyl methacrylate, N-vinyl oxazolidone, N-vinyl pyrrolidone, acrylonitrile, metaacrylonitrile, methylene malonnitrile, vinylidene chloride.

Of these, listed as preferable examples are alkyl methacrylates, aryl methacrylates, and styrenes. Of such polymers, those having an acetal group are preferably employed because they exhibit excellent compatibility with the resultant aliphatic carboxylic acid, whereby an increase in flexibility of the resultant layer is effectively minimized.

Particularly preferred as polymers having an acetal group are the compounds represented by General Formula (V) described below.

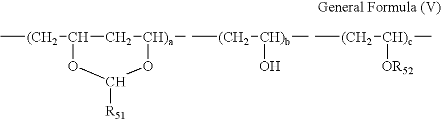

wherein R₅₁ represents a substituted or unsubstituted alkyl group, and a substituted or unsubstituted aryl group, however, groups other than the aryl group are preferred; R₅₂ represents a substituted or unsubstituted alkyl group, a substituted or unsubstituted aryl group, —COR₅₃ or —CONHR₅₃, wherein R₅₃ represents the same as defined above for R₅₁.

Unsubstituted alkyl groups represented by R₅₁, R₅₂, and R₅₃ preferably have from 1 to 20 carbon atoms and more preferably have from 1 to 6 carbon atoms. The alkyl groups may have a straight or branched chain, but preferably have a straight chain. Listed as such unsubstituted alkyl groups are, for example, a methyl group, an ethyl group, an n-propyl group, an isopropyl group, an n-butyl group, an isobutyl group, a t-butyl group, an n-amyl group, a t-amyl group, an n-hexyl group, a cyclohexyl group, an n-heptyl group, an n-octyl group, a t-octyl group, a 2-ethylhexyl group, an n-nonyl group, an n-decyl group, an n-dodecyl group, and an n-octadecyl group of these, particularly preferred is a methyl group or a propyl group.

Unsubstituted aryl groups preferably have from 6 to 20 carbon atoms and include, for example, a phenyl group and a naphthyl group. Listed as groups which can be substituted for the alkyl groups as well as the aryl groups are an alkyl group (for example, a methyl group, an n-propyl group, a t-amyl group, a t-octyl group, an n-nonyl group, and a dodecyl group), an aryl group (for example, a phenyl group), a nitro group, a hydroxyl group, a cyano group, a sulfo group, an alkoxy group (for example, a methoxy group), an aryloxy group (for example, a phenoxy group), an acyloxy group (for example, an acetoxy group), an acylamino group (for example, an acetylamino group), a sulfonamido group (for example, methanesulfonamido group), a sulfamoyl group (for example, a methylsulfamoyl group), a halogen atom (for example, a fluorine atom, a chlorine atom, and a bromine atom), a carboxyl group, a carbamoyl group (for example, a methylcarbamoyl group), an alkoxycarbonyl group (for example, a methoxycarbonyl group), and a sulfonyl group (for example, a methylsulfonyl group). When at least two of the substituents are employed, they may be the same or different. The number of total carbons of the substituted alkyl group is preferably from 1 to 20, while the number of total carbons of the substituted aryl group is preferably from 6 to 20.

R₅₂ is preferably —COR₅₃ (wherein R₅₃ represents an alkyl group or an aryl group) and —CONHR₅₃ (wherein R₅₃ represents an aryl group). “a”, “b”, and “c” each represents the value in which the weight of repeated units is shown utilizing mol percent; “a” is in the range of 40 to 86 mol percent; “b” is in the range of from 0 to 30 mol percent; “c” is in the range of 0 to 60 mol percent, so that a+b+c=100 is satisfied. Most preferably, “a” is in the range of 50 to 86 mol percent, “b” is in the range of 5 to 25 mol percent, and “c” is in the range of 0 to 40 mol percent. The repeated units having each composition ratio of “a”, “b”, and “c” may be the same or different.

Employed as polyurethane resins usable in the present invention may be those, known in the art, having a structure of polyester polyurethane, polyether polyurethane, polyether polyester polyurethane, polycarbonate polyurethane, polyester polycarbonate polyurethane, or polycaprolactone polyurethane. It is preferable that, if desired, all polyurethanes described herein are substituted, through copolymerization or addition reaction, with at least one polar group selected from the group consisting of —COOM, —SO₃M, —OSO₃M, —P═O(OM)₂, —O—P═O(OM)₂ (wherein M represents a hydrogen atom or an alkali metal salt group), —N(R₅₄)₂, —N⁺(R₅₄)₃ (wherein R₅₄ represents a hydrocarbon group, and a plurality of R₅₄ may be the same or different), an epoxy group, —SH, and —CN. The amount of such polar groups is commonly from 10⁻¹ to 10⁻⁸ mol/g, and is preferably from 10⁻² to 10⁻⁶ mol/g. Other than the polar groups, it is preferable that the molecular terminal of the polyurethane molecule has at least one OH group and at least two OH groups in total. The OH group cross-links with polyisocyanate as a hardening agent so as to form a 3-dimensinal net structure. Therefore, the more OH groups which are incorporated in the molecule, the more preferred. It is particularly preferable that the OH group is positioned at the terminal of the molecule since thereby the reactivity with the hardening agent is enhanced. The polyurethane preferably has at least three OH groups at the terminal of the molecules, and more preferably has at least four OH groups. When polyurethane is employed, the polyurethane preferably has a glass transition temperature of 70 to 105° C., a breakage elongation of 100 to 2,000 percent, and a breakage stress of 0.5 to 100 M/mm².

Polymers represented by aforesaid General Formula (V) of the present invention can be synthesized employing common synthetic methods described in “Sakusan Binihru Jushi (Vinyl Acetate Resins)”, edited by Ichiro Sakurada (Kohbunshi Kagaku Kankoh Kai, 1962).

Examples of representative synthetic methods will now be described. However, the present invention is not limited to these representative synthetic examples.

### SYNTHETIC EXAMPLE 1

### Synthesis of P-1

Charged into a reaction vessel were 20 g of polyvinyl alcohol (Gosenol GH18) manufactured by Nihon Gosei Co., Ltd. and 180 g of pure water, and the resulting mixture was dispersed in pure water so that 10 weight percent polyvinyl alcohol dispersion was obtained. Subsequently, the resultant dispersion was heated to 95° C. and polyvinyl alcohol was dissolved. Thereafter, the resultant solution was cooled to 75° C., whereby an aqueous polyvinyl alcohol solution was prepared. Subsequently, 1.6 g of 10 percent by weight hydrochloric acid, as an acid catalyst, was added to the solution. The resultant solution was designated as Dripping Solution A. Subsequently, 11.5 g of a mixture consisting of butylaldehyde and acetaldehyde in a mol ratio of 4:5 was prepared and was designated as Dripping Solution B. Added to a 1,000 ml four-necked flask fitted with a cooling pipe and a stirring device was 100 ml of pure water which was heated to 85° C. and stirred well. Subsequently, while stirring, Dripping Solution A and Dripping Solution B were simultaneously added dropwise into the pure water over 2 hours, employing a dripping funnel. During the addition, the reaction was conducted while minimizing coalescence of deposit particles by controlling the stirring rate. After the dropwise addition, 7 g of 10 weight percent hydrochloric acid, as an acid catalyst, was further added, and the resultant mixture was stirred for 2 hours at 85° C., whereby the reaction had sufficiently progressed. Thereafter, the reaction mixture was cooled to 40° C. and was neutralized employing sodium bicarbonate. The resultant product was washed with water 5 times, and the resultant polymer was collected through filtration and dried, whereby P-1 was prepared. The Tg of obtained P-1 was determined employing a DSC, resulting in 83° C.

Other polymers described in Table 1 were synthesized in the same manner as above.

These polymers may be employed individually or in combinations of at least two types as a binder. The polymers are employed as a main binder in the photosensitive silver salt containing layer (preferably in a photosensitive layer) of the present invention. The main binder, as described herein, refers to the binder in “the state in which the proportion of the aforesaid binder is at least 50 percent by weight of the total binders of the photosensitive silver salt containing layer”. Accordingly, other binders may be employed in the range of less than 50 weight percent of the total binders. The other polymers are not particularly limited as long as they are soluble in the solvents capable of dissolving the polymers of the present invention. More preferably listed as the polymers are poly(vinyl acetate), acrylic resins, and urethane resins.

Compositions of polymers, which are preferably employed in the present invention, are shown in Table 1. Incidentally, Tg in Table 1 is a value determined employing a differential scanning calorimeter (DSC), manufactured by Seiko Denshi Kogyo Co., Ltd.

TABLE 1

| | | | | | Hydroxyl | Tg |
|---|---|---|---|---|---|---|
| Polymer | Acetoacetal | Butyral | Acetal | Acetyl | Group | Value |
| Name | mol % | mol % | mol % | mol % | mol % | (° C.) |
| P-1 | 6 | 4 | 73.7 | 1.7 | 24.6 | 85 |
| P-2 | 3 | 7 | 75.0 | 1.6 | 23.4 | 75 |
| P-3 | 10 | 0 | 73.6 | 1.9 | 24.5 | 110 |
| P-4 | 7 | 3 | 71.1 | 1.6 | 27.3 | 88 |
| P-5 | 10 | 0 | 73.3 | 1.9 | 24.8 | 104 |
| P-6 | 10 | 0 | 73.5 | 1.9 | 24.6 | 104 |
| P-7 | 3 | 7 | 74.4 | 1.6 | 24.0 | 75 |
| P-8 | 3 | 7 | 75.4 | 1.6 | 23.0 | 74 |
| P-9 | — | — | — | — | — | 60 |

Incidentally, in Table 1, P-9 is a polyvinyl butyral resin B-79, manufactured by Solutia Ltd. “-” in the table 1 means “not measured”.

In the present invention, it is known that by employing cross-linking agents in the aforesaid binders, uneven development is minimized due to the improved adhesion of the layer to the support. In addition, it results in such effects that fogging during storage is minimized and the creation of printout silver after development is also minimized.

Employed as cross-linking agents used in the present invention may be various conventional cross-linking agents, which have been employed for silver halide photosensitive photographic materials, such as aldehyde based, epoxy based, ethyleneimine based, vinylsulfone based sulfonic acid ester based, acryloyl based, carbodiimide based, and silane compound based cross-linking agents, which are described in Japanese Patent Application Open to Public Inspection No. 50-96216. Of these, preferred are isocyanate based compounds, silane compounds, epoxy compounds or acid anhydrides, as shown below.

As one of preferred cross-linking agents, isocyanate based and thioisocyanate based cross-linking agents represented by General Formula (8), shown below, will now be described.

X₂═C═N-L-(N═C=X₂)ᵥ General Formula (8)

wherein v represents 1 or 2; L represents an alkyl group, an aryl group, or an alkylaryl group which is a linking group having a valence of v+1; and X₂ represents an oxygen atom or a sulfur atom.

Incidentally, in the compounds represented by aforesaid General Formula (8), the aryl ring of the aryl group may have a substituent. Preferred substituents are selected from the group consisting of a halogen atom (for example, a bromine atom or a chlorine atom), a hydroxyl group, an amino group, a carboxyl group, an alkyl group and an alkoxy group.

The aforesaid isocyanate based cross-linking agents are isocyanates having at least two isocyanate groups and adducts thereof. More specifically, listed are aliphatic isocyanates, aliphatic isocyanates having a ring group, benzene diisocyanates, naphthalene diisocyanates, biphenyl isocyanates, diphenylmethane diisocyanates, triphenylmethane diisocyanates, triisocyanates, tetraisocyanates, and adducts of these isocyanates and adducts of these isocyanates with dihydric or trihydric polyalcohols.

Employed as specific examples may be isocyanate compounds described on pages 10 through 12 of Japanese Patent Publication Open to Public Inspection No. 56-5535.

Incidentally, adducts of isocyanates with polyalcohols are capable of markedly improving the adhesion between layers and further of markedly minimizing layer peeling, image dislocation, and air bubble formation. Such isocyanates may be incorporated in any portion of the silver salt photothermographic dry imaging material. They may be incorporated in, for example, a support (particularly, when the support is paper, they may be incorporated in a sizing composition), and optional layers such as a photosensitive layer, a surface protective layer, an interlayer, an antihalation layer, and a subbing layer, all of which are placed on the photosensitive layer side of the support, and may be incorporated in at least two of the layers.

Further, as thioisocyanate based cross-linking agents usable in the present invention, compounds having a thioisocyanate structure corresponding to the isocyanates are also useful.

The amount of the cross-linking agents employed in the present invention is in the range of 0.001 to 2.000 mol per mol of silver, and is preferably in the range of 0.005 to 0.500 mol.

Isocyanate compounds as well as thioisocyanate compounds, which may be incorporated in the present invention, are preferably those which function as the cross-linking agent. However, it is possible to obtain the desired results by employing compounds which have a v of 0, namely compounds having only one functional group.

Listed as examples of silane compounds which can be employed as a cross-linking agent in the present invention are compounds represented by General Formal (1) or General Formula (2), described in Japanese Patent Application No. 2000-077904.

In these General Formulas, R¹, R², R³, R⁴, R⁵, R⁶, R⁷, and R⁸ each represents a straight or branched chain or cyclic alkyl group having from 1 to 30 carbon atoms, which may be substituted, (such as a methyl group, an ethyl group, a butyl group, an octyl group, a dodecyl group, and a cycloalkyl group), an alkenyl group (such as a propenyl group, a butenyl group, and a nonenyl group), an alkynyl group (such as an acetylene group, a bisacetylene group, and a phenylacetylene group), an aryl group, or a heterocyclic group (such as a phenyl group, a naphthyl group, a tetrahydropyrane group, a pyridyl group, a furyl group, a thiophenyl group, an imidazole group, a thiazole group, a thiadiazole group, and an oxadiazole group, which may have either an electron attractive group or an electron donating group as a substituent.

At least one of substituents selected from R¹, R², R³ R⁴, R⁵, R⁶, R⁷, and R⁸ is preferably either a non-diffusive group or an adsorptive group. Specifically, R² is preferably either a non-diffusive group or an adsorptive group.

Incidentally, the non-diffusive group, which is called a ballast group, is preferably an aliphatic group having at least 6 carbon atoms or an aryl group substituted with an alkyl group having at least 3 carbon atoms. Non-diffusive properties vary depending on binders as well as the used amount of cross-linking agents. By introducing the non-diffusive groups, migration distance in the molecule at room temperature is retarded, whereby it is possible to retard reactions during storage.

Compounds, which can be used as a cross-linking agent, may be those having at least one epoxy group. The number of epoxy groups and corresponding molecular weight are not limited. It is preferable that the epoxy group be incorporated in the molecule as a glycidyl group via an ether bond or an imino bond. Further, the epoxy compound may be a monomer, an oligomer, or a polymer. The number of epoxy groups in the molecule is commonly from about 1 to about 10, and is preferably from 2 to 4. When the epoxy compound is a polymer, it may be either a homopolymer or a copolymer, and its number average molecular weight Mn is most preferably in the range of about 2,000 to about 20,000.

Preferred as epoxy compounds are those represented by General Formula (9) described below.

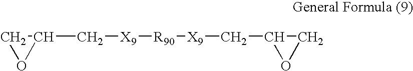

In General Formula (9), the substituent of the alkylene group represented by R₉₀ is preferably a group selected from a halogen atom, a hydroxyl group, a hydroxyalkyl group, or an amino group. Further, the linking group represented by R₉₀ preferably has an amido linking portion, an ether linking portion, or a thioether linking portion. The divalent linking group, represented by X₉, is preferably —SO₂—, —SO₂NH—, —S—, —O—, or —NR₉₁—, wherein R₉₁ represents a univalent group, which is preferably an electron attractive group.

These epoxy compounds may be employed individually or in combinations of at least two types. The added amount is not particularly limited but is preferably in the range of 1×10⁻⁶ to 1×10⁻² mol/m², and is more preferably in the range of 1×10⁻⁵ to 1×10⁻³ mol/m².

The epoxy compounds may be incorporated in optional layers on the photosensitive layer side of a support, such as a photosensitive layer, a surface protective layer, an interlayer, an antihalation layer, and a subbing layer, and may be incorporated in at least two layers. In addition, the epoxy compounds may be incorporated in optional layers on the side opposite the photosensitive layer on the support. Incidentally, when a photosensitive material has a photosensitive layer on both sides, the epoxy compounds may be incorporated in any layer.

Acid anhydrides are compounds which have at least one acid anhydride group having the structural formula described below.

—CO—O—CO—

The acid anhydrites are to have at least one such acid anhydride group. The number of acid anhydride groups, and the molecular weight are not limited, but the compounds represented by General Formula (B) are preferred.

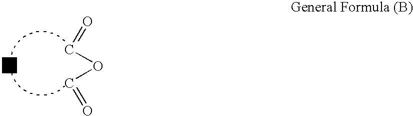

In General Formula (B), Z represents a group of atoms necessary for forming a single ring or a polycyclic system. These cyclic systems may be unsubstituted or substituted. Example of substituents include an alkyl group (for example, a methyl group, an ethyl group, or a hexyl group), an alkoxy group (for example, a methoxy group, an ethoxy group, or an octyloxy group), an aryl group (for example, a phenyl group, a naphthyl group, or a tolyl group), a hydroxyl group, an aryloxy group (for example, a phenoxy group), an alkylthio group (for example, a methylthio group or a butylthio group), an arylthio group (for example, a phenylthio group), an acyl group (for example, an acetyl group, a propionyl group, or a butyryl group), a sulfonyl group (for example, a methylsulfonyl group, or a phenylsulfonyl group), an acylamino group, a sulfonylamino group, an acyloxy group (for example, an acetoxy group or a benzoxy group), a carboxyl group, a cyano group, a sulfo group, and an amino group. Substituents are preferably those which do not contain a halogen atom.

These acid anhydrides may be employed individually or in combinations of at least two types. The added amount is not particularly limited, but is preferably in the range of 1×10⁻⁶ to 1×10⁻² mol/m² and is more preferably in the range of 1×10⁻⁶ to 1×10⁻³ mol/m².

In the present invention, the acid anhydrides may be incorporated in optional layers on the photosensitive layer side on a support, such as a photosensitive layer, a surface protective layer, an interlayer, an antihalation layer, or a subbing layer, and may be incorporated in at least two layers. Further, the acid anhydrides may be incorporated in the layer(s) in which the epoxy compounds are incorporated.

In the silver salt photothermographic dry imaging material of the present invention, photographic images are formed by thermal development. It is preferable that reducible silver sources (aliphatic carboxylic acid silver salts), photosensitive silver halide grains, reducing agents, and if desired, image toning agents, which control silver tone, are incorporated in an (organic) binder matrix under a dispersed state.

Examples of suitable image toning agents are disclosed in Research Disclosure, Item 17029, and U.S. Pat. Nos. 4,123,282, 3,994,732, 3,846,136, and 4,021,249. Particularly preferred image toning agents are either phthalazinones or combinations of phthalazine with phthalic acids or phthalic anhydrides.

In the present invention, by regulating the added amount of the aforesaid toning agents, developing agents, silver halide grains, and aliphatic carboxylic acid silver, which are directly or indirectly involved in the development reaction process, it is possible to optimize the shape of developed silver so as to result in the desired tone. For example, when the developed silver is shaped to dendrite, the resulting image tends to be bluish, while when shaped to filament, the resulting imager tends to be yellowish. Namely, it is possible to adjust the image tone taking into account the properties of shape of developed silver. Other than such a method, it is possible to control the image tone, employing couplers disclosed in Japanese Patent Publication Open to Public Inspection No. 11-288057 and European Patent 1134611A2.

Incidentally, heretofore, it has been pointed out that in regard to the output image tone for medical diagnosis, cold image tone tends to result in more accurate diagnostic observation of radiographs. The cold image tone, as described herein, refers to pure black tone or blue black tone in which black images are tinted to blue. On the other hand, warm image tone refers to warm black tone in which black images are tinted to brown.

“Colder tone” as well as “warmer tone”, which is terminology of image tone, is expressed, employing minimum density Dₘᵢₙ and hue angle h_{ab} at an optical density D of 1.0. The hue angle h_{ab} is obtained by the following formula, utilizing color specifications a* and b* of L*a*b* Color Space which is a color space perceptively having approximately a uniform rate, recommended by Commission Internationale de l'Eclairage (CIE) in 1976.

h_{ab}=tan⁻¹(b*/a*)

In the present invention, h_{ab} is preferably in the range of 180 degrees<h_{ab}<270 degrees, is more preferably in the range of 200 degrees<h_{ab}<270 degrees, and is most preferably in the range of 220 degrees<h_{ab}<260 degrees.

In the present invention, in order to minimize image abrasion caused by handling prior to development as well as after thermal development, matting agents are preferably incorporated in the surface layer (on the photosensitive layer side, and also on the other side when the light-insensitive layer is provided on the opposite side across the support). The added amount is preferably from 0.1 to 30.0 percent by weight with respect to the binders.

Matting agents may be comprised of organic or inorganic materials. Employed as inorganic materials for the matting agents may be, for example, silica described in Swiss Patent No. 330,158, glass powder described in French Patent No. 1,296,995, and carbonates of alkali earth metals or cadmium and zinc described in British Patent No. 1,173,181. Employed as organic materials for the matting agents are starch described in U.S. Pat. No. 2,322,037, starch derivatives described in Belgian Patent No. 625,451 and British Patent No. 981,198, polyvinyl alcohol described in Japanese Patent Publication No. 44-3643, polystyrene or polymethacrylate described in Swiss Patent No. 330,158, acrylonitrile described in U.S. Pat. No. 3,079,257, and polycarbonate described in U.S. Pat. No. 3,022,169.

The average particle diameter of the matting agents is preferably from 0.5 to 10.0 μm, and is more preferably from 1.0 to 8.0 μm. Further, the variation coefficient of the particle size distribution of the same is preferably less than or equal to 50 percent, is more preferably less than or equal to 40 percent, and is most preferably from less than or equal to 30 percent.

Herein, the variation coefficient of the particle size distribution refers to the value expressed by the formula described below.

((Standard deviation of particle diameter)/(particle diameter average))×100

Addition methods of the matting agent according to the present invention may include one in which the matting agent is previously dispersed in a coating composition and the resultant dispersion is applied onto a support, and the other in which after applying a coating composition onto a support, a matting agent is sprayed onto the resultant coating prior to completion of drying. Further, when a plurality of matting agents is employed, both methods may be used in combination.

Listed as materials of the support employed in the silver salt photothermographic dry imaging material of the present invention are various kinds of polymers, glass, wool fabric, cotton fabric, paper, and metal (for example, aluminum). From the viewpoint of handling as information recording materials, flexible materials, which can be employed as a sheet or can be wound in a roll, are suitable. Accordingly, preferred as supports in the silver salt photothermographic dry imaging material of the present invention are plastic films (for example, cellulose acetate film, polyester film, polyethylene terephthalate film, polyethylene naphthalate film, polyamide film, polyimide film, cellulose triacetate film or polycarbonate film). Of these, in the present invention, biaxially stretched polyethylene terephthalate film is particularly preferred. The thickness of the supports is commonly from about 50 to about 300 μm, and is preferably from 70 to 180 μm.

In the present invention, in order to minimize static-charge buildup, electrically conductive compounds such as metal oxides and/or electrically conductive polymers may be incorporated in composition layers. The compounds may be incorporated in any layer, but are preferably incorporated in a subbing layer, a backing layer, and an interlayer between the photosensitive layer and the subbing layer. In the present invention, preferably employed are electrically conductive compounds described in columns 14 through 20 of U.S. Pat. No. 5,244,773.

The silver salt photothermographic dry imaging material of the present invention comprises a support having thereon at least one photosensitive layer. The photosensitive layer may only be formed on the support. However, it is preferable that at least one light-insensitive layer is formed on the photosensitive layer. For example, it is preferable that for the purpose of protecting a photosensitive layer, a protective layer is formed on the photosensitive layer, and in order to minimize adhesion between photosensitive materials as well as adhesion in a wound roll, a backing layer is provided on the opposite side of the support. As binders employed in the protective layer as well as the backing layer, polymers such as cellulose acetate, cellulose acetate butyrate, which has a higher glass transition point from the thermal development layer and exhibit abrasion resistance as well as distortion resistance are selected from the aforesaid binders. Incidentally, for the purpose of increasing latitude, one of the preferred embodiments of the present invention is that at least two photosensitive layers are provided on the one side of the support or at least one photosensitive layer is provided on both sides of the support.

In the silver salt photothermographic dry imaging material of the present invention, in order to control the light amount as well as the wavelength distribution of light which transmits the photosensitive layer, it is preferable that a filter layer is formed on the photosensitive layer side or on the opposite side, or dyes or pigments are incorporated in the photosensitive layer.

Employed as dyes may be compounds, known in the art, which absorb various wavelength regions according to the spectral sensitivity of photosensitive materials.

For example, when the silver salt photothermographic dry imaging material of the present invention is used as an image recording material utilizing infrared radiation, it is preferable to employ squarylium dyes having a thiopyrylium nucleus (hereinafter referred to as thiopyriliumsquarylium dyes) and squarylium dyes having a pyrylium nucleus (hereinafter referred to as pyryliumsquarylium dyes), as described in Japanese Patent Application No. 11-255557, and thiopyryliumcroconium dyes or pyryliumcroconium dyes which are analogous to the squarylium dyes.

Incidentally, the compounds having a squarylium nucleus, as described herein, refers to ones having 1-cyclobutene-2-hydroxy-4-one in their molecular structure. Herein, the hydroxyl group may be dissociated. Hereinafter, all of these dyes are referred to as squarylium dyes.

Incidentally, preferably employed as the dyes are compounds described in Japanese Patent Publication Open to Public Inspection No. 8-201959.

It is preferable to prepare the silver salt photothermographic dry imaging material of the present invention as follows. Materials of each constitution layer as above are dissolved or dispersed in solvents to prepare coating compositions. Resultant coating compositions are subjected to simultaneous multilayer coating and subsequently, the resultant coating is subjected to a thermal treatment. “Simultaneous multilayer coating”, as described herein, refers to the following. The coating composition of each constitution layer (for example, a photosensitive layer and a protective layer) is prepared. When the resultant coating compositions are applied onto a support, the coating compositions are not applied onto a support in such a manner that they are individually applied and subsequently dried, and the operation is repeated, but are simultaneously applied onto a support and subsequently dried. Namely, before the residual amount of the total solvents of the lower layer reaches 70 percent by weight, the upper layer is applied.

Simultaneous multilayer coating methods, which are applied to each constitution layer, are not particularly limited. For example, are employed methods, known in the art, such as a bar coater method, a curtain coating method, a dipping method, an air knife method, a hopper coating method, and an extrusion method of these, more preferred is the pre-weighing type coating system called an extrusion coating method. The aforesaid extrusion coating method is suitable for accurate coating as well as organic solvent coating because volatilization on a slide surface, which occurs in a slide coating system, does not occur. Coating methods have been described for coating layers on the photosensitive layer side. However, the backing layer and the subbing layer are applied onto a support in the same manner as above.

In the present invention, silver coverage is preferably from 0.1 to 2.5 g/m², and is more preferably from 0.5 to 1.5 g/m².

Further, in the present invention, it is preferable that in the silver halide grain emulsion, the content ratio of silver halide grains, having a grain diameter of 0.030 to 0.055 μm in term of the silver weight, is from 3 to 15 percent in the range of a silver coverage of 0.5 to 1.5 g/m².

The ratio of the silver coverage which is resulted from silver halide is preferably from 2 to 18 percent with respect to the total silver, and is more preferably from 3 to 15 percent.

Further, in the present invention, the number of coated silver halide grains, having a grain diameter (being a sphere equivalent grain diameter) of at least 0.01 μm, is preferably from 1×10¹⁴ to 1×10¹⁸ grains/m², and is more preferably from 1×10¹⁵ to 1×10¹⁷.

Further, the coated weight of aliphatic carboxylic acid silver salts of the present invention is from 10⁻¹⁷ to 10⁻¹⁵ g per silver halide grain having a diameter (being a sphere equivalent grain diameter) of at least 0.01 μm, and is more preferably from 10⁻¹⁶ to 10⁻¹⁴ g.

When coating is carried out under conditions within the aforesaid range, from the viewpoint of maximum optical silver image density per definite silver coverage, namely covering power as well as silver image tone, desired results are obtained.

In the present invention, development conditions vary depending on employed devices and apparatuses, or means. Typically, an imagewise exposed silver salt photothermographic dry imaging material is heated at optimal high temperature. It is possible to develop a latent image formed by exposure by heating the material at relatively high temperature (for example, from about 100 to about 200° C.) for a sufficient period (commonly from about 1 second to about 2 minutes). When heating temperature is less than or equal to 100° C., it is difficult to obtain sufficient image density within a relatively short period. On the other hand, at more than or equal to 200° C., binders melt so as to be transferred to rollers, and adverse effects result not only for images but also for transportability as well as processing devices. Upon heating the material, silver images are formed through an oxidation-reduction reaction between aliphatic carboxylic acid silver salts (which function as an oxidizing agent) and reducing agents. This reaction proceeds without any supply of processing solutions such as water from the exterior.

Heating may be carried out employing typical heating means such as hot plates, irons, hot rollers and heat generators employing carbon and white titanium. When the protective layer-provided silver salt photothermographic dry imaging material of the present invention is heated, from the viewpoint of uniform heating, heating efficiency, and workability, it is preferable that heating is carried out while the surface of the side provided with the protective layer comes into contact with a heating means, and thermal development is carried out during the transport of the material while the surface comes into contact with the heating rollers.

When the silver salt photothermographic dry imaging material of the present invention is exposed, it is preferable to employ an optimal light source for the spectral sensitivity provided to the aforesaid photosensitive material. For example, when the aforesaid photosensitive material is sensitive to infrared radiation, it is possible to use any radiation source which emits radiation in the infrared region. However, infrared semiconductor lasers (at 780 nm and 820 nm) are preferably employed due to their high power, as well as ability to make photosensitive materials transparent.

In the present invention, it is preferable that exposure is carried out utilizing laser scanning. Employed as the exposure methods are various ones. For example, listed as a firstly preferable method is the method utilizing a laser scanning exposure apparatus in which the angle between the scanning surface of a photosensitive material and the scanning laser beam does not substantially become vertical.

“Does not substantially become vertical”, as described herein, means that during laser scanning, the nearest vertical angle is preferably from 55 to 88 degrees, is more preferably from 60 to 86 degrees, and is most preferably from 70 to 82 degrees.

When the laser beam scans photosensitive materials, the beam spot diameter on the exposed surface of the photosensitive material is preferably at most 200 μm, and is more preferably at most 100 mm, and is more preferably at most 100 μm. It is preferable to decrease the spot diameter due to the fact that it is possible to decrease the deviated angle from the verticality of laser beam incident angle. Incidentally, the lower limit of the laser beam spot diameter is 10 μm. By performing the laser beam scanning exposure, it is possible to minimize degradation of image quality according to reflection light such as generation of unevenness analogous to interference fringes.

Further, as the second method, exposure in the present invention is also preferably carried out employing a laser scanning exposure apparatus which generates a scanning laser beam in a longitudinal multiple mode, which minimizes degradation of image quality such as generation of unevenness analogous to interference fringes, compared to the scanning laser beam in a longitudinal single mode.

The longitudinal multiple mode is achieved utilizing methods in which return light due to integrated wave is employed, or high frequency superposition is applied. The longitudinal multiple mode, as described herein, means that the wavelength of radiation employed for exposure is not single. The wavelength distribution of the radiation is commonly at least 5 nm, and is preferably at least 10 nm. The upper limit of the wavelength of the radiation is not particularly limited, but is commonly about 60 nm.

Incidentally, in the recording methods of the aforesaid first and second embodiments, it is possible to suitably select any of the following lasers employed for scanning exposure, which are generally well known, while matching the use. The aforesaid lasers include solid lasers such as a ruby laser, a YAG laser, and a glass laser; gas lasers such as a HeNe laser, an Ar ion laser, a Kr ion laser, a CO₂ laser a CO laser, a HeCd laser, an N₂ laser, and an excimer laser; semiconductor lasers such as an InGaP laser, an AlGaAs laser, a GaASP laser, an InGaAs laser, an InAsP laser, a CdSnP₂ laser, and a GaSb laser; chemical lasers; and dye lasers. Of these, from the viewpoint of maintenance as well as the size of light sources, it is preferable to employ any of the semiconductor lasers having a wavelength of 600 to 1,200 nm. Incidentally, the beam spot diameter of lasers employed in laser imagers, as well as laser image setters, is commonly in the range of 5 to 75 μm in terms of a short axis diameter and in the range of 5 to 100 μm in terms of a long axis diameter. Further, it is possible to set a laser beam scanning rate at the optimal value for each photosensitive material depending on the inherent speed of the silver salt photothermographic dry imaging material at laser transmitting wavelength and the laser power.

### EXAMPLES

The present invention will now be detailed with reference to examples. However, the present invention is not limited to these examples.

### Example 1

<<Preparation of Support 1>>

One side surface of a polyethylene terephthalate film base, tinted to blue at a density of 0.170 (of a thickness of 175 μm), was subjected to a corona discharge treatment of 0.5 kV·A·min/m². Thereafter, Subbing Layer “a” was formed by applying the Subbing Coating Composition A, described below, on the resultant surface so as to obtain a dried coating thickness of 0.2 μm. Further, in the same manner, the other surface was subjected to a corona discharge of 0.5 kV·A·min/m². Thereafter, Subbing Layer “b” was formed by applying the Subbing Coating Composition B described below onto the resultant surface so as to obtain a dried coating thickness of 0.1 μm. Subsequently, the resultant coating was subjected to a thermal treatment at 130° C. for 15 minutes in a thermal processing type oven, having a film transport device comprised of a plurality of rollers, whereby Support 1 was prepared.

(Preparation of Subbing Coating Composition A)

Mixed were 270 g of latex (30 percent solids) comprised of a copolymer of 30 percent by weight of n-butyl acrylate,

20 percent by weight of t-butyl acrylate, 25 percent by weight of styrene, and 25 percent by weight of 2-hydroxyethyl acrylate, 0.6 g of a surface active agent (UL-1), and 0.5 g of methyl cellulose. Further, a dispersion was added which was prepared by adding 1.3 g of silica particles (Siloid 350, manufactured by Fuji Silysia Chemical Ltd.) to 100 g of water and by dispersing the resultant mixture for 30 minutes employing an ultrasonic homogenizer (Ultrasonic Generator at a frequency of 25 kHz and 600 W, manufactured by ALEX Corporation). Finally, the total volume was adjusted to 1,000 ml by adding water. The resultant dispersion was designated as Subbing Coating Composition A.

(Preparation of Subbing Coating Composition B)

Mixed were 37.5 g of the colloidal tin oxide dispersion described below, 3.7 g latex (30 percent solids) comprised of a copolymer of 20 percent by weight of n-butyl acrylate, 30 percent by weight of t-butyl acrylate, 27 percent by weight of styrene, and 28 percent by weight of 2-hydroxyethyl acrylate, 14.8 g of a copolymer latex (30 percent solids) comprised of 40 percent by weight of n-butyl acrylate, 20 percent by weight of styrene, and 40 percent by weight of glycidyl methacrylate, and 0.1 g of surface active agent UL-1. The volume of the resulting mixture was adjusted to 1,000 ml by adding water, and was designated as Subbing Coating Composition B.

(Preparation of Colloidal Tin Oxide Dispersion)

Dissolved in 2,000 ml of a water/ethanol mixed solution was 65 g of stannic chloride hydrate, and a uniform solution was prepared. Subsequently, the resultant solution was boiled and coprecipitates were obtained. The resultant precipitates were collected employing decantation, and subsequently washed with water several times. After confirming that by dripping an aqueous silver nitrate solution into distilled water, no chloride ion reaction occurred, the total volume was adjusted to 2,000 ml by adding distilled water. Further, 40 ml of 40 percent ammonia water was added. Subsequently, the resultant aqueous solution was heated and concentrated so that the volume was reduced to 470 ml, whereby a colloidal tin oxide dispersion was prepared.

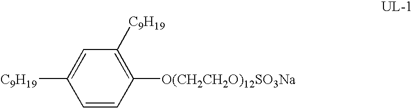

<<Back Side Coating>>

While stirring, added to 830 g of methyl ethyl ketone (MEK) were 84.2 g of cellulose acetate butyrate (CAB381-20 of Eastman Chemical Co.) and 4.5 g of a polyester resin (Vitel PE2200B of Bostic Co.), and dissolved. Subsequently, 0.30 g of Infrared Dye 1 was added to the resultant solution, and further, 4.5 g of an F based surface active agent (Surfron KH40 of Asahi Glass Co.) dissolved in 43.2 g of methanol and 2.3 g of an F based surface active agent (Megafag F120K of Dainippon Ink Co.) were added. Subsequently, the resultant mixture was well stirred until added compounds were completely dissolved. Finally, 75 g of silica (Siloid 64×6000 of W.R. Grace Co.), which was dispersed in methyl ethyl ketone at a concentration of 1 percent by weight, employing a dissolver type homogenizer, was added while stirring, whereby a coating composition for the back side was prepared.

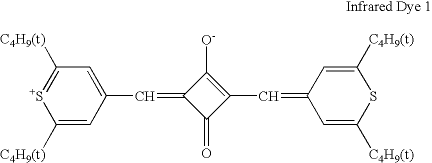

The back side coating composition prepared as above was applied onto the aforesaid Subbing Layer “b” so as to obtain a dried coating thickness of 3.5 μm, employing an extrusion coater, and subsequently dried. Drying was carried out for 5 minutes employing 100° C. air flow of a dew point of 10° C.

<<Preparation of Photosensitive Silver Halide Emulsion>>

(Preparation of Photosensitive Silver Halide Emulsion 1)

| (Solution A1) | | |
|---|---|---|
| Phenylcarbamoyl-modified gelatin | 88.3 | g |
| Compound (*1) (10% aqueous methanol | 10 | ml |
| solution) | | |
| Potassium bromide | 0.32 | g |
| Water to make | 5429 | ml |
| (Solution B1) | | |
| 0.67 mol/L aqueous silver nitrate | 2635 | ml |
| solution | | |
| (Solution C1) | | |
| Potassium bromide | 51.55 | g |
| Potassium iodide | 1.47 | g |
| Water to make | 660 | ml |
| (Solution D1) | | |
| Potassium bromide | 154.9 | g |
| Potassium iodide | 4.41 | g |
| K₃IrCl₆ + K₄[Fe(CN)₆] (equivalent to | 50.0 | ml |
| 2 × 10⁻⁵ mol/Ag) | | |
| Water to make | 1982 | ml |
| (Solution E1) | | |
| 0.4 mol/L aqueous potassium bromide | the following amount controlled | |
| solution by silver potential | | |
| (Solution F1) | | |
| Potassium hydroxide | 0.71 | g |
| Water to make | 20 | ml |
| (Solution G1) | | |
| 56 percent aqueous acetic acid solution | 18.0 | ml |
| (Solution H1) | | |
| Sodium carbonate anhydride | 1.72 | g |
| Water to make | 151 | ml |

(*1) Compound A: HO(CH₂CH₂O)ₙ(CH(CH₃)CH₂O)₁₇(CH₂CH₂O)ₘH
(m + N = 5 through 7)

Upon employing a mixing stirrer shown in Japanese Patent Publication Nos. 58-58288 and 58-58289, ¼ portion of Solution B1 and whole Solution C1 were added to Solution A1 over 4 minutes 45 seconds, employing a double-jet precipitation method while adjusting the temperature to 30° C. and the pAg to 8.09, whereby nuclei were formed. After one minute, whole Solution F1 was added. During the addition, the pAg was appropriately adjusted employing Solution E1. After 6 minutes, ¾ portion of Solution B1 and whole Solution D1 were added over 14 minutes 15 seconds, employing a double-jet precipitation method while adjusting the temperature to 30° C. and the pAg to 8.09. After stirring for 5 minutes, the mixture was cooled to 40° C., and whole Solution G1 was added, whereby a silver halide emulsion was flocculated. Subsequently, while leaving 2000 ml of the flocculated portion, the supernatant was removed, and 10 L of water was added. After stirring, the silver halide emulsion was again flocculated. While leaving 1,500 ml of the flocculated portion, the supernatant was removed. Further, 10 L of water was added. After stirring, the silver halide emulsion was flocculated. While leaving 1,500 ml of the flocculated portion, the supernatant was removed. Subsequently, Solution H1 was added and the resultant mixture was heated to 60° C., and then stirred for an additional 120 minutes. Finally, the pH was adjusted to 5.8 and water was added so that the weight was adjusted to 1,161 g per mol of silver, whereby an emulsion was prepared.

The prepared emulsion was comprised of monodispersed cubic silver iodobromide grains having an average grain size of 0.040 μm, a grain size variation coefficient of 12 percent and a (100) surface ratio of 92 percent.

(Preparation of Photosensitive Silver Halide Emulsion 2)

Photosensitive Silver Halide Emulsion 2 was prepared in the same manner as aforesaid Photosensitive Silver Halide Emulsion 1, except that 5 ml of 0.4 percent aqueous lead bromide solution was added to Solution D1.

Incidentally, the prepared emulsion was comprised of monodispersed cubic silver iodobromide grains having an average grain size of 0.042 μm, a grain size variation coefficient of 14 percent and a (100) surface ratio of 94 percent.

(Preparation of Photosensitive Silver Halide Emulsion 3)

Photosensitive Silver Halide Emulsion 3 was prepared in the same manner as aforesaid Photosensitive Silver Halide Emulsion 1, except that after nucleus formation, all Solution F1 was added, and subsequently 40 ml of a 5 percent aqueous 4-hydroxy-6-methyl-1,3,3a,7-tetraazaindene solution was added.

Incidentally, the prepared emulsion was comprised of monodispersed cubic silver iodobromide grains having an average grain size of 0.042 μm, a grain size variation coefficient of 14 percent and a (100) surface ratio of 93 percent.

(Preparation of Photosensitive Silver Halide Emulsion 4)

Photosensitive Silver Halide Emulsion 4 was prepared in the same manner as aforesaid Photosensitive Silver Halide Emulsion 1, except that 40 ml of K₃IrCl₆+K₄[Fe(CN₆) was added.

Incidentally, the prepared emulsion was comprised of monodispersed cubic silver iodobromide grains having an average grain size of 0.041 μm, a grain size variation coefficient of 13 percent and a (100) surface ratio of 91 percent.

(Preparation of Photosensitive Silver Halide Emulsion 5)

Photosensitive Silver Halide Emulsion 5 was prepared in the same manner as aforesaid Photosensitive Silver Halide Emulsion 1, except that K₃IrCl₆+K₄[Fe(CN₆)₅ ml was not employed at all.

Incidentally, the prepared emulsion was comprised of monodispersed cubic silver bromide grains having an average grain size of 0.042 μm, a grain size variation coefficient of 14 percent and a (100) surface ratio of 93 percent.

<<Preparation of Photosensitive Layer Coating Composition>>

(Preparation of Powder Aliphatic Carboxylic Acid Silver Salt A)

Dissolved in 4,720 ml of pure water were 130.8 g of behenic acid, 67.7 g of arachidic acid, 43.6 g of stearic acid, and 2.3 g of palmitic acid at 80° C. Subsequently, 540.2 ml of a 1.5 M aqueous sodium hydroxide solution was added, and further, 6.9 ml of concentrated nitric acid was added. Thereafter, the resultant mixture was cooled to 55° C., whereby an aliphatic acid sodium salt solution was prepared. While heating the aliphatic acid sodium salt solution at 55° C., 45.3 g (equivalent to 0.039 mol of silver) of the aforesaid Photosensitive Silver Halide Emulsion A as well as 450 ml of pure water was added and stirred for 5 minutes.

Subsequently, 702.6 ml of one mol silver nitrate solution was added over two minutes and stirred for 10 minutes, whereby an aliphatic carboxylic acid silver salt dispersion was prepared. Thereafter, the resultant aliphatic carboxylic acid silver salt dispersion was transferred to a water washing machine, and deionized water was added. After stirring, the resultant dispersion was allowed to stand, whereby a flocculated aliphatic carboxylic acid silver salt was allowed to float and was separated, and the lower portion, containing water-soluble salts, were removed. Thereafter, washing was repeated employing deionized water until electric conductivity of the resultant effluent reached 50 μS/cm. After centrifugal dehydration, the resultant cake-shaped aliphatic carboxylic acid silver salt was dried employing an gas flow type dryer Flush Jet Dryer (manufactured by Seishin Kikaku Co., Ltd.), while setting the drying conditions such as nitrogen gas as well as heating flow temperature at the inlet of the dryer, until its water content ratio reached 0.1 percent, whereby Powder Aliphatic Carboxylic Acid Silver Salt A was prepared. The water content ratio of aliphatic carboxylic acid silver salt compositions was determined employing an infrared moisture meter.

<<Preparation of Preliminary Dispersion A>>

Dissolved in 1457 g of methyl ethyl ketone (hereinafter referred to as MEK) was 14.57 g of poly(vinyl butyral) resin P-9. While stirring, employing Dissolver DISPERMAT Type CA-40M, manufactured by VMA-Getzmann Co., 500 g of aforesaid Powder Aliphatic Carboxylic Acid Silver Salt A was gradually added and sufficiently mixed, whereby Preliminary Dispersion A was prepared.

(Preparation of Photosensitive Emulsion A)

Preliminary Dispersion A, prepared as above, was charged into a media type homogenizer DISPERMAT Type SL-C12EX (manufactured by VMA-Getzmann Co.), filled with 0.5 mm diameter zirconia beads so as to occupy 80 percent of the interior volume so that the retention time in the mill reached 1.5 minutes and was dispersed at a peripheral rate of the mill of 8 m/second, whereby Photosensitive Emulsion A was prepared.

(Preparation of Stabilizer Solution)

Stabilizer Solution was prepared by dissolving 1.0 g of Stabilizer 1 and 0.31 g of potassium acetate in 4.97 g of methanol.

(Preparation of Infrared Sensitizing Dye A Solution)

Infrared Sensitizing Dye A Solution was prepared by dissolving 19.2 mg of Infrared Sensitizing Dye 1, 1.488 g of 2-chloro-benzoic acid, 2.779 g of Stabilizer 2, and 365 mg of 5-methyl-2-mercaptobenzimidazole in 31.3 ml of MEK in a light-shielded room.

(Preparation of Additive Solution “a”)

Additive Solution “a” was prepared by dissolving 27.98 g of 1,1-bis(2-hydroxy-3,5-dimethylphenyl)-3,5,5-trimethylhexane (Developing Agent A) and 1.54 g of 4-methylphthalic acid, and 0.48 g of aforesaid Infrared Dye 1 in 110 g of MEK.

Incidentally, in the present experiments, other than aforesaid Developing Agent A, employed as developing agents were selected the compounds shown in Table 2 from a group of exemplified compounds.

(Preparation of Additive Solution “b”)

Additive Solution “b” was prepared by dissolving 3.56 g of Antifoggant 2 and 3.43 g of phthalazine in 40.9 g of MEK.

(Preparation of Photosensitive Layer Coating Composition A)

While stirring, 50 g of aforesaid Photosensitive Emulsion A and 15.11 g of MEK were mixed and the resultant mixture was maintained at 21° C. Subsequently, 390 μl of Antifoggant 1 (being a 10 percent methanol solution) was added and stirred for one hour. Further, 494 μl of calcium bromide (being a 10 percent methanol solution) was added and stirred for 20 minutes. Subsequently, 167 ml of aforesaid Stabilizer Solution was added and stirred for 10 minutes. Thereafter, 1.32 g of aforesaid Infrared Sensitizing Dye A was added and the resulting mixture was stirred for one hour. Subsequently, the resulting mixture was cooled to 13° C. and stirred for an additional 30 minutes. While maintaining at 13° C., 13.31 g of poly(vinyl acetal) Resin P-1 as a binder was added and stirred for 30 minutes. Thereafter, 1.084 g of tetrachlorophthalic acid (being a 9.4 weight percent MEK solution) was added and stirred for 15 minutes. Further, while stirring, 12.43 g of Additive Solution “a”, 1.6 ml of Desmodur N300/aliphatic isocyanate, manufactured by Mobay Chemical Co. (being a 10 percent MEK solution), and 4.27 g of Additive Solution “b” were successively added, whereby Photosensitive Layer Coating Composition A was prepared.

<<Surface Protective Layer Coating Composition>>

While stirring, added to 865 g of MEK were 96 g of cellulose acetate butyrate (CAB171-15 of Eastman Chemical Co.), 4.5 g of polymethylmethacrylic acid (Paraloid A-21 of Rohm & Haas Co.), vinylsulfone compound (VSC), 1.0 g of bemztriazole and 1.0 g of a F based surface active agent (Surfron KH40 of Asahi Glass Co.) and dissolved. Added to the resulting solution was 30 g of the matting agent dispersion described below and the resulting mixture was stirred, whereby a surface protective layer coating compositing was prepared.

<<Preparation of Matting Agent Dispersion>>

Dissolved in 42.5 g of MEK was 7.5 g of cellulose acetate butyrate (CAB171-15 of Eastman Chemical Co.) and further, 5 g of calcium carbonate (Super-Pflex 200 of Speciality Minerals Co.) was added. The resultant mixture was dispersed at 8,000 rpm for 30 minutes, employing a dissolver type homogenizer, whereby a matting agent dispersion was prepared.

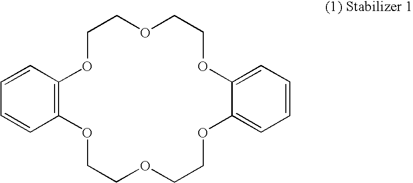

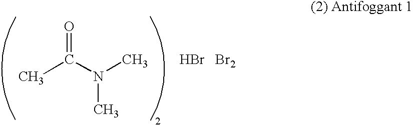

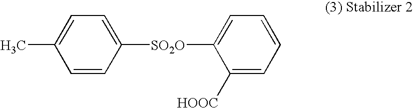

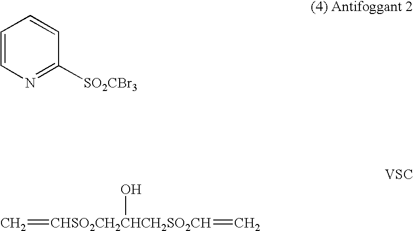

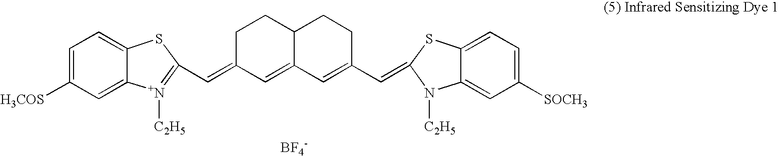

<<Preparation of Silver Salt Photothermographic Dry Imaging Material Sample>>

Sample 101 was prepared by simultaneously applying Photosensitive Layer Coating Composition A and Surface Protective Layer Coating Composition onto subbing layer “b” of Support 1, prepared as above, employing an prior art extrusion type coater. Coating was carried out so as to obtain a silver coverage of the photosensitive layer of 1.5 g/m² and a dried coating thickness of the protective layer of 2.5 μm. Thereafter, the coating was dried for 10 minutes employing 75° C. air flow having a dew temperature of 10° C., whereby Sample 101 was prepared.

Subsequently, Samples 102 through 114 were prepared in the same manner as Sample 101, except that the developing agent (the comparative developing agent in Additive Solution “a”) and of silver aliphatic carboxylates, the ratio of silver behenate was changed to the value shown Table 2. Incidentally, when the ratio of silver behenate was changed, the relative ratio of the proportion of silver arachidate, silver stearate, and silver palmitate was kept constant.

<<Evaluation of Each Characteristic>>

(Exposure and Development Process)

Scanning exposure was given onto the emulsion side surface of each sample prepared as above, employing an exposure apparatus in which a semiconductor laser, which was subjected to longitudinal multi mode of a wavelength of 800 to 820 nm, employing high frequency superposition, was employed as a laser beam source. In such a case, images were formed while adjusting the angle between the exposed surface of the sample and the exposure laser beam to 75 degrees. By employing such a method, compared to the case in which the angle was adjusted to 90 degrees, images were obtained which minimized unevenness and surprisingly exhibited excellent sharpness.

Thereafter, while employing an automatic processor having a heating drum, the protective layer of each sample was brought into contact with the surface of the drum and thermal development was carried out at 110° C. for 15 seconds. In such a case, exposure as well as development was carried out in the room which was conditioned at 23° C. and 50 percent relative humidity.

(Measurement of Speed, Fog Density, and Maximum Density)

The density of the resulting images formed as above was measured employing a densitometer and characteristic curves were prepared in which the abscise shows the exposure amount and the ordinate shows the density. Utilizing the resulting characteristic curve, speed was defined as the reciprocal of an exposure amount to result in density higher 1.0 than the unexposed part, and fog density (minimum density) as well as maximum density was determined. Incidentally, the speed and the maximum density were shown as a relative value when each value of Sample 105 was 100.

<Evaluation of Storage Stability prior to Development>

Each sample was stored under the two conditions described below for 10 days. Thereafter, each sample was exposed employing the speed measurement method same as above and developed. Thereafter, the speed and the minimum density of the resultant image were determined. Further, the variation ratio of minimum density (Dmin) and speed of each sample for Condition B to Condition A were obtained based on the formula described below, and was utilized as the scale of the storage stability.

Condition A: 25° C. and 55 percent relative humidity

Condition B: 40° C. and 80 percent relative humidity

Variation ratio=minimum density or sensitivity under Condition B/minimum density or sensitivity under Condition A×100

(Evaluation of Image Retention Properties after Development)

<Measurement of Variation Ratio of Minimum Density (Dₘᵢₙ)>

Each of thermally developed samples, which had been prepared employing the same method as the aforesaid speed determination, was allowed to stand for three days at an ambience of 45° C. and 55 percent relative humidity while a commercially available fluorescent lamp was arranged so as to result in an illuminance of 500 lux on the surface of each sample. The minimum density (D2) of each of fluorescent light-exposed samples and the minimum density (D1) of each of fluorescent light-unexposed samples were determined, and the variation ratio (in percent) of minimum density was calculated based on the formula described below.

Variation ratio of minimum density=D2/D1×100 (in percent)

<Determination of Variation Ratio of Maximum Density (Dₘₐₓ)>

Each of thermally developed samples, which had been prepared in the same manner as the determination of the variation ratio of minimum density, was allowed to stand for three days at an ambience of 25° C. and 45° C. Thereafter, the variation of the maximum density was determined, and the variation ratio of image density was determined based on the formula described below, which was utilized as the scale of the image retention Properties.

Variation ratio of maximum density=maximum density of the sample stored at 45° C./maximum density of the sample stored at 25° C.×100 (in percent)

<Determination of Hue Angle>

Hue angle h_{ab} was determined as follows. The minimum density part and the part of an optical density of 1.0 of each of the developed samples were measured employing a spectral calorimeter CM-508d (manufactured by Minolta Co.) at a visual field of 2 degrees, while utilizing standard light source D65 specified by CIE as a calorimetric light source.

Tables 2 and 3 show the results except for the hue angle.

TABLE 2

| | | | | | | | | Storage Stability | | Storage Stability | | |
|---|---|---|---|---|---|---|---|---|---|---|---|---|
| | | | | | | | | prior to Development | | after Development | | |
| | Silver | | Devel- | | | | | Dmin | Speed | Dmin | Dₘₐₓ | |
| Sample | Halide | | oping | | | Relative | | Variation | Variation | Variation | Variation | |
| No. | Emulsion | *1 | Agent | *2 | Fog | Speed | *3 | Ratio (%) | Ratio (%) | Ratio (%) | Ratio (%) | Remarks |
| 101 | 1 | absence | A | 54 | 0.195 | 175 (18) | 195 | 120 | 85 | 115 | 90 | Inv. |
| 102 | 2 | absence | A | 54 | 0.180 | 180 (15) | 200 | 115 | 90 | 110 | 93 | Inv. |
| 103 | 3 | absence | A | 54 | 0.190 | 175 (13) | 195 | 115 | 90 | 115 | 95 | Inv. |
| 104 | 4 | absence | A | 54 | 0.175 | 210 (10) | 210 | 115 | 90 | 113 | 97 | Inv. |
| 105 | 5 | absence | A | 54 | 0.220 | 100 (25) | 100 | 125 | 75 | 145 | 85 | Comp. |
| 106 | 1 | presence | A | 54 | 0.205 | 420 (15) | 210 | 125 | 95 | 125 | 95 | Inv. |
| 107 | 2 | presence | A | 54 | 0.190 | 425 (13) | 215 | 125 | 95 | 120 | 95 | Inv. |
| 108 | 3 | presence | A | 54 | 0.190 | 425 (10) | 220 | 120 | 95 | 120 | 95 | Inv. |
| 109 | 4 | presence | A | 54 | 0.185 | 430 (5) | 230 | 120 | 95 | 118 | 95 | Inv. |
| 110 | 5 | presence | A | 54 | 0.235 | 190 (45) | 170 | 130 | 90 | 135 | 95 | Comp. |
| 111 | 4 | presence | 1-24 | 54 | 0.180 | 425 (5) | 225 | 115 | 95 | 110 | 95 | Inv. |
| 112 | 4 | presence | 1-24 | 65 | 0.180 | 425 (5) | 225 | 110 | 95 | 108 | 97 | Inv. |
| 113 | 4 | presence | 1-24 | 85 | 0.175 | 420 (5) | 220 | 107 | 96 | 105 | 97 | Inv. |
| 114 | 4 | presence | 1-24 | 98 | 0.175 | 425 (5) | 220 | 105 | 97 | 102 | 98 | Inv. |

*1: Presence or Absence of Chemical Sensitization of Silver Halide Emulsion
*2: Content Ratio of Behenic Acid and Salt Thereof (weight %)
*3: Maximium Density (relative value)
Inv.: Present Invention
Comp.: Comparative

Note: Figure in the parenthesis was obtained as follows. Prior to exposing a photosensitive material to white light, the photosensitive material was thermally treated at thermal development temperature, subsequently was exposed to white light (4874 K, 30 seconds) and was thermally developed, whereby speed was determined. On the other hand, the photosensitive material, which had not been thermally treated, was exposed to white light under the same conditions as above and subsequently was thermally developed, whereby speed was also determined. When the latter speed was 100, the former speed was represented as a relative speed. Incidentally, when silver halide emulsion underwent chemical sensitization at the final preparation stage of each of Silver Halide Emulsions 1 though 5, 240 ml of Sulfur Sensitizer S-5 (0.5 percent methanol solution) was added, and chemical sensitization was carried out at 55° C. for 120 minutes.

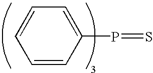

As can clearly be seen from Table 2, silver salt photothermographic dry imaging materials of the present invention resulted in lower fog (minimum density) than Comparative Samples, even though the speed was higher than or equal to the Comparative Samples, and exhibited excellent storage stability prior to development, and especially excellent storage stability after development. Further, though not shown in Table 2, in the samples of the present invention, all hue angle values specified in CIE were from 200 to 265 degrees, which resulted in the cold image tone, whereby it was confirmed that suitable output images for medical diagnosis were obtained.

### Example 2

Silver salt photothermographic dry imaging materials were prepared in the same manner as Example 1, except that in instead of carrying out chemical sensitization at the final preparation stage of Silver Halide Emulsions 1 through 5, chemical sensitization was carried out as described below during the preparation stage of Photosensitive Layer Coating Composition A.

(Preparation of Photosensitive Layer Coating Composition A-2)

While stirring, 50 g of aforesaid Photosensitive Emulsion A and 15.11 g of MEK were mixed and the resultant mixture was maintained at 21° C. Subsequently, 390 μl of Antifoggant 1 (being a 10 percent methanol solution) was added and stirred for one hour. Further, 494 μl of calcium bromide (being a 10 percent methanol solution) was added and stirred for 20 minutes. Subsequently, 240 ml of Sulfur Sensitizer S-5 (10 percent methanol solution) was added and chemical sensitization was performed while stirring at 55° C. for one hour. Further, 494 μl of calcium bromide solution (being a 10 percent methanol solution) was added and the resulting mixture was stirred for 20 minutes. Subsequently, 167 ml of the aforesaid stabilizer solution was added and the resulting mixture was stirred for 10 minutes. Thereafter, 1.32 g of aforesaid Infrared Sensitizing Dye A was added and the resulting mixture was stirred for one hour. Subsequently, the resulting mixture was cooled to 13° C. and stirred for an additional 30 minutes. While maintaining at 13° C., 13.31 g of poly(vinyl acetal) Resin P-1 as a binder was added and the resulting mixture was stirred for 30 minutes. Thereafter, 1.084 g of tetrachlorophthalic acid (being a 9.4 weight percent MEK solution) was added and the resulting mixture was stirred for 15 minutes. Further, while stirring, 12.43 g of Additive Solution “a”, 1.6 ml of Desmodur N300/aliphatic isocyanate, manufactured by Mobay Chemical Co. (being a 10 percent MEK solution), and 4.27 g of Additive Solution “b” were successively added, whereby Photosensitive Layer Coating Composition A-2 was prepared.

<<Preparation of Silver Salt Photothermographic Dry Imaging Material Sample 201>>

Sample 201 was prepared in the same manner as Sample 101 of Example 1, employing Photosensitive Layer Coating Composition A-2 and the surface protective layer coating composition, described in Example 1.

Subsequently, Samples 202 through 205 were prepared in the same manner as Sample 201, except that the type of the photosensitive silver halide emulsion, the developing agent (being a comparative developing agent in Additive Solution “a” and the ratio of behenic acid in the photosensitive silver halide emulsion were changed as shown in Table 3. Incidentally, when the ratio of silver behenate was changed, the relative ratio of three content ratios of silver arachidinate, silver stearate, and silver palmitate was kept constant.

Incidentally, in all samples, P-1 was employed as the binder resin in the photosensitive layer coating composition, whereby the thermal transition temperature of the photosensitive layers was adjusted to approximately 55° C.

<<Evaluation of Each Characteristic>>

Exposure and photographic processing, as well as various evaluations, were carried out employing the methods described in Example 1. Table 3 shows the results except for the hue angle. Incidentally, speed and maximum density were represented using relative values when each corresponding value of Sample 205 was 100.

TABLE 3

| | | | | | | | | Storage Stability | | Storage Stability | | |
|---|---|---|---|---|---|---|---|---|---|---|---|---|
| | | | | | | | | prior to Development | | after Development | | |
| | Silver | | Devel- | | | | | Dmin | Speed | Dmin | Dₘₐₓ | |
| Sample | Halide | | oping | | | Relative | | Variation | Variation | Variation | Variation | |
| No. | Emulsion | *1 | Agent | *2 | Fog | Speed | *3 | Ratio (%) | Ratio (%) | Ratio (%) | Ratio (%) | Remarks |
| 201 | 4 | presence | A | 85 | 0.190 | 210 (10) | 195 | 115 | 90 | 110 | 94 | Inv. |
| 202 | 4 | presence | 1-24 | 85 | 0.170 | 225 (5) | 200 | 105 | 96 | 105 | 97 | Inv. |
| 203 | 4 | presence | 1-28 | 85 | 0.185 | 230 (8) | 195 | 107 | 95 | 105 | 96 | Inv. |
| 204 | 4 | presence | 1-68 | 85 | 0.175 | 220 (7) | 210 | 115 | 90 | 113 | 97 | Inv. |
| 205 | 1 | presence | A | 85 | 0.220 | 100 (28) | 100 | 125 | 80 | 150 | 80 | Comp. |

*1: Presence or Absence of Chemical Sensitization of Silver Halide Emulsion
*2: Content Ratio of Behenic Acid and Salt Thereof (weight %)
*3: Maximum Density (relative value)
Inv.: Present Invention
Comp.: Comparative

Note: Figure in the parenthesis in the column of Relative Speed was calculated in the same manner as the case in Table 2.

As can clearly be seen from Table 3, the silver salt photothermographic dry imaging materials of the present invention resulted in lower fog (minimum density) than Comparative Sample, even though the speed was higher than or equal to the Comparative Sample, and exhibited excellent storage stability prior to development. In addition, though not shown in Table 3, in the samples of the present invention, all hue angle values specified in CIE were from 200 to 265 degrees, which resulted in the cold image tone, whereby it was confirmed that suitable output images for medical diagnosis were obtained.

### Example 3

<<Preparation of Support 2>>

Support 2 was prepared employing the same method as described in Example 1, except that in Support 1 prepared in Example 1, Silver Saving Agent A and Silver Saving Agent B described below were added to aforesaid Subbing Coating Composition B in an amount of 0.2 g and 0.9 g, respectively.

(1) Silver Saving Agent A

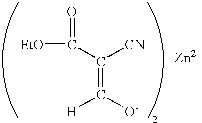

(2) Silver Saving Agent B

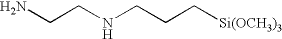

<<Preparation of Photosensitive Emulsion A-3 and Photosensitive Layer Coating Composition A-3>>

Photosensitive Emulsion A-3 and Photosensitive Layer Coating Composition A-3 were prepared in the same manner as Example 1, except that in Photosensitive Layer Coating Composition A described in Example 1, Photosensitive Silver Halide Emulsion 4 was used.

<<Preparation of Silver Salt Photothermographic Dry Imaging Material Sample 301>>

Sample 301 was prepared by simultaneously applying two layers consisting of a photosensitive Layer and a surface protective layer onto Subbing Layer “b” of Support 1 or Support 2, employing a prior art extrusion type coater. Coating was carried out so as to obtain a silver coverage of the photosensitive layer comprised of Photosensitive Emulsion A-3 of 0.7 g/m² and a dried coating thickness of the protective layer of 2.5 μm. Thereafter, the coating was dried for 10 minutes employing 75° C. air flow having a dew temperature of 10° C.

Subsequently, Samples 302 through 306 were prepared in the same manner as aforesaid Sample 301, except that the developing agent (being the developing agent in Additive Solution “a”) was changed to those shown in Table 4. Incidentally, in all the samples, P-1 was employed as a binder resin in the photosensitive layer coating composition. Further, the thermal transition temperature of the photosensitive layer was adjusted to approximately 55° C.

<<Evaluation of Each Characteristic>>

Exposure and photographic processing, as well as various evaluations, were carried out employing the methods described in Example 1. Table 3 shows the results except for the hue angle. Incidentally, speed and maximum density were represented using relative values when each corresponding value of Sample 301 was 100.

TABLE 4

| | | | | Presence | | | | | | | | |
|---|---|---|---|---|---|---|---|---|---|---|---|---|
| | | | | or | | | | | | | | |
| | | | | Absence | | | | | | | | |
| | | | | of Silver | | | | Storage Stability | | Storage Stability | | |
| | | | | Saving | | | | prior to Development | | after Development | | |
| | Devel- | Silver | | Agent in | | | | Dmin | Speed | Dmin | Dₘₐₓ | |
| Sample | oping | Halide | | Subbing | | Relative | | Variation | Variation | Variation | Variation | |
| No. | Agent | Emulsion | *1 | Layer | Fog | Speed | *2 | Ratio (%) | Ratio (%) | Ratio (%) | Ratio (%) | Remarks |
| 301 | A | 4 | 54 | absence | 0.178 | 100 (5) | 100 | 115 | 86 | 115 | 90 | Inv. |
| 302 | A | 4 | 54 | presence | 0.183 | 127 (7) | 153 | 118 | 80 | 120 | 88 | Inv. |
| 303 | A | 4 | 85 | presence | 0.180 | 135 (8) | 150 | 115 | 92 | 110 | 95 | Inv. |
| 304 | 1-24 | 4 | 85 | presence | 0.170 | 133 (6) | 155 | 110 | 96 | 105 | 98 | Inv. |
| 305 | 1-28 | 4 | 85 | presence | 0.160 | 130 (8) | 155 | 110 | 95 | 107 | 97 | Inv. |
| 306 | 1-68 | 4 | 85 | presence | 0.165 | 135 (7) | 150 | 112 | 96 | 103 | 97 | Inv. |

*1: Content Ratio of Behenic Acid and Salt Thereof (weight %)
*2: Maximum Density (relative value)

Note: Figure in the parenthesis in the column of Relative Speed was calculated in the same manner as the case in Table 2.

As can clearly be seen from Table 4, the silver salt photothermographic dry imaging materials of the present invention resulted in lower fog, while exhibiting high speed, even in the imaging materials comprising the silver saving agent, and exhibited excellent storage stability prior to development as well as storage stability after development. In addition, in the samples, all hue angle values specified in CIE were from 200 to 265 degrees, which resulted in the cold image tone, whereby it was confirmed that suitable output images for medical diagnosis were obtained.

Based on the present invention, it is possible to provide a silver salt photothermographic dry imaging material which results in high sensitivity, minimizes fog, and exhibits excellent storage stability and especially excellent silver image stability after thermal development, and a image recording method as well as an image forming method using the same.

What is claimed is:

1. A photothermographic imaging material comprising a support having thereon a photosensitive layer comprising photosensitive silver halide grains, light-insensitive organic silver salt grains, a binder, and a reducing agent for silver ions,
wherein the silver halide grains are capable of:
(a) forming surface latent images when exposed prior to heating development; and
(b) forming internal latent images when exposed after heating development.

2. A photothermographic imaging material comprising a support having thereon a photosensitive layer comprising photosensitive silver halide grains, light-insensitive organic silver salt grains, a binder, and a reducing agent for silver ions,
wherein the imaging material has a first photographic speed and a second photographic speed and the second photographic speed is not more than ⅕ of the first photographic speed,
the first photographic speed being derived from a first characteristic curve obtained from the imaging material subjected to a first measuring method comprising the following steps in the order named:
(1a) exposing the imaging material to white light or infrared light using an optical wedge; and
(1b) applying heat to the exposed imaging material under a predetermined condition so as to develop the exposed imaging material,
and the second photographic speed being derived from a second characteristic curve obtained from the imaging material subjected to a second measuring method comprising the following steps in the order named:
(2a) applying heat to the imaging material under the same condition as (1b);
(2d) exposing the heated imaging material to white light or infrared light using the optical wedge.

3. The photothermographic imaging material of claim 1,
wherein the silver halide grains comprise a dopant capable of trapping an electron inside of the grains.

4. The photothermographic imaging material of claim 2,
wherein the silver halide grains comprise a dopant capable of trapping an electron inside of the grains.

5. The photothermographic imaging material of claim 1,
wherein the silver halide grains are covered with a spectral sensitizing dye on surfaces of the grains so as to exhibit a spectral sensitivity and the spectral sensitivity substantially disappears after thermal development of the imaging material.

6. The photothermographic imaging material of claim 2,
wherein the silver halide grains are covered with a spectral sensitizing dye on surfaces of the grains so as to exhibit a spectral sensitivity and the spectral sensitivity substantially disappears after thermal development of the imaging material.

7. The photothermographic imaging material of claim 1,
wherein the silver halide grains are chemically sensitized on surfaces of the grains so as to exhibit a chemical sensitivity and the chemical sensitivity substantially disappears after thermal development of the imaging material.

8. The photothermographic imaging material of claim 2,
wherein the silver halide grains are chemically sensitized on surfaces of the grains so as to exhibit a chemical sensitivity and the chemical sensitivity substantially disappears after thermal development of the imaging material.

9. The photothermographic imaging material of claim 1,
wherein the silver halide grains are covered with a spectral sensitizing dye on surfaces of the grains so as to exhibit a spectral sensitivity and the silver halide grains are chemically sensitized on the surfaces of the grains so as to exhibit a chemical sensitivity, and the spectral sensitivity and the chemical sensitivity substantially after thermal development of the imaging material.

10. The photothermographic imaging material of claim 2,
wherein the silver halide grains are covered with a spectral sensitizing dye on surfaces of the grains so as to exhibit a spectral sensitivity and the silver halide grains are chemically sensitized on the surfaces of the grains so as to exhibit a chemical sensitivity, and the spectral sensitivity and the chemical sensitivity substantially disappears after thermal development of the imaging material.

11. The photothermographic imaging material of claim 1, wherein the reducing agent is represented by the following Formula (S):
Formula (S) 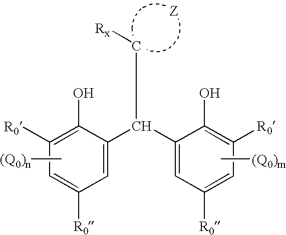
wherein Z is a group of atoms necessary to form a non aromatic ring of 3 to 10 members; Rx is a hydrogen or an alkyl group; each Ro′ and Ro″ is independently a hydrogen, an alkyl group, an aryl group, or a heterocyclic group; Qo is a substituent; and each n and m is independently an integer of 0 to 2; and plural Qos may be the same or different.

12. The photothermographic imaging material of claim 2, wherein the reducing agent is represented by the following Formula (S):
Formula (S) 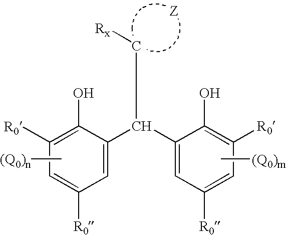
wherein Z is a group of atoms necessary to form a non aromatic ring of 3 to 10 members; Rx is a hydrogen or an alkyl group; each Ro′ and Ro″ is independently a hydrogen, an alkyl group, an aryl group, or a heterocyclic group; Qo is a substituent; and each n and m is independently an integer of 0 to 2; and plural Qos may be the same or different.

13. The photothermographic imaging material of claim 1,
wherein the photosensitive layer has a silver coverage of from 0.5 to 1.5 g/m² and the silver halide grains comprise a dopant capable of trapping an electron inside of the grains.

14. The photothermographic imaging material of claim 2,
wherein the photosensitive layer has a silver coverage of from 0.5 to 1.5 g/m² and the silver halide grains comprise a dopant capable of trapping an electron inside of the grains.

15. The photothermographic imaging material of claim 1,
wherein the light-insensitive organic silver salt grains comprise a silver salt of an aliphatic carboxylic acid having a melting point of 60 to 90° C. in an amount of 65 weight % based on the total organic silver salt grains.

16. The photothermographic imaging material of claim 2,
wherein the light-insensitive organic silver salt grains comprise a silver salt of an aliphatic carboxylic acid having a melting point of 60 to 90° C. in an amount of 65 weight % based on the total organic silver salt grains.

17. The photothermographic imaging material of claim 15,
wherein the aliphatic carboxylic acid has a melting point of 70 to 90° C.

18. The photothermographic imaging material of claim 16,
wherein the aliphatic carboxylic acid has a melting point of 70 to 90° C.

19. An image recording method, comprising the steps of:
(a) providing the photothermographic imaging material of claim 1 in a laser scanning exposure apparatus; and
(b) exposing the photothermographic imaging material with a laser beam, wherein the laser beam is applied to the photothermographic imaging material using a longitudinal multiple scanning method; and
(c) applying heat to the exposed imaging material under a predetermined condition so as to develop the exposed imaging material.

20. An image recording method, comprising the steps of:
(a) providing the photothermographic imaging material of claim 2 in a laser scanning exposure apparatus; and
(b) exposing the photothermographic imaging material with a laser beam, wherein the laser beam is applied to the photothermographic imaging material using a longitudinal multiple scanning method; and
(c) applying heat to the exposed imaging material under a predetermined condition so as to develop the exposed imaging material.

21. An image forming method, comprising the steps of:
(a) providing the photothermographic imaging material of claim 1 in a laser scanning exposure apparatus;
(b) exposing the photothermographic imaging material with a laser beam; and, (c) applying heat to the exposed imaging material under a predetermined condition so as to develop the exposed imaging material, wherein after the step (c) being carried out, the imaging material exhibits a hue angle h_{ab} which satisfies the following relationship:
180°<h_{ab}<270°

22. An image forming method, comprising the steps of:
(a) providing the photothermographic imaging material of claim 2 in a laser scanning exposure apparatus;
(b) exposing the photothermographic imaging material with a laser beam; and,
(c) applying heat to the exposed imaging material under a predetermined condition so as to develop the exposed imaging material, wherein after the step (c) being carried out, the imaging material exhibits a hue angle h_{ab} which satisfies the following relationship:
180°<h_{ab}<270°
